(19) United States
(12) Patent Application Publication
(10) Pub. No.: US 2018/0255589 A1
(43) Pub. Date: Sep. 6, 2018

(54) RANDOM ACCESS REQUEST REGULATION TECHNIQUES FOR WIRELESS STATIONS

(71) Applicant: QUALCOMM Incorporated, San Diego, CA (US)

(72) Inventors: Abhishek Pramod Patil, San Diego, CA (US); George Cherian, San Diego, CA (US); Alfred Asterjadhi, San Diego, CA (US); Bin Tian, San Diego, CA (US)

(21) Appl. No.: 15/900,768

(22) Filed: Feb. 20, 2018

Related U.S. Application Data
(63) Continuation-in-part of application No. 15/853,604, filed on Dec. 22, 2017.
(60) Provisional application No. 62/530,057, filed on Jul. 7, 2017.
(60) Provisional application No. 62/466,941, filed on Mar. 3, 2017.

(51) Int. Cl. H04W 74/08; H04W 74/00

(52) U.S. Cl. CPC H04W 74/0875; H04W 74/006; H04W 74/004; H04W 74/0833; H04W 74/008

(57) ABSTRACT

Methods, systems, and devices for wireless communication are described. An access point (AP) may configure one or more trigger frames, which may include a number of random access resource units (RUs). A number of stations (STAs) may contend to use such random access RUs. Regulation techniques for which STAs may contend for access to random access RUs may include providing that separate subsets of random access RUs may be identified for STAs that are associated and unassociated with the AP. In some implementations, the regulation techniques enable STAs to attempt transmissions using the random access RUs when uplink-limited or if the STA has a non-empty buffer, or combinations thereof. Techniques for acknowledging receipt of an uplink transmission may include transmitting an acknowledgment using a same association identification for the acknowledgment as used in the uplink transmission, and including a STA identifier in a signaling field associated with the acknowledgment.

### CROSS REFERENCES

The present Application for Patent is a Continuation-in-Part of U.S. patent application Ser. No. 15/853,604 by Patil et al., entitled “Random Request Prioritization Techniques For Wireless Stations,” filed Dec. 22, 2017, which claims priority to U.S. Provisional Patent Application No. 62/466,941 by Patil et al., entitled “Random Request Prioritization Techniques For Wireless Stations,” filed Mar. 3, 2017, and U.S. Provisional Patent Application No. 62/530,057 by Patil et al., entitled “Random Request Prioritization Techniques For Wireless Stations, filed Jul. 7, 2017, assigned to the assignee hereof, and each of which are hereby expressly incorporated by reference herein in their entirety.

### TECHNICAL FIELD

The present disclosure relates generally to wireless communication, and more specifically to random access request regulation techniques for wireless stations.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a wireless local area network (WLAN), such as a Wi-Fi (that is, Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A mobile device may communicate with a network device bi-directionally. For example, in a WLAN, a STA may communicate with an associated AP via downlink (DL) and uplink (UL) transmissions. The DL (or forward link) may refer to the communication link from the AP to the STA, and the UL (or reverse link) may refer to the communication link from the STA to the AP.

In some cases, an AP may communicate with a number of STAs within a basic service set (BSS), and one or more STAs, within the BSS or outside of the BSS, may need to transmit uplink information to the AP. In cases where a STA does not have any UL resources allocated that may be used for transmission of such information, the STA may need to wait for a subsequent transmission opportunity prior to making the UL transmission, which may add to latency at the STA.

### SUMMARY

The described techniques relate to improved methods, systems, devices, or apparatuses that support random access resources for uplink transmissions in certain wireless frames, and which support and prioritization of random access resources among a number of stations (STAs). In some examples, an access point (AP) may configure one or more trigger frames, which may include a number of frequency-division-multiplexed resource units (RUs). A number of different STAs may use different RUs to simultaneously send uplink traffic to an AP. In some cases, one or more RUs may be assigned for random access, and multiple STAs can contend to use such random access RUs. Techniques provided herein provide prioritization for which STAs may contend for access to random access RUs. In some cases, separate subsets of random access RUs may be identified or allocated for STAs that are associated versus unassociated with the AP, and an AP may assign different numbers of random access RUs for associated versus unassociated STAs. In some cases, STAs having relatively poorer channel conditions may be prioritized ahead of STAs having relatively good channel conditions. In some cases, associated STAs may modify a random access counter or countdown process based on whether the STA is uplink-limited, and may contend for access to a random access RU based on a value of the random access counter. In some cases, the random access counter or countdown process may be modified based on channel conditions at the STA.

In some cases, the trigger frame may be a buffer status report poll (BSRP) trigger frame and may have random access RUs configured that may be used for buffer status report (BSR) transmissions from STAs. In the event that a STA has a non-empty buffer, the STA may attempt to use one of the random access RUs for a BSR transmission. If a STA has an empty buffer, the STA may be prohibited from attempting to use a random access RU for a BSR transmission.

In some cases, an AP may acknowledge uplink transmissions that are transmitted in random access RUs. The AP may, in some cases, transmit an acknowledgment of an uplink transmission in a random access RU using an acknowledgment frame associated with the particular random access RU, and also transmit an indication of a STA that transmitted the uplink transmission. A STA may confirm that the acknowledgment is for its uplink transmission by comparing the indication of the STA provided by the AP with the STA' s identification.

A method of wireless communication is described. The method may include receiving, at a STA, a trigger frame from an AP that indicates one or more random access RUs are available for an uplink transmission from the STA, determining a connectivity parameter of the STA with the AP, the connectivity parameter associated with an eligibility of the one or more random access RUs, modifying a value of a random access counter responsive to the determining, and transmitting the uplink transmission using one or more of the random access RUs based at least in part on the modified value of the random access counter.

An apparatus for wireless communication is described. The apparatus may include means for receiving, at a STA, a trigger frame from an AP that indicates one or more random access resource units RUs are available for an uplink transmission from the STA, means for determining a connectivity parameter of the STA with the AP, the connectivity parameter associated with an eligibility of the one or more random access RUs, means for modifying a value of a random access counter responsive to the determining, and means for transmitting the uplink transmission using one or more of the random access RUs based at least in part on the modified value of the random access counter.

Another apparatus for wireless communication is described. The apparatus may include a processor, memory in electronic communication with the processor, and instructions stored in the memory. The instructions may be operable to cause the processor to receive, at a STA, a trigger frame from an AP that indicates one or more random access RUs are available for an uplink transmission from the STA, determine a connectivity parameter of the STA with the AP, the connectivity parameter associated with an eligibility of the one or more random access RUs, modify a value of a random access counter responsive to the determining, and transmit the uplink transmission using one or more of the random access RUs based at least in part on the modified value of the random access counter.

A non-transitory computer-readable medium for wireless communication is described. The non-transitory computer-readable medium may include instructions operable to cause a processor to receive, at a STA, a trigger frame from an AP that indicates one or more random access RUs are available for an uplink transmission from the STA, determine a connectivity parameter of the STA with the AP, the connectivity parameter associated with an eligibility of the one or more random access RUs, modify a value of a random access counter responsive to the determining, and transmit the uplink transmission using one or more of the random access RUs based at least in part on the modified value of the random access counter.

Some examples of the method, apparatus, and non-transitory computer-readable medium described above may further include processes, features, means, or instructions for identifying a prioritization rule for one or more of the random access RUs, wherein transmitting the uplink transmission using one or more of the random access RUs comprises transmitting the uplink transmission based at least in part on the identified prioritization rule.

In some examples of the method, apparatus, and non-transitory computer-readable medium described above, the prioritization rule may be applied to each of the one or more random access RUs. In some examples of the method, apparatus, and non-transitory computer-readable medium described above, the prioritization rule may be applied to the one or more random access RUs on a per random access RU-basis.

Some examples of the method, apparatus, and non-transitory computer-readable medium described above may further include processes, features, means, or instructions for receiving the prioritization rule via signaling in a User Info field. Some examples of the method, apparatus, and non-transitory computer-readable medium described above may further include processes, features, means, or instructions for determining that the STA may be associated with the AP. In such instances, the trigger frame can further indicate that the one or more random access RUs may be available for uplink transmissions of associated STAs. In some examples of the method, apparatus, and non-transitory computer-readable medium described above, the trigger frame further indicates that at least a first RU different from the one or more random access RUs.

Some examples of the method, apparatus, and non-transitory computer-readable medium described above may further include processes, features, means, or instructions for receiving the prioritization rule via signaling in an overloaded bit. In some examples of the method, apparatus, and non-transitory computer-readable medium described above, the prioritization rule may be applied to each of the one or more random access RUs of the trigger frame. In some examples of the method, apparatus, and non-transitory computer-readable medium described above, the prioritization rule may be applied based at least in part on a combination of entries to two or more RU allocation subfields of the trigger frame.

In some examples of the method, apparatus, and non-transitory computer-readable medium described above, the transmitting the uplink transmission using one or more of the random access RUs comprises transmitting the uplink transmission based at least in part on a new entry to a RU allocation subfield of the trigger frame. In some examples of the method, apparatus, and non-transitory computer-readable medium described above, the determining that the STA may be uplink-limited comprises determining that one or more uplink transmissions may have failed prior to receiving the trigger frame. In some examples of the method, apparatus, and non-transitory computer-readable medium described above, the determining the connectivity parameter of the STA with the AP comprises determining that the STA may be uplink-limited.

In some examples of the method, apparatus, and non-transitory computer-readable medium described above, the information subfield may be used to indicate spatial stream allocations in non-random access RUs and may be used to indicate, in random access RUs, one or more of preferential random access, presence of random access RUs in future trigger frames, a number of random access RUs associated with the trigger frame, or combinations thereof.

In some examples of the method, apparatus, and non-transitory computer-readable medium described above, the trigger frame comprises a first association identification (AID) that indicates that the one or more random access RUs may be available for uplink transmissions of associated STAs and a second AID that indicates that at least the first RU may be available for uplink transmissions of unassociated STAs.

In some examples of the method, apparatus, and non-transitory computer-readable medium described above, a first number of random access RUs for associated STAs may be greater than a second number of random access RUs for unassociated STAs. In some examples of the method, apparatus, and non-transitory computer-readable medium described above, a first number of random access RUs for associated STAs may be less than a second number of random access RUs for unassociated STAs. In some examples of the method, apparatus, and non-transitory computer-readable medium described above, the one or more random access RUs may be available for uplink transmissions only from STAs that may be associated with the AP. In some examples of the method, apparatus, and non-transitory computer-readable medium described above, the one or more random access RUs may be available for uplink transmissions only from STAs that may be unassociated with the AP.

In some examples of the method, apparatus, and non-transitory computer-readable medium described above, the trigger frame further indicates one or more parameters associated with the random access RUs in an information subfield that may be used to indicate different information for non-random access RUs. In some examples, such an information subfield may be used to indicate spatial stream allocations in non-random access RUs (for example, a spatial stream (SS) Allocation subfield in a User Info (or, User Information) field) and is used to indicate, in random access RUs, one or more of preferential random access, presence of random access RUs in future trigger frames, a number of random access RUs associated with the trigger frame, or combinations thereof.

Some examples of the method, apparatus, and non-transitory computer-readable medium described above may further include processes, features, means, or instructions for allocating a greater number of RUs for the STA based at least in part on determining that the STA may be uplink-limited, wherein determining that the STA may be uplink-limited may be based at least in part on the connectivity parameter. In some examples of the method, apparatus, and non-transitory computer-readable medium described above, the modifying may be based at least in part on the associated eligibility of the one or more random access RUs, the one or more random access RUs including one or more restricted RUs.

Some examples of the method, apparatus, and non-transitory computer-readable medium described above may further include processes, features, means, or instructions for determining that the STA may be uplink limited comprises determining that a STA long retry count (SLRC) may be non-zero.

Some examples of the method, apparatus, and non-transitory computer-readable medium described above may further include processes, features, means, or instructions for bypassing the random access counter when a STA signal strength may be below a threshold value and transmitting the uplink transmission using one or more of the random access RUs irrespective of a value of the random access counter.

Some examples of the method, apparatus, and non-transitory computer-readable medium described above may further include processes, features, means, or instructions for determining that the STA has a STA signal strength value that is below a threshold value. In such instances, the transmitting can be based at least in part on the STA signal strength being below the threshold value. In some cases the STA signal strength corresponds to a received signal strength index (RSSI) of a signal transmitted from the STA to an AP. In other cases, the STA signal strength corresponds to a RSSI of a trigger frame received at the STA.

In some examples of the method, apparatus, and non-transitory computer-readable medium described above, the random access counter may be modified by decrementing a backoff counter based at least in part on a number of random access RUs indicated in the trigger frame when the STA may be uplink limited. In some examples of the method, apparatus, and non-transitory computer-readable medium, the backoff counter may be modified at a first rate when a STA signal strength is below a threshold value and modified at a second rate when the STA signal strength is at or above the threshold value. In such instances, the first rate may be greater than the second rate. In some examples, the backoff counter may be bypassed when the STA signal strength is below the threshold, and the STA may attempt a transmission in a random access RU irrespective of a value of the backoff counter. In some examples of the method, apparatus, and non-transitory computer-readable medium described above, the uplink transmission may be attempted when the backoff counter reaches zero. In some examples of the method, apparatus, and non-transitory computer-readable medium described above, the backoff counter may be maintained at a same value when the STA may be not uplink limited or has relatively good channel conditions. In some examples of the method, apparatus, and non-transitory computer-readable medium described above, the backoff counter may be an orthogonal frequency division multiple access (OFDMA) backoff (OBO) counter.

A method of wireless communication is described. The method may include receiving, at a STA, a trigger frame from an AP that indicates one or more random access RUs are available for a transmission of an uplink transmission from the STA to the AP, determining that the STA has a non-empty buffer, and transmitting the uplink transmission using one or more of the random access RUs based at least in part on the determining.

An apparatus for wireless communication is described. The apparatus may include means for receiving, at a STA, a trigger frame from an AP that indicates one or more random access RUs are available for a transmission of an uplink transmission from the STA to the AP, means for determining that the STA has a non-empty buffer, and means for transmitting the uplink transmission using one or more of the random access RUs based at least in part on the determining.

Another apparatus for wireless communication is described. The apparatus may include a processor, memory in electronic communication with the processor, and instructions stored in the memory. The instructions may be operable to cause the processor to receive, at a STA, a trigger frame from an AP that indicates one or more random access RUs are available for a transmission of an uplink transmission from the STA to the AP, determine that the STA has a non-empty buffer, and transmit the uplink transmission using one or more of the random access RUs based at least in part on the determining.

A non-transitory computer-readable medium for wireless communication is described. The non-transitory computer-readable medium may include instructions operable to cause a processor to receive, at a STA, a trigger frame from an AP that indicates one or more random access RUs are available for a transmission of an uplink transmission from the STA to the AP, determine that the STA has a non-empty buffer, and transmit the uplink transmission using one or more of the random access RUs based at least in part on the determining.

Some examples of the method, apparatus, and non-transitory computer-readable medium described above may further include processes, features, means, or instructions for determining that the STA may be associated with the AP, and wherein the received trigger frame indicates that the one or more random access RUs may be available for random access transmissions of associated STAs.

In some examples of the method, apparatus, and non-transitory computer-readable medium described above, the received trigger frame comprises a first AID that indicates the one or more random access RUs available for transmission of the uplink transmission. In some examples of the method, apparatus, and non-transitory computer-readable medium described above, the trigger frame may be received in a BSRP trigger frame, and the transmission may be a buffer status report. In some examples of the method, apparatus, and non-transitory computer-readable medium described above, the trigger frame comprises a buffer status request, a buffer quality request, a basic trigger frame, or a combination thereof.

A method of wireless communication is described. The method may include receiving, at a STA, a trigger frame from an AP that indicates one or more random access RUs are available for an uplink transmission from the STA, the random access RUs identified using a first AID, transmitting the uplink transmission to the AP using a first RU of the one or more of the random access RUs, receiving an acknowledgment in a downlink transmission from the AP that indicates whether the uplink transmission in the first RU was successfully received at the AP, receiving a signaling field in the downlink transmission that includes a STA identification associated with the acknowledgment, and determining that the uplink transmission to the AP was successfully received based at least in part on the acknowledgment and the STA identification.

An apparatus for wireless communication is described. The apparatus may include means for receiving, at a STA, a trigger frame from an AP that indicates one or more random access RUs are available for an uplink transmission from the STA, the random access RUs identified using a first AID, means for transmitting the uplink transmission to the AP using a first RU of the one or more of the random access RUs, means for receiving an acknowledgment in a downlink transmission from the AP that indicates whether the uplink transmission in the first RU was successfully received at the AP; means for receiving a signaling field in the downlink transmission that includes a STA identification associated with the acknowledgment, and means for determining that the uplink transmission to the AP was successfully received based at least in part on the acknowledgment and the STA identification. In some cases, the acknowledgment may have the first AID.

Another apparatus for wireless communication is described. The apparatus may include a processor, memory in electronic communication with the processor, and instructions stored in the memory. The instructions may be operable to cause the processor to receive, at a STA, a trigger frame from an AP that indicates one or more random access RUs are available for an uplink transmission from the STA, the random access RUs identified using a first AID, transmit the uplink transmission to the AP using a first RU of the one or more of the random access RUs, receive an acknowledgment in a downlink transmission from the AP that indicates whether the uplink transmission in the first RU was successfully received at the AP, receive a signaling field in the downlink transmission that includes a STA identification associated with the acknowledgment, and determine that the uplink transmission to the AP was successfully received based at least in part on the acknowledgment and the STA identification. In some cases, the acknowledgment may have the first AID.

A non-transitory computer-readable medium for wireless communication is described. The non-transitory computer-readable medium may include instructions operable to cause a processor to receive, at a STA, a trigger frame from an AP that indicates one or more random access RUs are available for an uplink transmission from the STA, the random access RUs identified using a first AID, transmit the uplink transmission to the AP using a first RU of the one or more of the random access RUs, receive an acknowledgment in a downlink transmission from the AP that indicates whether the uplink transmission in the first RU was successfully received at the AP, receive a signaling field in the downlink transmission that includes a STA identification associated with the acknowledgment, and determine that the uplink transmission to the AP was successfully received based at least in part on the acknowledgment and the STA identification. In some cases, the acknowledgment may have the first AID.

In some examples of the method, apparatus, and non-transitory computer-readable medium described above, the acknowledgment comprises the first AID, a medium access control (MAC) address, or a combination thereof. In some examples of the method, apparatus, and non-transitory computer-readable medium described above, the STA may be associated with the AP and the first AID may be for associated STAs. In some examples of the method, apparatus, and non-transitory computer-readable medium described above, the STA may be unassociated with the AP and the MAC address may be for unassociated STAs. In some cases, the STA may have a first STA identification.

In some examples of the method, apparatus, and non-transitory computer-readable medium described above, the determining comprises determining that the uplink transmission was successfully received when the STA identification in the signaling field matches the first STA identification, and determining that the uplink transmission was unsuccessfully received when the STA identification in the signaling field may be different than the first STA identification.

In some examples of the method, apparatus, and non-transitory computer-readable medium described above, the STA may be associated with the AP and the first AID is for associated STAs. In some examples of the method, apparatus, and non-transitory computer-readable medium described above, the STA is unassociated with the AP and the first AID is for unassociated STAs. In some examples of the method, apparatus, and non-transitory computer-readable medium described above, the STA identification comprises one or more of a STA identification (STA-ID) or a MAC address. In some examples of the method, apparatus, and non-transitory computer-readable medium described above, the STA-ID comprises a value representing all unassociated STAs.

A method of wireless communication is described. The method may include transmitting, from an AP, a trigger frame to two or more STAs that indicates one or more random access RUs are available for uplink transmissions from the STAs, the one or more random access RUs identified with a first AID, receiving a first uplink transmission from a first STA over a first RU of the one or more of the random access RUs, identifying a STA identification of the first STA, transmitting an acknowledgment that indicates that the first uplink transmission in the first RU was successfully received at the AP, and transmitting a signaling field that includes the STA identification of the first STA. In some cases, the acknowledgment may have the first AID.

An apparatus for wireless communication is described. The apparatus may include means for transmitting, from an AP, a trigger frame to two or more STAs that indicates one or more random access RUs are available for uplink transmissions from the STAs, the one or more random access RUs identified with a first AID, means for receiving a first uplink transmission from a first STA over a first RU of the one or more of the random access RUs, means for identifying a STA identification of the first STA, means for transmitting an acknowledgment that indicates that the first uplink transmission in the first RU was successfully received at the AP, and means for transmitting a signaling field that includes the STA identification of the first STA. In some cases, the acknowledgment may have the first AID.

Another apparatus for wireless communication is described. The apparatus may include a processor, memory in electronic communication with the processor, and instructions stored in the memory. The instructions may be operable to cause the processor to transmit, from an AP, a trigger frame to two or more STAs that indicates one or more random access RUs are available for uplink transmissions from the STAs, the one or more random access RUs identified with a first AID, receive a first uplink transmission from a first STA over a first RU of the one or more of the random access RUs, identify a STA identification of the first STA, transmit an acknowledgment that indicates that the first uplink transmission in the first RU was successfully received at the AP, and transmit a signaling field that includes the STA identification of the first STA. In some cases, the acknowledgment may have the first AID.

A non-transitory computer-readable medium for wireless communication is described. The non-transitory computer-readable medium may include instructions operable to cause a processor to transmit, from an AP, a trigger frame to two or more STAs that indicates one or more random access RUs are available for uplink transmissions from the STAs, the one or more random access RUs identified with a first AID, receive a first uplink transmission from a first STA over a first RU of the one or more of the random access RUs, identify a STA identification of the first STA, transmit an acknowledgment that indicates that the first uplink transmission in the first RU was successfully received at the AP, and transmit a signaling field that includes the STA identification of the first STA. In some cases, the acknowledgment may have the first AID.

Some examples of the method, apparatus, and non-transitory computer-readable medium described above may further include processes, features, means, or instructions for identifying a prioritization rule for one or more of the random access RUs. Some examples of the method, apparatus, and non-transitory computer-readable medium described above may further include processes, features, means, or instructions for transmitting an indication of the prioritization rule to the first STA, wherein receiving the first uplink transmission may be based at least in part on the transmitted indication of the prioritization rule.

In some examples of the method, apparatus, and non-transitory computer-readable medium described above, the prioritization rule may be applied to each of the one or more random access RUs. In some examples of the method, apparatus, and non-transitory computer-readable medium described above, the prioritization rule may be applied to the one or more random access RUs on a per random access RU-basis. Some examples of the method, apparatus, and non-transitory computer-readable medium described above may further include processes, features, means, or instructions for transmitting the indication of the prioritization rule via signaling in a User Info field. Some examples of the method, apparatus, and non-transitory computer-readable medium described above may further include processes, features, means, or instructions for transmitting the indication of the prioritization rule via signaling in an overloaded bit.

In some examples of the method, apparatus, and non-transitory computer-readable medium described above, the prioritization rule may be applied to each of the one or more random access RUs of the trigger frame. In some examples of the method, apparatus, and non-transitory computer-readable medium described above, the prioritization rule may be applied based at least in part on a new entry to a RU allocation subfield of the trigger frame. In some examples of the method, apparatus, and non-transitory computer-readable medium described above, the prioritization rule may be applied based at least in part on a combination of entries to two or more RU allocation subfields of the trigger frame.

In some examples of the method, apparatus, and non-transitory computer-readable medium described above, the one or more random access RUs comprise a first subset of RUs for STAs that may be associated with the AP and that may be indicated in the trigger frame by the first AID, and the one or more random access RUs further comprise a second subset of RUs for STAs that may be unassociated with the AP and that may be indicated in the trigger frame by a second AID.

In some examples of the method, apparatus, and non-transitory computer-readable medium described above, the first RU may be in the first subset of RUs, and wherein the transmitting the acknowledgment comprises transmitting an acknowledgment frame in a downlink RU identified by the first AID. In some examples of the method, apparatus, and non-transitory computer-readable medium described above, the first RU may be in the second subset of RUs, and wherein the transmitting the acknowledgment comprises transmitting an acknowledgment frame in a downlink RU identified by the second AID. In some examples of the method, apparatus, and non-transitory computer-readable medium described above, the STA identification comprises one or more of a STA-ID or a MAC address.

A method of wireless communication is described. The method may include receiving, at a STA, a trigger frame from an AP that indicates one or more random access RUs are available for an uplink transmission from the STA, determining a connectivity parameter of the STA with the AP, the connectivity parameter associated with an eligibility of the one or more random access RUs, and transmitting the uplink transmission using one or more of the random access RUs based at least in part on the determined connectivity parameter.

An apparatus for wireless communication is described. The apparatus may include means for receiving, at a STA, a trigger frame from an AP that indicates one or more random access RUs are available for an uplink transmission from the STA, means for determining a connectivity parameter of the STA with the AP, the connectivity parameter associated with an eligibility of the one or more random access RUs, and means for transmitting the uplink transmission using one or more of the random access RUs based at least in part on the determined connectivity parameter.

Another apparatus for wireless communication is described. The apparatus may include a processor, memory in electronic communication with the processor, and instructions stored in the memory. The instructions may be operable to cause the processor to receive, at a STA, a trigger frame from an AP that indicates one or more random access RUs are available for an uplink transmission from the STA, determine a connectivity parameter of the STA with the AP, the connectivity parameter associated with an eligibility of the one or more random access RUs, and transmit the uplink transmission using one or more of the random access RUs based at least in part on the determined connectivity parameter.

A non-transitory computer-readable medium for wireless communication is described. The non-transitory computer-readable medium may include instructions operable to cause a processor to receive, at a STA, a trigger frame from an AP that indicates one or more random access RUs are available for an uplink transmission from the STA, determine a connectivity parameter of the STA with the AP, the connectivity parameter associated with an eligibility of the one or more random access RUs, and transmit the uplink transmission using one or more of the random access RUs based at least in part on the determined connectivity parameter.

Some examples of the method, apparatus, and non-transitory computer-readable medium described above may further include processes, features, means, or instructions for determining whether to transmit the uplink transmission at a first transmit power for an assigned modulation and coding scheme (MCS) based at least in part on one or more restricted RUs, wherein the connectivity parameter may be based at least in part on the associated eligibility of the one or more random access RUs, the one or more random access RUs including the one or more restricted RUs.

In some examples of the method, apparatus, and non-transitory computer-readable medium described above, the first transmit power for the assigned MCS may be a maximum transmit power for the assigned MCS.

Some examples of the method, apparatus, and non-transitory computer-readable medium described above may further include processes, features, means, or instructions for determining that the first STA may be able to meet a target RSSI threshold without exceeding a power headroom limit, wherein transmitting the uplink transmission may be based at least in part on determining that the first STA may be able to meet the target RSSI threshold without exceeding the power headroom limit. In some examples of the method, apparatus, and non-transitory computer-readable medium described above, the target RSSI threshold may be based at least in part on an assigned MCS.

Some examples of the method, apparatus, and non-transitory computer-readable medium described above may further include processes, features, means, or instructions for determining a presence of an indication of a power headroom limit for the connectivity parameter. Some examples of the method, apparatus, and non-transitory computer-readable medium described above may further include processes, features, means, or instructions for identifying a prioritization rule for one or more of the random access RUs based at least in part on the determined presence of the indication of the power headroom limit, wherein transmitting the uplink transmission using one or more of the random access RUs may be based at least in part on the identified prioritization rule.

Some examples of the method, apparatus, and non-transitory computer-readable medium described above may further include processes, features, means, or instructions for determining an absence of an indication of a power headroom limit, wherein transmitting the uplink transmission using one or more of the random access RUs may be based at least in part on the absence of the indication of the power headroom limit.

Some examples of the method, apparatus, and non-transitory computer-readable medium described above may further include processes, features, means, or instructions for determining a default power headroom limit based at least in part on determining the absence of the indication of the power headroom limit.

Some examples of the method, apparatus, and non-transitory computer-readable medium described above may further include processes, features, means, or instructions for determining a feedback indication based at least in part on a connectivity of a second STA with the AP. Some examples of the method, apparatus, and non-transitory computer-readable medium described above may further include processes, features, means, or instructions for transmitting the feedback indication to the AP. In some examples of the method, apparatus, and non-transitory computer-readable medium described above, the feedback indication comprises NDP feedback.

A method of wireless communication is described. The method may include transmitting, from an AP, a trigger frame to a first STA of a first set of STAs that indicates one or more random access RUs are available for uplink transmissions from the STA, determining a prioritization rule for one or more of the random access RUs, transmitting to the first STA an indication of the prioritization rule for one or more of the random access RUs, and receiving a first uplink transmission from the first STA over a first RU of the one or more of the random access RUs based at least in part on the prioritization rule.

An apparatus for wireless communication is described. The apparatus may include means for transmitting, from an AP, a trigger frame to a first STA of a first set of STAs that indicates one or more random access RUs are available for uplink transmissions from the STA, means for determining a prioritization rule for one or more of the random access RUs, means for transmitting to the first STA an indication of the prioritization rule for one or more of the random access RUs, and means for receiving a first uplink transmission from the first STA over a first RU of the one or more of the random access RUs based at least in part on the prioritization rule.

Another apparatus for wireless communication is described. The apparatus may include a processor, memory in electronic communication with the processor, and instructions stored in the memory. The instructions may be operable to cause the processor to transmit, from an AP, a trigger frame to a first STA of a first set of STAs that indicates one or more random access RUs are available for uplink transmissions from the STA, determine a prioritization rule for one or more of the random access RUs, transmit to the first STA an indication of the prioritization rule for one or more of the random access RUs, and receive a first uplink transmission from the first STA over a first RU of the one or more of the random access RUs based at least in part on the prioritization rule.

A non-transitory computer-readable medium for wireless communication is described. The non-transitory computer-readable medium may include instructions operable to cause a processor to transmit, from an AP, a trigger frame to a first STA of a first set of STAs that indicates one or more random access RUs are available for uplink transmissions from the STA, determine a prioritization rule for one or more of the random access RUs, transmit to the first STA an indication of the prioritization rule for one or more of the random access RUs, and receive a first uplink transmission from the first STA over a first RU of the one or more of the random access RUs based at least in part on the prioritization rule.

In some examples of the method, apparatus, and non-transitory computer-readable medium described above, the trigger frame comprises the indication of the prioritization rule. In some examples of the method, apparatus, and non-transitory computer-readable medium described above, the prioritization rule may be based at least in part on a location of the first STA. In some examples of the method, apparatus, and non-transitory computer-readable medium described above, the first STA comprises a cell-edge STA.

In some examples of the method, apparatus, and non-transitory computer-readable medium described above, the prioritization rule may be based at least in part on a ratio of cell-edge STAs of the first set of STAs to a total number of STAs of the first set of STAs. In some examples of the method, apparatus, and non-transitory computer-readable medium described above, the prioritization rule may be based at least in part on an elapsed time since a previous received uplink transmission from the first STA. In some examples of the method, apparatus, and non-transitory computer-readable medium described above, the prioritization rule may be based at least in part on a total number of STAs in the first set of STAs.

Some examples of the method, apparatus, and non-transitory computer-readable medium described above may further include processes, features, means, or instructions for receiving a feedback indication from a second STA of the first set of STAs, wherein the prioritization rule may be determined based at least in part on the received feedback. In some examples of the method, apparatus, and non-transitory computer-readable medium described above, the feedback indication comprises null data packet feedback.

Some examples of the method, apparatus, and non-transitory computer-readable medium described above may further include processes, features, means, or instructions for determining to transmit the trigger frame to the first STA of the first set of STAs based at least in part on a feedback indication received from a second STA of the first set of STAs, an elapsed time since a previous received uplink transmission from a cell-edge STA, or a combination thereof.

Some examples of the method, apparatus, and non-transitory computer-readable medium described above may further include processes, features, means, or instructions for transmitting the trigger frame to a second STA of the two or more STAs that indicates one or more random access RUs may be available for uplink transmissions from the STAs. Some examples of the method, apparatus, and non-transitory computer-readable medium described above may further include processes, features, means, or instructions for transmitting to the second STA the indication of the prioritization rule for one or more of the random access RUs.

Some examples of the method, apparatus, and non-transitory computer-readable medium described above may further include processes, features, means, or instructions for receiving a second uplink transmission from the second STA over a second RU of the one or more of the random access RUs based at least in part on the prioritization rule.

Some examples of the method, apparatus, and non-transitory computer-readable medium described above may further include processes, features, means, or instructions for determining that a second uplink transmission was not received from the second STA over a second RU of the one or more of the random access RUs based at least in part on the prioritization rule.

### BRIEF DESCRIPTION OF THE DRAWINGS

FIG. 1 illustrates a wireless local area network (WLAN) configured in accordance with aspects of the present disclosure.

FIG. 2 illustrates an example of a wireless communications system that supports random access request regulation techniques for wireless stations in accordance with aspects of the present disclosure.

FIG. 3 illustrates an example of wireless resources that support random access request regulation techniques for wireless stations in accordance with aspects of the present disclosure.

FIG. 4 illustrates example trigger frames with resource units allocated for associated and unassociated wireless stations that support random access request regulation techniques in accordance with aspects of the present disclosure.

FIG. 5 illustrates a WLAN configured in accordance with aspects of the present disclosure.

FIG. 6 illustrates an example of a process flow for a system that supports random access request regulation techniques for wireless stations in accordance with aspects of the present disclosure.

FIG. 7 illustrates another example of a process flow for a system that supports random access request regulation techniques for wireless stations in accordance with aspects of the present disclosure.

FIG. 8 illustrates another example of a process flow for a system that supports random access request regulation techniques for wireless stations in accordance with aspects of the present disclosure.

FIGS. 9 through 10 show block diagrams of wireless devices that support random access regulation techniques for wireless stations in accordance with aspects of the present disclosure.

FIG. 11 shows a block diagram of a station (STA) random access manager that supports random access regulation techniques for wireless stations in accordance with aspects of the present disclosure.

FIG. 12 illustrates a block diagram of a system including a STA that supports random access regulation techniques for wireless stations in accordance with aspects of the present disclosure.

FIGS. 13 through 15 show block diagrams of devices that support random access regulation techniques for wireless stations in accordance with aspects of the present disclosure.

FIG. 16 shows a block diagram of a system including an access point (AP) that supports random access regulation techniques for wireless stations in accordance with aspects of the present disclosure.

FIGS. 17 through 29 illustrate methods for random access regulation techniques for wireless stations in accordance with aspects of the present disclosure.

### DETAILED DESCRIPTION

In some wireless communication systems, an access point (AP) may configure one or more trigger frames, which may include a number of frequency-division-multiplexed resource units (RUs) that may be assigned to one or more different stations (STAs) and used for uplink transmissions from the STAs. Such trigger frames may enable multiple STAs to send uplink traffic to an AP concurrently in time over different frequencies. A trigger frame may address one or more STAs through an association identification (AID) for each STA, and may assign each AID one or more unique RUs that can be used to send uplink traffic to the AP.

In some cases, an AP also may configure one or more RUs of a trigger frame for random access. In such cases, multiple STAs can contend to use the random access RUs, which in some cases may result in collisions between uplink transmissions of two or more STAs resulting in wastage of the random access RUs. Various techniques provided herein provide for prioritization of STAs that may contend for usage of random access (RA) RUs, which may reduce the likelihood of collisions between multiple STAs for particular random access RUs and thereby enhance system efficiency.

In some cases, associated STAs may modify a random access counter based on whether the STA is uplink-limited or has relatively poor channel conditions, and may contend for access to one or more random access RUs based on a value of the random access counter. For example, a STA may maintain an orthogonal frequency division multiple access (OFDMA) backoff (OBO) counter, and the STA may contend for use of a random access RU only when the OBO counter has a certain value (such as zero or a value that is less than a number of random access RUs in a trigger frame). In some cases, a STA may only modify its OBO counter if the STA is uplink-limited or has relatively poor channel conditions. In some cases, a STA with relatively poor channel conditions is a STA having a target received signal strength indicator (RSSI) that is below a threshold value. In some cases the target RSSI is for a signal transmitted from the STA to an AP. In other cases, the target RSSI may correspond to a RSSI of a trigger frame received at the STA. In some implementations, an uplink-limited STA is a STA that has transmitted one or more uplink transmissions that the AP has failed to receive. In other implementations, an uplink-limited STA may be identified based on one or more factors which may include, for example, the presence of retransmissions from the STA, channel conditions at the STA, a buffer size of the STA, a quality-of-service (QoS) target for communications, or any combination thereof. In such cases, STAs that are uplink-limited have higher priority to the random access RUs than STAs that are not uplink-limited.

In some cases, separate subsets of random access RUs may be identified for STAs that are associated and unassociated with the AP, and an AP may assign different numbers of random access RUs for associated versus unassociated STAs. For example, an AP may identify that a number of associated STAs are uplink-limited, and may provide additional random access RUs that are available to associated STAs and fewer random access RUs that are available for unassociated STAs. In other implementations, an AP may identify that a relatively large number of probe requests are received from unassociated STAs and may provide additional random access RUs to unassociated STAs. In still further implementations, an AP may provide random access RUs only to associated STAs or, conversely, only to unassociated STAs. In some cases, the random access RUs may be assigned to associated versus unassociated STAs by assigning separate AIDs for the associated STAs than for the unassociated STAs, which the STAs may recognize the AIDs and identify the random access RUs based on the associated or unassociated status of the respective STA.

In some cases, the trigger frame may be a buffer status report poll (BSRP) trigger frame and may have random access RUs configured that may be used for buffer status report (BSR) transmissions from STAs. In the event that a STA has a non-empty buffer, the STA may attempt to use one or more of the random access RUs for a BSR transmission. If a STA has an empty buffer, the STA may be prohibited from attempting to use a random access RU for a BSR transmission.

In some cases, an AP may acknowledge uplink transmissions that are transmitted in random access RUs. The AP may, in some cases, transmit an acknowledgment of an uplink transmission in a random access RU using an acknowledgment frame in a downlink RU having a same AID as the AID of the particular random access RU. In such instances, the AP also may transmit an indication of a STA that transmitted the uplink transmission. A STA may confirm that the acknowledgment is for its uplink transmission by comparing the indication of the STA provided by the AP with the STA's identification.

Aspects of the disclosure are initially described in the context of a wireless communications system. Examples of random access resources and process flows are then described for wireless devices that support regulation of random access resources. Aspects of the disclosure are further illustrated by and described with reference to apparatus diagrams, system diagrams, and flowcharts that relate to random access regulation techniques for wireless stations.

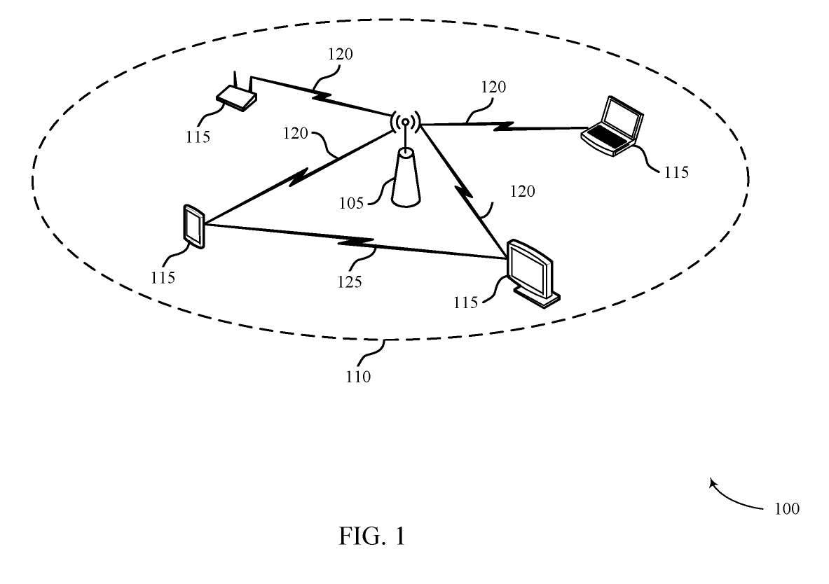

FIG. 1 illustrates a wireless local area network (WLAN) 100 (also known as a Wi-Fi network) configured in accordance with aspects of the present disclosure. The WLAN 100 may include an AP 105 and multiple associated STAs 115, which may represent devices such as wireless communication terminals, mobile stations, phones, personal digital assistant (PDAs), other handheld devices, netbooks, notebook computers, tablet computers, laptops, display devices (such as TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be coupled with a wired or wireless distribution system that may allow multiple APs 105 to be connected in an ESS. WLAN 100 may represent a network that supports random access regulation techniques for wireless stations.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (such as metropolitan area, home network, etc.), with varying and overlapping coverage areas 110. Two STAs 115 may also communicate directly via a direct wireless link 125 regardless of whether both STAs 115 are in the same coverage area 110. Two STAs 115 may additionally or alternatively communicate directly via a direct wireless link 125 regardless of whether both STAs 115 are in the same coverage area 110. In some cases, a second BSS may be present within a relatively close proximity of coverage area 110. The second BSS may be referred to as an overlapping basic service set. In some cases, the overlapping basic service set may be a source of interference to one or more STAs 115, where additional wireless devices associated with the overlapping basic service set may be referred to as hidden nodes and affect communications and throughput for the STAs 115.

Examples of direct wireless links 120 may include Wi-Fi Direct connections, Wi-Fi Tunneled Direct Link Setup (TDLS) links, and other group connections. The STAs 115 and the APs 105 may communicate according to the WLAN radio and baseband protocol for physical and medium access control (MAC) layers from Institute of Electrical and Electronics Engineers (IEEE) 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (such as carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. RTS/CTS may help mitigate a hidden node problem.

In some cases, an STA 115 or an AP 105 may operate in a shared or unlicensed frequency spectrum. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and the 900 MHz band. The unlicensed spectrum may also include other frequency bands. The shared nature of the unlicensed frequency spectrum may result in the STA 115 or the AP 105 contending for access to the wireless medium. For example, these devices may perform a clear channel assessment (CCA) prior to communicating in order to determine whether the channel is available. A CCA may include an energy detection procedure to determine whether there are any other active transmissions. For example, the device may infer that a change in a RSSI of a power meter indicates that a channel is occupied. Specifically, signal power is that is concentrated in a certain bandwidth and that exceeds a predetermined noise floor may indicate another wireless transmitter. A CCA may also include detection of specific sequences that indicate use of the channel. For example, another device may transmit a specific preamble prior to transmitting a data sequence.

In various implementations, an AP 105 may allocate resources for random access transmissions. In some cases, resources for random access transmissions may be indicated in a trigger frame, which may include a number of frequency-division-multiplexed RUs that may be assigned to one or more different STAs 115. In some wireless communications systems, a trigger frame may refer to a frame that solicits a simultaneous response from one or more peer STAs 115. For example, some wireless communications systems (for example, an IEEE 802.11 wireless communications system) may define a Control Frame as a Trigger frame. A trigger frame may address one or more STAs 115 associated or unassociated with a corresponding AP 105, for example, via an AID assigned to the STA 115, or a particular type of STA 115 (for example, one AID may correspond to associated STAs 115, and a second AID may correspond to unassociated STAs 115), in a field that provides per-user information (for example, a User Info field). This per-user field may carry information indicating that one or more RUs are assigned to a peer STA 115 for a response. A trigger frame may also carry one or more fields (for example, a Common Info field) or subfields that provide information to multiple STAs 115 addressed in the frame, or, in some cases, all STAs 115 addressed in the frame. A trigger frame may further carry one or more random access RUs, that is, RUs that may be open for use by any STA 115 that may not have been assigned a dedicated RU. Random access RUs may be further identified based on whether they are dedicated for use by STAs 115 unassociated with a corresponding AP 105, or STAs 115 that are associated with the AP 105. In some implementations, in addition to being sent from an AP 105 to STAs 115, a trigger frame may additionally or alternatively be sent from an AP 105 to another AP 105 or from one STA 115 to another STA 115.

RUs within the trigger frame may be assigned to STAs 115 using an AID that is assigned to a STA 115. An AP 105 may indicate that one or more RUs are allocated for random access transmissions by assigning an AID associated with random access to the RUs. In some cases, an AP 105 may use a first AID for random access RUs of associated STAs 115 and may use a second AID for random access RUs of unassociated STAs 115. The RUs may allocate different frequency resources to different STAs 115 (such as different tones may be allocated to different STAs 115), and may have multiple random access RUs, and enable multiple STAs 115 to simultaneously send uplink traffic to the AP 105.

In cases where one or more RUs are configured for random access, multiple STAs 115 can contend to use the random access RUs, which in some cases may result in collisions between uplink transmissions of two or more STAs 115. In some cases, STAs 115 may be prioritized in order to reduce the likelihood of collisions between multiple STAs 115 for a particular random access RU and thereby enhance system efficiency. In some implementations, an AP 105 may configure a STA 115 to only contend for random access RUs if it has relatively poor channel conditions (such as if a STA RSSI is less than an indicated target in a Target RSSI field of a User Info field in a trigger frame). STAs 115 which may have difficulty accessing the AP 105, such as cell-edge STAs 115, may have priority for a random access RU.

In some such cases, however, an STA 115 in a closer proximity to the AP 105 may possess an advantage over one or more farther away STAs 115 in gaining access to the medium through random access. In such a case, the STA 115 closer to the AP 105 may contend for and gain access to a particular set of RUs, which may then be detrimental to the usage of the same RUs by STAs 115 that may, for example, random access RUs as an its primary means to communicate with the AP 115. Further, in some cases, an AP 105 may be capable of a greater transmit power than a STA 115 (for example, because the AP 105 may be plugged into a power source, versus a battery-operated STA 115, or because an antenna and other hardware of an AP 105 may have more capabilities than that of some STAs 115). In such cases, the STA 115 may be able to hear transmissions from the AP 105, even though the AP 105 may not be able to hear transmissions from the STA 115. Such a STA 115 may be referred to as an uplink-limited STA 115, and the uplink-limited STA 115 may be said to not be able to close the link with the AP 105. The AP 105, however, may possess information (such as global knowledge) of the surrounding conditions associated with the different STAs 115, including the location of each STA 115 in its BSS. In this case, it may be beneficial for the AP 105 to configure parameters for a set of farther away STAs 115 in its BSS, or uplink-limited STAs 115, such that the farther or uplink-limited STAs 115 are able to access the resources when these conflicts with closer STAs 115 occur. The described techniques accordingly provide for an AP 115 to configure random access parameters to facilitate uplink-limited STAs accessing the medium through random access.

For example, via the described techniques, the AP 105 may regulate access to one or more RUs so that the RUs are used by STAs 115 for which the random access RUs are intended or are best suited to ensure conditions are satisfied. In doing so, the AP 105 may apply a prioritization rule for at least some, if not all, random access RUs, the AP 105 may apply a prioritization rule on a per-random access RU basis as signaled in one or more fields (such as a User Info field). Additionally or alternatively, the AP 105 may apply a prioritization rule on a per-random access RU basis as signaled in one or more bits (such as a Coding Type bit).

In some implementations, STAs 115 may modify a random access counter based on whether the STA 115 is uplink-limited, based on channel conditions of the STA 115, or any combination thereof, and may contend for access to a random access RU based on a value of the random access counter. For example, a STA 115 may maintain an OBO counter, and the STA 115 may contend for use of a random access RU only when the OBO counter has a certain value (such as zero or a value that is less than a number of random access RUs in a trigger frame). In some cases, a STA 115 may only modify its OBO counter if the STA 115 is uplink-limited (such as if the STA 115 has a STA long retry count (SLRC) that is non-zero). In such cases, STAs 115 that are uplink-limited have higher priority to the random access RUs than STAs 115 that are not uplink-limited.

In some cases, a STA 115 may modify its OBO counter based on channel conditions. For example, if a target RSSI of the STA 115 is below a threshold value (such as a Target RSSI indicated in a Target RSSI field of a User Info field in a trigger frame), the STA 115 may modify its OBO counter. In some cases, the OBO counter may be modified at different rates based on whether channel conditions at the STA 115 are above or below a certain value (such as the OBO counter may be decremented by multiple counts if a target RSSI is below a threshold value, and otherwise the OBO counter may be decremented by a single count). In some cases, the OBO counter may be bypassed when the STA signal strength is below the threshold value, and the STA 115 may attempt a transmission in a random access RU irrespective of a value of the OBO counter.

In some cases, the trigger frame may be a BSRP trigger frame and may have random access RUs configured that may be used for BSR transmissions from STAs 115. In the event that a STA 115 has a non-empty buffer, the STA 115 may attempt to use one of the random access RUs for a BSR transmission. In some cases, an AP 105 may acknowledge uplink transmissions that are transmitted in random access RUs. The AP 105 may, in some cases, transmit an acknowledgment of an uplink transmission in a random access RU using an acknowledgment frame that has a same AID as the AID of the random access RU, and also transmit an indication of a STA 115 that transmitted the uplink transmission. A STA 115 may confirm that the acknowledgment is for its uplink transmission by comparing the indication of the STA 115 provided by the AP 105 with the STA identification.

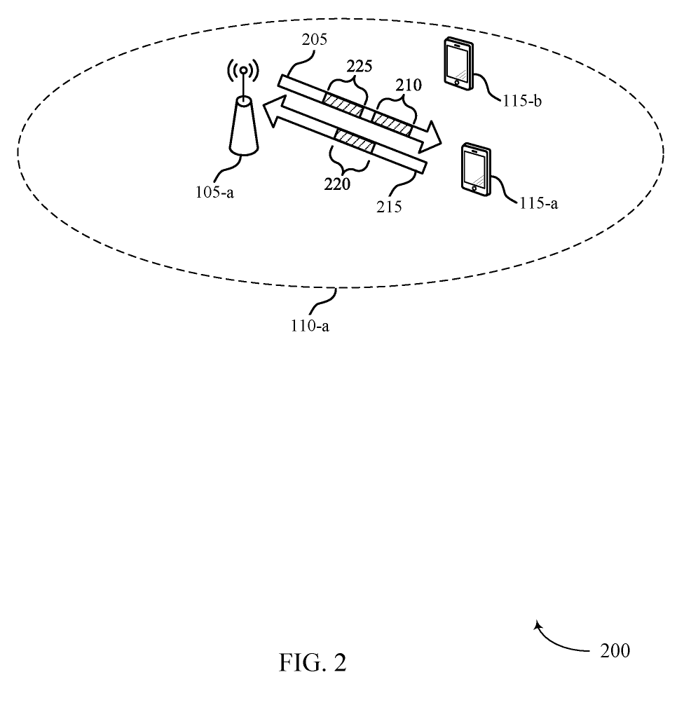

FIG. 2 illustrates an example of a wireless communications system 200 that supports random access request regulation techniques for wireless stations in accordance with aspects of the present disclosure. Wireless communications system 200 may include an AP 105-a and an STA 115-a, which may be examples of the corresponding devices as described with reference to FIG. 1. In this example, STA 115-a is an associated STA. An unassociated STA 115-b also may be within coverage area 110-a of the AP 105-a.

In wireless communications system 200, the AP 105-a may transmit downlink communications 205, which may include a trigger frame 210 to indicate random access RUs for uplink transmissions of the associated STA 115-a and the unassociated STA 115-b. In some implementations, the AP 105-a may broadcast a beacon followed by one or more trigger frames 210. In some implementations, the transmission time of the trigger frame is signaled in a preceding beacon frame and one or more trigger frames may be scheduled over a given beacon period. The associated STA 115-a may transmit uplink communications 215 which may include an uplink transmission 220 that may be transmitted in a random access RU that was indicated in the trigger frame 210. In some cases, the AP 105-a may transmit an acknowledgment 225 to the associated STA 115-a to acknowledge successful receipt of the uplink transmission 220.

As indicated above, the AP 105-a may configure trigger frame 210 with a number of frequency-division-multiplexed RUs that may enable multiple STAs 115 to simultaneously send uplink traffic to the AP 105-a. As also indicated above, one or more RUs of trigger frame 210 may be configured for random access, and multiple STAs 115 can contend to use the random access RUs. The likelihood of collisions between STAs 115 contending for access to random access RUs may be reduced, in some cases, through prioritization of STAs 115. Such prioritization may be based on one or more of: associated or unassociated statuses of the STAs 115, SLRC values of STAs 115, buffer status of STAs 115, channel conditions of STAs 115, or any combination thereof. In some implementations, the AP 105-a may configure a particular STA of STAs 115 to only contend for random access RUs if it has relatively poor channel conditions (such as if a STA RSSI is less than an indicated target in a Target RSSI field of a User Info field in a trigger frame). In some cases the target RSSI corresponds to a signal transmitted from the associated STA 115-a to an the AP 105-a. In other cases, the target RSSI may correspond to a RSSI of the trigger frame received at the STAs 115. STAs 115 which may have difficulty accessing the AP, such as cell-edge STAs 115, may have priority for a random access RU.

In some cases, the AP 105-a may transmit a trigger frame 210 that may indicate one or more random access RUs, in which an information subfield used for non-random access RUs may be repurposed to indicate one or more aspects related to random access. In some implementations, a spatial stream allocation (SS Allocation) subfield in a User Info field, when a RU is used for random access, may be unused. In such cases, the SS Allocation subfield may be repurposed to provide one or more aspects related to random access. In one example, the six bits of the SS Allocation field may be repurposed to provide one bit to indicate Preferential RA, one bit to indicate whether or not future trigger frames (such as future trigger frames in the TWT SP or cascading sequence, etc.) contain random access RUs, and the remaining four bits may indicate a number of random access RUs.

The AP 105-a may have a mix of random access RUs, some that are repeating (number indicated via SS Allocation), some that have unique requirements specified in the User Info field. In some cases, a STA 115 may identify that the SS Allocation subfield has different format if AID12 in the User info field is equal to 0 or 2045. In one example, the SS Allocation subfield may be repurposed to include a Random Access RU Number subfield that indicates the number of continuous RUs allocated for random access (all the random access RUs have the same size, which is equal to the size of the first random access RU indicated in the RU allocation subfield), a More RA subfield that indicates whether future trigger frames include random access RUs, and a preferential RA subfield that indicates whether STAs 115 are to apply one or regulation techniques such as discussed herein. In other implementations, such bits may be repurposed in different manners. In some cases, both the STARTING SS NUM and NUM SS of the high efficiency (HE) trigger-based PPDU transmitted on each random access RU are set to 1.

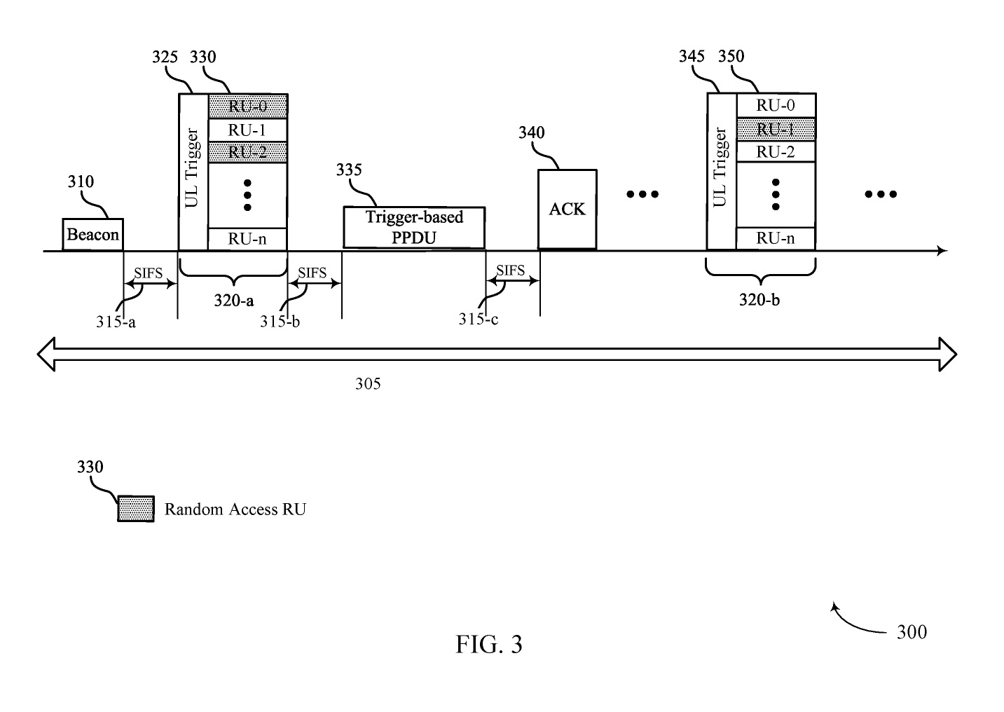

FIG. 3 illustrates an example of wireless resources 300 that support random access request regulation techniques for wireless stations in accordance with aspects of the present disclosure. In some cases, wireless resources 300 may represent aspects of techniques performed by an AP 105 or a STA 115 as described with reference to FIGS. 1 and 2.

As an example, a beacon 310 may announce a beacon period 305 that may include one or more trigger frames 320. A first trigger frame 320-a may follow a first short inter-frame space (SIFS) 315-a after the beacon 310, and may include uplink trigger information 325 (such as information in various information fields such as frame control, duration, common information, and User Info fields) as well as a number of RUs 330. The RUs 330 may be identified by AIDs, which may be assigned to different STAs 115. In some cases, certain AIDs may be designated for random access RUs 330. In this example, the first trigger frame 320-a may include two random access RUs 330, namely RU-0 and RU-2, which may be identified by a first AID value (such as an AID value of 0).

In some cases, a STA 115 may have uplink data to transmit, but not be assigned an RU 330 for an uplink transmission, in which case the STA 115 may attempt to make a transmission using one of the random access RUs 330. In some implementations, the AP 105 may transmit an OFDMA contention window (OCW) in the beacon 310 (or in a probe response), which may be an integer with an initial value of OCWmin. The STA 115 may initialize its OBO counter to a random value in the range of 0 and OCWmin. If, upon receipt of the first trigger frame 320-a, the OBO counter of the STA 115 is smaller than the number of random access RUs 330 in the first trigger frame 320-a, the STA 115 may randomly select one of the random access RUs 330 to attempt an uplink transmission. If the OBO counter of the STA 115 is larger than the number of random access RUs 330 in the first trigger frame 320-a, the STA 115 may decrement the OBO counter by a value equal to the number of random access RUs 330 in the first trigger frame 320-a.

In cases where the STA 115 attempts the uplink transmission, the STA 115 may, for the randomly-selected random-access RU, determine if the RU is idle (such as through physical carrier sensing, virtual carrier sensing, or combinations thereof), and if so, may transmit a trigger-based physical layer convergence procedure (PLCP) protocol data unit (PPDU) 335 following SIFS 315-b. If the selected random access RU is not idle, the STA 115 may not transmit the trigger-based PPDU 335 and may randomly select a random access RU 330 of a subsequent trigger frame 320-b. If the OBO counter is not zero and does not decrement to 0, the STA 115 may resume with its OBO counter in the subsequent trigger frame 320-b based on a number of random access RUs 330 in the subsequent trigger frame 320-b.

In some cases, in order to prioritize STAs 115 that are uplink-limited, a STA 115 may decrement its OBO counter only if its SLRC is non-zero. In such a manner, STAs 115 that are not retransmitting one or more uplink transmissions, and may have relatively good channel conditions for communications with the AP 105, do not decrement their OBO counters and are less likely to attempt to transmit using a random access RU 330. Likewise, STAs 115 that are retransmitting one or more uplink transmissions, and may have relatively poor channel conditions or are subject to intermittent interference, may decrement their OBO counters and be more likely to attempt to transmit using a random access RU 330.

In some cases, an AP 105 with global knowledge of the conditions and locations of the STAs 115 in its BSS (among other STAs 115) may facilitate the abilities of the STAs, including that of uplink-limited STAs 115, to contend for the medium. As further described below, the AP 105 may apply a prioritization rule for some or all random access RUs. First, the AP 105 may signal that a random access RU is to be prioritized. The AP 105 may signal the prioritization of random access RUs on, for example, on a per-random-access RU basis, on a per-trigger basis, or on an all-or-nothing basis. Signaling on a per-random-access RU basis may include signaling in a field or subfield (in, for example, a User Info field) of a trigger frame. In some implementations, the User Info field corresponding to the random access RU may apply particularly to that random access RU. Additionally or alternatively, signaling on a per-trigger basis may include signaling in a field or subfield (in, for example a Common Info field), and the prioritization may apply to all random access RU allocated to that particular trigger frame. Additionally or alternatively, prioritization information may be signaled by another frame, for example, a management frame carrying a particular element or a field, or, in some cases, the lack of such a particular element or field. For example, the presence (or lack thereof) of a particular field in a UORA parameter set element carried in a management frame may indicate that all corresponding random access RUs are to be prioritized. If a random access RU is to be prioritized, the AP 105 may then signal criteria and other parameters for prioritization. One such parameter may include, for example, a power headroom.

For example, in a first technique, the AP 105 may apply a prioritization rule (for example, a power headroom constraint calculation and related technique) for at least some, and in some cases all, random access RUs. In this case, the AP 105 may signal metrics for the random access mechanism in an uplink OFDMA-based random access (UORA) Parameter Set element, which may be an example of information transmitted in the beacon 310. A UORA Parameter Set element, may, for example, be defined according to the following format:

As shown, the UORA Parameter Set element format may include, for example, fields for an Element ID, Length, Element ID Extension, and UORA Parameters. The UORA Parameters field may further be divided into fields, for example, OCW Range, and Prioritization Power Headroom (or, UORA Power Headroom) according to the following format:

That is, the UORA Parameters field may include a number of bits (such as six bits) for an OCW range (for example, an OCWmin value, as described herein), and a number of bits (such as two bits) for Prioritization Power Headroom (that is, a priority for the set of STAs 115 having a power headroom in a particular range). The OCW range field may, in some implementations, indicate values related to the OCW (such as a minimum and maximum value of the OCW), based on, for example, fields defined according to the following format:

In some cases, the above field formats may be combined, for example, to show the following format:

As shown above, a further field (for example, an OCWmin field) may indicate a minimum value of OCW for an initial HE TB PPDU transmission using UORA. In some implementations, the STA 115 may derive a parameter of this field (for example, an OCWmin parameter corresponding to the OCWmin field) from the above field (here, the EOCWmin parameter). The STA may then use the derived parameter for an initial transmission, following a successful HE TB PPDU transmission, or both. For example, the STA 115 may derive the value of OCWmin from the EOCWmin parameter according to the equation:

OCWmin=2^{EOCWmin}−1.

Similarly, the STA 115 may determine a maximum value for a parameter of a field (for example, an EOCWmax field) corresponding to a maximum value of OCW for UORA. In some implementations, the STA 115 may derive an OCWmax parameter from the EOCWmax parameter, and use the derived parameter for retransmission attempts of UORA. For example, The STA 115 may derive the value of OCWmin from the EOCWmin parameter according to the equation:

OCWmax=2^{EOCWmax}−1.

In some implementations, a field (for example, a UORA Power Headroom field, or a Prioritization Power Headroom field) may set value above which a random access RU may be considered to be ineligible. The above format may be one example format for this implementation. This field may determine an eligibility of the one or more random access RUs. By setting a power headroom field value, an AP 105 may be able to define the set of STA 115 that may utilize a random access procedure to connect to the AP 105. Then, STAs 115 that are, for example, closer to the AP 105 that have more power headroom may or may not be able to use the random access procedure, depending on whether the power headroom of the STA 115 meets the threshold value. The following table shows one possible encoding implementation for such a field (such as for a Prioritization Power Headroom field value):

| Field | |
|---|---|
| value | Encoding |
| 0 | 5 dB |
| 1 | 10 dB |
| 2 | 15 dB |
| 3 | 20 dB |

As shown in the above table, for example, a field value of 0, 1, 2, and 3 may correspond to values of 5, 10, 15, and 20 dB, respectively. That is, an AP 105 with a field value of, for example, 1 may permit STAs 115 with 10 dB of Power Headroom to connect to the AP 105 using the random access procedure. As another example, an AP 105 with a field value of, for example, 3 may permit STAs 115 with 20 dB of Power Headroom to connect to the AP 105 using the random access procedure.

Alternatively, a field value (for example, a field value of 3) may indicate no power headroom restriction for STAs 115, and a STA 115 may attempt to connect to the AP 105 using the random access procedure without regard for the power headroom of that STA 115. The following table shows such an alternative encoding implementation:

| Field | |
|---|---|
| value | Encoding |
| 0 | 5 dB |
| 1 | 10 dB |
| 2 | 15 dB |
| 3 | No Restriction |

As shown in the above table, for example, a field value of 0, 1, and 2, may correspond to values of 5, 10, and 15 dB, respectively. That is, an AP 105 with a field value of, for example, 1 may permit STAs 115 with 10 dB of Power Headroom to connect to the AP 105 using the random access procedure. In this implementation, however, a field value of 3 may have no power headroom restriction for STAs 115, and a STA 115 may attempt to connect to the AP 105 using the random access procedure regardless of its particular power headroom under this alternative. In some cases, a STA 115 may assume a default field value (such as, for example, 2, corresponding to 15 dB) when the STA 115 has not received prior signaling from the AP 105. In some cases, an AP 105 may configure a field value for its BSS based on the capabilities of the AP 105 and the STAs 115 in its BSS.

Following from the above methods of applying a prioritization rule for all random access RUs, the AP 105 may include the UORA Parameter Set element in any of, at least some of, or all of a beacon, a probe response, an association frames, and a re-association frame that the AP 105 may transmit. The AP 105 may then indicate to the corresponding STAs 115 the UORA Parameter values (for example, a range for OCW and for prioritization power headroom) via the UORA Parameters field carried in the UORA Parameter Set element. Based on the received UORA Parameter values, the STAs 115 may then initiate random access following transmission of the trigger frame.

In some cases, a BSS may belong to a multiple BSS identifier (BSSID) set, and may advertise UORA Parameter values via the UORA Parameter Set element carried in the management frames with the transmitted BSSID. A corresponding AP 105 may include the UORA Parameter Set element in a nontransmitted BSSID profile subelement, as may be carried, for example, in a multiple BSSID element.

The AP 105 may accordingly provide different UORA Parameter values for STAs 115 associated with that nontransmitted BSSID. A corresponding STA 115 may then obtain the UORA Parameters values from the most recently received UORA Parameter Set element, as may have been carried, for example, in the management frames transmitted by its associated AP 105. A non-AP STA 115 with a dotl1MultiBSSIDActivated parameter set to true, and associated with a nontransmitting BSSID, may inherit the UORA Parameters values from the UORA Parameter Set element advertised by the transmitted BSSID if, for example, the element is not carried in the Nontransmitted BSSID Profile subelement for that BSSID.

Alternatively, an unassociated STA 115 may initialize the range of OCW and prioritization power headroom value after receiving the UORA Parameter Set element from the AP 105. If the STA 115 has not received a UORA Parameter Set element from the AP 105, the STA 115 may use a default value for Prioritization Headroom, for example, equal to 2 (corresponding to 15 dB), an OCWmin equal to 7, and an OCWmax equal to 31. The STA 115 may apply the default values upon reception of a trigger frame containing an RU with an AID12 subfield, for example, equal to 0 or 2045. Each time an unassociated STA 115 communicates with a different AP 105 using random access, the STA 115 may initiate its OBO counter and prioritization power headroom based on the default values or the parameters received from the UORA Parameter Set element for that AP 105.

In some cases, a STA 115 may not contend for an eligible random access RU or decrement its OBO counter. For example, the STA 115 may not contend for an eligible random access RU or decrement its OBO counter if the STA 115 does not have pending frames to be transmitted to a corresponding AP 105. Additionally or alternatively, the STA 115 may not contend for an eligible random access RU or decrement its OBO counter if, for example, a Prioritization Power Headroom subfield indicates a value other than an unrestricted value (for example, a value other than 3, indicating No Restriction), and the power headroom required to meet a target RSSI for the RU indicated in a Target RSSI is greater than a threshold value specified in the Prioritization Power Headroom subfield.

Additionally or alternatively, in a second technique, the AP 105 may apply a prioritization rule (for example, a power headroom constraint) on a per-random access RU basis. The prioritization rule may be signaled via one field (for example, the B39 field) of the User Field information of a trigger frame. In some implementations, the presence or absence of a value carried in a field or subfield (for example, one field in the User Info field corresponding to a random access RU) may indicate whether or not a prioritization rule is to be applied. Additionally or alternatively, other fields of the trigger frame may be used for this signaling, for example, a dual-carrier modulation (DCM) field, or another field. An example trigger frame for per-random access RU basis prioritization may be defined according to the following format:

In this example, when the RU is assigned for random access (for example, if the AID12 subfield has a value of 0 or 2045), the value of the RA Prioritization subfield may indicate whether the AP 105 is to regulate the random access RU to aid STAs 115 having a weak link to the AP 105. A value of, for example, 1, in this subfield may indicate that a STA 115 receiving the trigger frame is permitted to use this random access RU. This may be the case, for example, when the STA 115 is able to meet a target RSSI requirement specified for the RU with a power headroom less than or equal to the threshold specified in the Prioritization Power Headroom subfield in the UORA Parameter Set element. Alternatively, the RA Prioritization subfield may be set to a value of, for example, 0, if the AP 105 does not regulate the eligibility of the random access RU, or if the RU is directed.

According to the second technique, metrics of the OFDM-based random access mechanism may be signaled in the UORA Parameter Set element similarly to the first technique described above. The AP 105 may then signal the UORA Parameters, values for OCW, and encode the signals similarly as described above in the first example. That is, after determining which random access RUs are to be regulated to aid particular STAs 115 belonging to the BSS of the AP 105, the AP 105 may proceed similarly as described herein for the second technique. In some cases, however, according to the described techniques, some fields of the frame format may be reserved, including for example, any of, at least some of, or all of modulation and coding scheme (MCS), Coding Type and RA Prioritization, DCM, SS Allocation/Random Access RU Information, and Target RSSI fields, each in the User Info field.

Additionally or alternatively, in a third technique, the AP 105 may apply a prioritization rule (for example, a power headroom constraint) on a per-random access RU basis, which may signaled by overloading one field (for example, the Coding Type bit (B20)) in the User Info field of a trigger frame. An overloaded field may include, for example, the prioritization rule in addition to the underlying information in the field (for example, in addition to a coding type). Additionally or alternatively, another field of the trigger frame may be used for this signaling, for example, a DCM field, or another field. An example trigger frame for the third technique may be defined according to the following format:

In this example, when the AID12 subfield carries the 12 least significant bits (LSBs) of the AID of the STA 115 for which the RU is intended, the value in the Coding Type field (for example, in bit 20 (B20)) may signal the prioritization rule. When the RU is for random access (for example, the AID12 subfield has a value of other than 0 or 2045), the coding type of the HE TB PPDU may be fixed to a low-density parity-check (LDPC), and, for example, bit B20 may represent the RA Prioritization subfield. The Coding Type subfield of the User Info field may indicate the code type of the HE TB PPDU that is the response to the trigger frame. The Coding Type subfield may then be set to 0 to indicate a binary convolution code (BCC), or set to 1 to indicate LDPC. The RA Prioritization subfield may indicate whether the random access RU is regulated to aid STAs 115 having a weak link to the AP 105. A value of, for example, 1, in this subfield may indicate that a STA 115 receiving the trigger frame is permitted to use this random access RU, for example, only if it can meet the Target RSSI threshold requirement specified for this RU, with power headroom less than or equal to the threshold specified in the Prioritization Power Headroom subfield carried in the UORA Parameter Set element. The RA Prioritization subfield may be set to, for example, 0, if the AP 105 does not regulate the eligibility of the random access RU.

According to the third technique, metrics of the OFDM-based random access mechanism may be signaled in the UORA Parameter Set element similarly to the techniques described above. The AP 105 may then signal the UORA Parameters, values for OCW, and encode the signals similarly as described above. That is, after determining which random access RUs are to be regulated to aid particular STAs 115 belonging to the BSS of the AP 105, the AP 105 may proceed similarly as described herein. For example, some fields of the frame format may be reserved, including for example, any of, at least some of, or all of modulation and coding scheme (MCS), Coding Type and RA Prioritization, DCM, SS Allocation/Random Access RU Information, and Target RSSI fields, each in the User Info field.

Additionally or alternatively, in a fourth technique, the AP 105 may apply a prioritization rule (for example, a power headroom constraint) to random access RUs in a particular trigger frame, which may be signaled by adding signaling to a field common to one trigger frame (for example, a Common Info field). In some implementations, the prioritization may be applied to all random access RUs in a trigger frame. In some implementations, the presence or absence of a value carried in a field (for example, one field in the Common Info field of the Trigger frame corresponding to a random access RU) may indicate whether or not a prioritization rule is to be applied. The Common Info field may, for example, be defined according to the following format:

According to this technique, a field or subfield (for example, the RA Prioritization subfield) may be used to indicate whether the random access RU(s) carried in the trigger frame are to be regulated to aid STAs 115 having a weak link to the AP 105. A value of, for example, 1, in this subfield may indicate that a STA 115 receiving the trigger frame is permitted to use only those random access RUs for which it can meet the Target RSSI requirement for that RU while having a power headroom less than or equal to the threshold specified in the Prioritization Power Headroom subfield carried in the UORA Parameter Set element. The RA Prioritization subfield may be set to, for example, 0 if the AP 105 is not to regulate the eligibility of the random access RUs carried in the frame. In another implementation, a UORA Parameter Set element (carried in, for example, a corresponding management frame) may be defined according to the following format:

In some implementations, according to this format, a field (for example, a UORA Power Headroom Limit field) may indicate a threshold value (that is, establishing a limit) that, when exceeded, indicates that a random access RU is considered to be ineligible. That is, a restricted random access RU may be considered to be an eligible RU if a STA is able to meet a target RSSI threshold (specified for the random access RU in, for example, a corresponding User Info field of the trigger frame), with respect to an assigned MCS, without reducing its transmit power below the threshold indicated in the UORA Power Headroom Limit field. In some implementations, and as further described below, the UORA Power Headroom Limit field may be optional, in which case, the presence or absence of the UORA Power Headroom Limit field in the UORA Parameter Set element may indicate whether or not random access is to be prioritized. The following table shows one possible encoding implementation for such a field (such as for a UORA Power Headroom Limit field value):

| Field | |
|---|---|
| value | Encoding |
| 0-25 | Values of 0 to 25 correspond to 5 |
| | dB to 30 dB |
| 26-255 | Reserved |

As shown in the above table, for example, field values ranging from 0 to 25 may correspond to values ranging from 5 to 30 dB. For example, a field value of 0 may correspond to a value of 5 db, a field value of 10 may correspond to a value of 10 db, and so on. Alternatively, a field value of, for example, a value between 26 to 255 (or, alternatively, one single defined value (for example, a value of 255)) may indicate that the random access RUs are unregulated and open to any STA, without a restriction based on an ability to meet a target RSSI threshold, or without regard for a power headroom limitation. In another implementation, the field values above may be for example, 0 to 25 corresponding to 5 dB to 30 dB, with field values of 26 to 255 being reserved. Other similar implementations are also contemplated.

In some implementations, when contending for random access RUs, a STA that has not received a UORA Parameter Set element may be configured to use a default value, for example, a UORA Power Headroom Limit value of a preconfigured value (for example, a value of 20), corresponding to a preconfigured setting (e.g., 25 db) (and, for example, default values of OCWmin=7 and OCWmax=31). In some implementations, the presence, or lack of, a particular field (for example, the UORA Power Headroom Limit field) itself may determine whether or not random access is to be prioritized.

According to the fourth technique, metrics of the OFDM-based random access mechanism may be signaled in the UORA Parameter Set element similarly to the techniques described above. The AP 105 may then signal the UORA Parameters, values for OCW, and encode the signals similarly as described above. That is, after applying the prioritization rules to the random access RUs to be regulated to aid particular STAs 115 belonging to the BSS of the AP 105, the AP 105 may proceed similarly as described herein.

Additionally or alternatively, in a fifth technique, the AP 105 may apply a prioritization rule (for example, a power headroom constraint) to particular random access RUs based on new entries to a further subfield (for example, a RU allocation subfield) in the trigger frame. In this case, field values (for example, RU index values) may correspond to a particular number of tones to be used for the random access RUs. For example, the trigger frame may be formatted according to the following RU allocation table:

| | | Number |
|---|---|---|
| B19-B13 | Description | of entries |
| 0-36 | Possible 26-tone RU | 37 |
| | cases in 80 MHz | |
| 37-52 | Possible 52-tone RU z | 16 |
| | cases in 80 MH | |
| 53-60 | Possible 106-tone RU | 8 |
| | cases in 80 MHz | |
| 61-64 | Possible 242-tone RU | 4 |
| | cases in 80 MHz | |
| 65-66 | Possible 484-tone RU | 2 |
| | cases in 80 MHz | |
| 67 | 996-tone RU cases in 80 MHz | 1 |
| 68 | 2 × 996-tone RU case | 1 |
| 69-105 | Restricted 26-tone RU cases in | 37 |
| | 80 MHz | |
| 106-121 | Restricted 52-tone RU cases in | 16 |
| | 80 MHz | |
| 122-127 | Reserved | 6 |
| Total | | 128 |

Alternatively, the trigger frame may be formatted for restricted random access RUs and further reserved RUs. For example, a particular field value may indicate a number of tones for a restricted random access RU (for example, 26-tone and 52-tone RUs, indicated by field values of 69 and 70, respectively, as shown below). Such a trigger frame may be formatted according to the following RU allocation table:

| | | Number |
|---|---|---|
| B19-B13 | Description | of entries |
| 0-36 | Possible 26-tone | 37 |
| | RU cases in 80 MHz | |
| 37-52 | Possible 52-tone | 16 |
| | RU cases in 80 MHz | |
| 53-60 | Possible 106-tone | 8 |
| | RU cases in 80 MHz | |
| 61-64 | Possible 242-tone | 4 |
| | RU cases in 80 MHz | |
| 65-66 | Possible 484-tone | 2 |
| | RU cases in 80 MHz | |
| 67 | 996-tone RU cases in 80 MHz | 1 |
| 68 | 2 × 996-tone RU case | 1 |
| 69 | Restricted 26-tone RU | 1 |
| 70 | Restricted 52-tone RU | 1 |
| 71-127 | Reserved | 57 |
| Total | | 128 |

In some cases, an AP 105 may advertise several contiguous random access RUs using a combination of the RU allocation table (for example, one of the above RU allocation tables) and a further field or subfield (for example, a Random Access RU Number subfield). In this case, the field value (such as the RU index value) in the RU allocation table may indicate the number of tones and the description of the tones to be used, and the Random Access RU Number may indicate an amount of these tones.

For example, if the value of the RU index is 69, and the value of the Random Access RU Number subfield is 10, the AP 105 may advertise 10 contiguous 26-tone restricted RUs. By combining values from different subfields, the AP 105 may efficiently advertise tone formats for multiple different random access RUs. Without such a scheme combining different subfields, in the above example, the AP 105 may only advertise only 10 identical User Info fields that vary only in the RU mapping, but not number, location, other parameters or constraints, etc. By additionally using the RU Number subfield in the way described above, a STA 115 may determine the number of random access RUs as well as the location of each random access RU based on the knowledge that the random access RUs are contiguous. In some implementations, this scheme of an AP advertising several contiguous random access RUs using a combination of the RU allocation table and the a Random Access RU Number subfield, may reduce the size of the trigger frame. A reduced trigger frame size may then reduce the amount of air time occupied by transmitting the trigger frame—creating further efficiencies and advantages. In some implementations, as another advantage, a receiver may also use less time to decode and parse the relatively smaller trigger frame.

In some cases, according to this technique, only STAs 115 that satisfy the power headroom requirement may use the new RU set. In some cases, the default values described above for Prioritization Power Headroom may only be applied to a new RU type. According to the fifth technique, metrics of the OFDM-based random access mechanism may be signaled in the UORA Parameter Set element similarly to the techniques described above. The AP 105 may then signal the UORA Parameters, values for OCW, and encode the signals similarly as described above. That is, after applying the prioritization rules to the random access RUs to be regulated to aid particular STAs 115 belonging to the BSS of the AP 105, the AP 105 may proceed similarly as described herein.

In some cases, a STA 115 may modify its OBO counter based on channel conditions, based on whether the STA 115 is associated or unassociated with an AP 105, based on whether the STA 115 is uplink limited, or any combination thereof. For example, if a target RSSI of the STA 115 is below a threshold value (such as a Target RSSI indicated in a Target RSSI field of a User Info field in a trigger frame), the STA 115 may modify its OBO counter. In some cases, the OBO counter may be modified at different rates based on whether channel conditions at the STA 115 are above or below a certain value (such as the OBO counter may be decremented by multiple counts if a target RSSI is below a threshold value, and otherwise the OBO counter may be decremented by a single count). In some cases, the OBO counter may be bypassed when the STA 115 signal strength is below the target RSSI value, and the STA 115 may attempt a transmission in a random access RU irrespective of a value of the OBO counter.

In some cases, a trigger frame 320 may be a BSRP trigger frame that triggers a STA 115 to transmit a BSR to the AP 105. In some cases, the BSRP trigger frame may not include RUs with a particular STA' s AID, and such a non-indicated STA 115 that receives such a BSRP may attempt to transmit its BSR using a random access RU. In some implementations, a STA 115 may attempt to transmit a BSR using random access RUs only if the STA 115 has a non-empty buffer. Thus, STAs 115 that have empty buffers will not attempt to transmit using random access RUs, and STAs 115 with non-empty buffers may have a higher likelihood of transmitting a BSR using such random access RU resources.

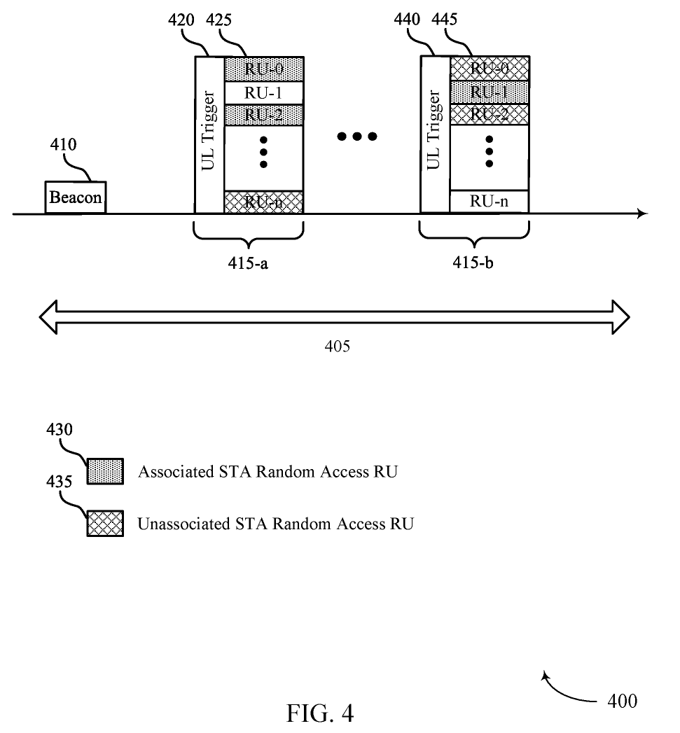

In some cases, the AP 105, following SIFS 315-c, may transmit an acknowledgment 340 of the trigger-based PPDU 335. The AP 105, for example, may generate an acknowledgment 340 to be transmitted in a downlink PPDU, which may include an acknowledgment frame in a downlink RU that is identified using a same AID as used for the random access RU of uplink trigger-based PPDU 335 transmission. In some cases, as will be discussed in more detail below with reference to FIG. 4, different AIDs may identify different random access RUs for associated and unassociated STAs 115. In such cases, the acknowledgment frame in the downlink RU may use the same respective AID that for associated or unassociated STAs 115 as used to identify the respective random access RUs. In some implementations, an AID value of 0 may identify random access RUs for associated STAs 115 and an AID value of 2045 may identify random access RUs for unassociated RUs, and these same AID values may be used to identify downlink RUs that contain acknowledgments for the corresponding uplink random access RUs.

The AP 105 may also transmit an indicator of the STA 115 that transmitted the trigger-based PPDU 335 (such as a STA-ID or a MAC address). In some cases, the STA-ID for an unassociated STA may be a special value representing all unassociated STAs. In some cases, the indicator may be transmitted in a signaling field (such as in a SIG-B field) transmitted by the AP 105. The STA 115 may decode the signaling field and look for its indicator, such as its STA ID or MAC address. If the indicator in the signaling field matches the transmitting STA's indicator, the STA 115 may determine that the uplink transmission was successfully received. If the indicator in the signaling field does not match the transmitting STA's indicator, or if a negative acknowledgment is indicated in the acknowledgment 340, the transmitting STA 115 may determine that the uplink transmission was not received at the AP 105.

FIG. 4 illustrates example trigger frames 415 with resource units allocated for associated and unassociated wireless stations that support random access request regulation techniques in accordance with aspects of the present disclosure. In some cases, trigger frames 415 may represent aspects of techniques performed by an AP 105 or a STA 115 as described with reference to FIGS. 1 and 2.

Prior to the transmission of a trigger frame, a beacon 410 may announce a beacon period 405 that may include one or more trigger frames 415. A first trigger frame 415-a may include uplink trigger information 420 (such as information in various information fields such as frame control, duration, common information, and User Info fields), as well as a number of RUs 425. The RUs 425 may be identified by AIDs, which may be assigned to different STAs 115. In some cases, certain AIDs may be designated for random access RUs as described above. For example, associated STAs 115 may use a first AID value (such as an AID value of 0) that is assigned to a first subset of random access RUs 430 and unassociated STAs 115 may use a second AID value (such as an AID value of 2045) that is assigned to a second subset of random access RUs in 435. In the illustrated example, the first trigger frame 420-a may include two random access RUs with the first AID value, namely RU-0 and RU-2, and may include one random access RU with the second AID value, namely RU-1.

In the example of FIG. 4, a second trigger frame 415-b may include uplink trigger information 440 and RUs 445. The second trigger frame 415-b may include a different number of random access RUs for associated STAs 430 and a different number of random access RUs for unassociated STAs 435 than in the first trigger frame 415-a. In some cases, the number of random access RUs for unassociated STAs 435 may be less than a number of random access RUs for associated STAs 430. In other cases, the number of random access RUs for associated STAs 430 may be less than a number of random access RUs for unassociated STAs 435. In still other implementations, unassociated STAs may not have any random access RUs, or associated STAs may not have any random access RUs. Whether associated or unassociated STAs have any random access RUs, or what relative quantities of random access RUs are assigned for different types of STAs, may depend on a number of factors. In some cases, an AP 105 may select whether or how many random access RUs are to be available for different types of STAs 115. In some cases, an AP 105 may base such a selection on channel conditions, traffic conditions, or combinations thereof. For example, if an AP 105 is receiving a relatively large number of probe requests, the AP 105 may determine that a relatively large number of unassociated STAs are present and may allocate additional random access RUs for unassociated STAs. In other cases, an AP 105 may determine that currently associated STAs have relatively large amounts of buffered traffic and may allocate more or all available random access RUs for associated STAs. In some cases, an AP 105 may dynamically change available random access RUs that may be available for associated and unassociated STAs.

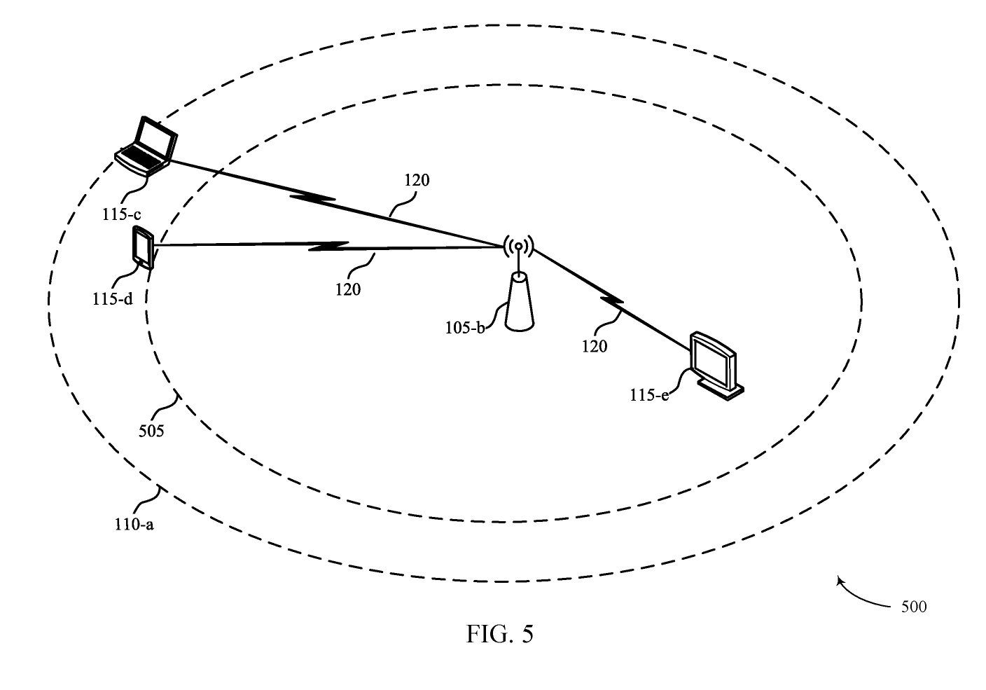

FIG. 5 illustrates a WLAN 500 configured in accordance with aspects of the present disclosure. The WLAN 500 may include an AP 105-b, STA 115-c, STA 115-d, and STA 11-e, which may each represent devices such as wireless communication terminals, mobile stations, phones, PDAs, other handheld devices, netbooks, notebook computers, tablet computers, laptops, display devices (such as TVs, computer monitors, etc.), printers, etc. In some cases, WLAN 500 may represent aspects of techniques performed by an AP 105 or a STA 115 as described with reference to FIGS. 1 through 4. The AP 105-b and the associated STAs 115 may represent a BSS or an ESS. The various STAs 115 in the network are able to communicate with one another through the AP 105-b. An extended network station associated with the WLAN 100 may be coupled with a wired or wireless distribution system that may allow multiple APs 105 to be connected in an ESS. WLAN 100 may represent a network that supports random access regulation techniques for wireless stations.

Examples of direct wireless links 120 may include Wi-Fi Direct connections, Wi-Fi TDLS links, and other group connections. The STAs 115 and the APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. Also shown is a coverage area 110-a of the AP 105-b, which may represent a BSA of the WLAN 100. FIG. 5 further shows a threshold range 505, which is shown to be within the coverage area 110-a. In different implementations, the coverage range may be larger or smaller than as shown in FIG. 5. Threshold range 505 may represent an approximate range within which, for example, STAs 115 may not satisfy a target RSSI threshold without reducing their corresponding transmit power below a specified power headroom limit threshold.

As described above with reference to FIG. 3, in some implementations, a UORA Power Headroom Limit field may indicates a threshold value that, when exceeded, indicates that a random access RU is ineligible. That is, a restricted random access RU may be considered to be an eligible RU if a STA is able to meet a target RSSI threshold (specified for the random access RU in, for example, a corresponding User Info field of the trigger frame), with respect to an assigned MCS, without reducing its transmit power below the threshold indicated in the UORA Power Headroom Limit field. Similarly, in some implementations, a Preferential RA field may indicate whether a value for a target RSSI subfield value may indicate a maximum transmit power, or whether that value may indicate that the subfield is reserved.

Referring back to FIG. 5, an example field value of 5 may be considered for the UORA Power Headroom limit field value, which may correspond to a 10 db limit. In the illustrated example, the STA 115-c is shown to be the furthest STA 115 from the AP 105-b. The STA 115-c may first receive an indication of the UORA Power Headroom Limit to use particular random access RAs. The STA 115-c may reduce its transmit power by 5 db to meet a defined target RSSI threshold. Because the STA 115-c will have then reduced its transmit power by 5 db to reach the RSSI threshold, the STA 115-c may be considered to be eligible to use the random access RAs (that is, because 5 db is less than the 10 db UORA Power Headroom Limit threshold).

The STA 115-d is shown to be the second-closest STA 115 to the AP 105-b (i.e., the STA 115 with the “middle” distance from the AP 105-b of the three STAs 115). Similarly as described for STA 115-c, the STA 115-d may first receive an indication of the UORA Power Headroom Limit to use particular random access RAs. The STA 115-d may reduce its transmit power by 7 db to meet a defined target RSSI threshold. Because the STA 115-d will have then reduced its transmit power by 7 db to reach the RSSI threshold, the STA 115-d may be considered to be eligible to use the random access RAs (that is, because 7 db is less than the 10 db UORA Power Headroom Limit threshold).

The STA 115-e is shown to be the closest STA 115 to the AP 105. As shown in FIG. 5, STA 115-e is shown to be within the threshold range 505. The STA 115-e may first receive an indication of the UORA Power Headroom Limit to use particular random access RAs. The STA 115-e may reduce its transmit power by 12 db to meet a defined target RSSI threshold. As the STA 115-e will have then reduced its transmit power by 12 db to reach the RSSI threshold, the STA 115-c may be considered to be ineligible to use the random access RAs (that is, because 12 db is greater than the 10 db UORA Power Headroom Limit threshold).

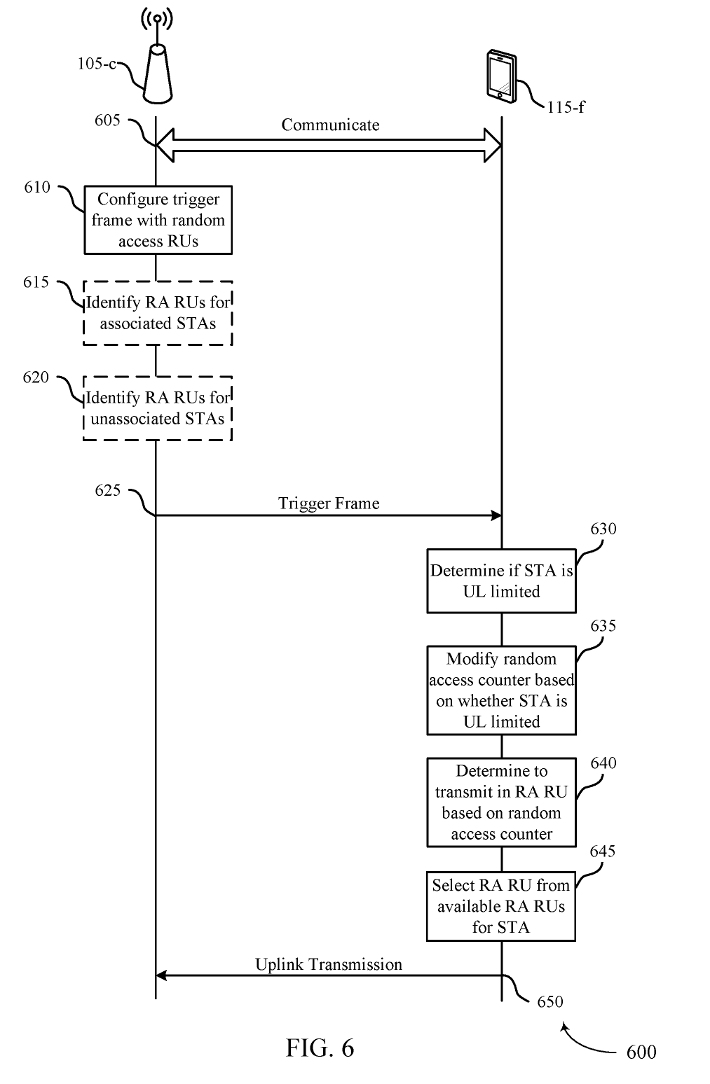

FIG. 6 illustrates an example of a process flow 600 for a system that supports random access regulation techniques for wireless stations in accordance with aspects of the present disclosure. The system and process flow 600 may include AP 105-c and STA 115-f, which may be examples of the corresponding devices as described with reference to FIGS. 1 through 5.

AP 105-c may communicate with STA 115-f through communication link 605, such as through uplink and downlink communications or through a probe request and probe response, for example.

At block 610, the AP 105-c may configure a trigger frame with random access RUs. The AP 105-c may configure the trigger frame based at least in part on, for example, a number of associated STAs 115 having buffered traffic. At least some of the STAs 115 may be assigned resource units by the trigger frame by assigning RUs an AID that is associated with each STA 115. Each STA 115 with an assigned RU may use the assigned RUs to transmit a triggered PPDU to the AP 105-c. The trigger frame may be configured with other information, which may be provided in associated information fields and subfields, such as, for example, a frame control field, a duration field, transmitter or recipient address (or broadcast address) fields, a common information field, User Info fields, or any combinations thereof.

At optional block 615, the AP 105-c may identify random access RUs for associated STAs 115. In some cases, the random access RUs for associated STAs 115 may be assigned a first AID value, which may be defined as an AID value for random access RUs for associated STAs 115 (such as an AID value of 0). As multiple STAs 115 may be able to use such random access RUs, various regulation techniques as discussed herein may be used to provide higher priority access to random access RUs for certain STAs 115, such as STAs 115 that are uplink-limited, or have non-zero traffic buffers, for example.

At optional block 620, the AP 105-c may identify random access RUs for unassociated STAs 115. In some cases, the random access RUs for unassociated STAs 115 may be assigned a second AID value, which may be defined as an AID value for random access RUs for unassociated STAs 115 (such as an AID value of 2045). In some implementations, associated or unassociated STAs 115 may be given higher priority for accessing random access RUs through providing different numbers of available random access RUs.

The AP 105-c may transmit trigger frame 625 to the STA 115-f, as well as to one or more other STAs 115. In some cases, the trigger frame 625 may be transmitted following a SIFS after another transmission, such as after a beacon transmission or after an acknowledgment transmission of the AP 105-c.

At block 630, the STA 115-f may determine whether it is uplink-limited or not. In some cases, the STA 115-f may determine that it is uplink-limited based on a current number of retransmissions that are being performed, which indicates that uplink transmissions are not being successfully received at the AP 105-c due to channel conditions, interference, or combinations thereof. In some implementations, the STA 115-f may determine that it is uplink-limited if its SLRC is non-zero.

At block 635, the STA 115-f may modify a random access counter based on whether the STA is uplink-limited. In some implementations, the STA 115-f may initiate a random access counter, such as an OBO counter, and may decrement the counter by a number of random access RUs present in each successive trigger frame. When the counter decrements to zero, or to a value that is less than a number of random access RUs in a trigger frame, the STA 115-a may attempt a transmission using one of the random access RUs in the particular trigger frame. In this example, the STA 115-f may modify the random access counter only if the STA is uplink-limited, which may be determined in some implementations by a SLRC value being non-zero at the STA 115-f. In other implementations, other criteria may be used to determine that the STA 115-f is uplink-limited, such as channel conditions, one or more other retry counters, or an amount of data in a data buffer, among other implementations. In some cases, one or more combinations of one or more criteria may be used to determine that the STA 115-f is uplink-limited. In some cases, the AP 105-c may configure the STA 115-f to only contend for random access RUs if it has relatively poor channel conditions (such as if a STA RSSI is less than an indicated target in a Target RSSI field of a User Info field in a trigger frame). STAs 115 which may have difficulty accessing the AP 105-c, such as cell-edge STAs 115, may have priority for a random access RU. In some cases, an allocation of RUs, or of restricted RUs, may be relatively increased based on a greater number of cell-edge STAs 115. This may permit a greater number of cell-edge STAs 115 to access restricted random access RUs, when, for example, a ratio of cell-edge STAs 115 to STAs 115 near to the AP 105 is relatively higher. In some implementations, an allocation of RUs, or of restricted RUs, may be relatively increased based on an elapsed time since the last uplink transmission was received from a particular STA 115 or group of STAs 115.

Further in some systems, the AP 105 may receive some sort of feedback (for example, null data packet (NDP) feedback) which lets the AP know that there is at least one STA 115 (associated or unassociated depending on the type of NFRP) in the neighborhood that is having difficulty closing the link with the AP. Based on such feedback, the AP 105 may decide to prioritize one or more random access RUs. In some implementations, a STA 115 may transmit feed back to an AP 105 indicating that one or more nearby STAs 115 may be having difficulty associating or linking with the AP 105. For example, a STA 115 may be aware that a nearby unassociated STA 115 (that is, the STA 115 has not yet associated with the AP 105) is having difficulty associating with the AP 105. Alternatively, a STA 115 may be aware that a nearby associated STA 115 is having difficulty closing a link with the AP despite having previously already associated with the AP 105. The STA 115 may transmit feedback to the AP 105 (for example, NDP feedback) to inform the AP 105 of the difficulties of the nearby STA 115 in accessing the AP 105. In some implementations, the feedback from the informing STA 115 of the STA 115 having difficulties may be based on a type of NFRP of the STA 115 having difficulty accessing the AP 105. Based on the feedback received from the STA 115, the AP 105 may then determine to allocate random access RUs in its next trigger frame, determine a relative distribution of random access RUs (for example, determine how many random access RUs are to be for unassociated STAs 115, how many random access RUs for associated STAs 115, how many RUs are to be directed RUs, or a combination thereof), or decide to restrict (that is, prioritize) some random access RUs for the particular STA 115 or similarly situated STAs 115.

In some implementations, the trigger frame may include a Preferential RA field, which may be a single bit that, when set, indicates that random access is prioritized for certain STAs 115. For example, when the RU is assigned for Random Access (that is, the AID12 subfield has a value 0 or 2045), the value in Preferential RA subfield may indicate whether random access is prioritized for certain STAs 115. The subfield may be reserved otherwise.

In some implementations, the value of the Preferential RA field may indicate whether a value for a target RSSI subfield value may indicate a maximum transmit power, or whether that value indicates that the subfield is reserved. Illustratively, the following table shows one example encoding implementation for such a field (for example, a target RSSI subfield):

| Field | |
|---|---|
| value | Encoding |
| 0-90 | Values of 0 to 90 correspond to −110 |
| | dBm to −20 dBm |
| 91-126 | Reserved |
| 127 | STA is to transmit an HE TB PPDU |
| | response at its maximum transmit |
| | power for the assigned MCS. |
| | Reserved when User Info corresponds |
| | to random access RU and the |
| | restricted random access RU subfield |
| | is set to a value of 1. |

In some implementations, as shown above, a value of, for example, 127 in the target RSSI subfield may indicate that a STA 115 may transmit at a maximum transmit power for the assigned MCS if the RU is not a random access RU, or if the RU is a random RU but the prioritization subfield (for example, the restricted random access RU subfield) is set to, for example, 0. Alternatively, if a restricted RA field is set to 1 (for example, indicating that the random access RU is restricted), the target RSSI subfield value may indicate (for example, a value of 127) that the subfield is reserved. In other implementations, a value of 1 in this subfield indicates that a STA 115 cannot use the Random Access RU if it receives the Trigger frame above the target receive signal power indicated in the Target RSSI subfield. The Preferential RA subfield may be set to 0 if the AP 105-c has no preference on which STA 115 accesses a random access RU. In some cases, the trigger frame may not include the Preferential RA field, and instead all random access RUs may need to comply with the target RSSI rule. In some cases, such a target RSSI rule may apply only when the RA is for unassociated STAs 115 (such as when AID12=2045) or only when the RA is for associated STAs 115 (such as when AID12=0).

At block 640, the STA 115-f may determine to transmit a random access RU based on the random access counter. As indicated above, in some cases the random access counter may be a backoff counter, and the STA 115-f may determine that a transmission should be attempted in the random access RU when a value of the backoff counter (such as an OBO counter) is zero or less than a number of random access RUs in the trigger frame. In some implementations, the STA 115-f may modify its random access counter based on channel conditions, based on whether the STA 115-f is associated or unassociated with the AP 105-c, based on whether the STA 115-f is uplink limited, or any combination thereof. For example, if a target RSSI of the STA 115-f is below a threshold value (such as if the STA 115-f transmission would be less than the target receive signal power as specified by the Target RSSI subfield if it were to transmit an HE TB PPDU response at its maximum transmit power for the assigned MCS, or if the STA 115-f receives the trigger frame above the target receive signal power indicated in the Target RSSI subfield), the STA 115-f may modify its random access counter, otherwise the STA 115-f would not modify its random access counter. In some cases, the random access counter may be modified at different rates based on whether channel conditions at the STA 115-f are above or below a certain value (such as the counter may be decremented by multiple counts if a target RSSI is below a threshold value, and otherwise the OBO counter may be decremented by a single count). In some cases, the random access countdown process may be modified by bypassing the random access counter when the STA signal strength is below the target RSSI value. In such cases, the STA 115-f may attempt a transmission in a random access RU irrespective of a value of the random access counter.

At block 645, the STA 115-f may select a random access RU from the available random access RUs for the STA 115-f that are in the trigger frame. In some cases, the STA 115-f may randomly select one of a number of random access RUs that are in the trigger frame. In some cases, the random access RUs are identified by defined AID values, and the STA 115-f may identify the random access RUs based on a first AID value when the STA 115-f is associated with the AP 105-c and may identify the random access RUs based on a second AID value when the STA 115-f is unassociated with the AP 105-c. In some cases, when the STA 115-f makes a determination to attempt to transmit an uplink transmission using a random access RU, the STA 115-f may attempt to determine that the random access RU is idle (such as by physical and virtual carrier sensing), and if the RU is idle the STA 115-f may transmit uplink transmission 650.

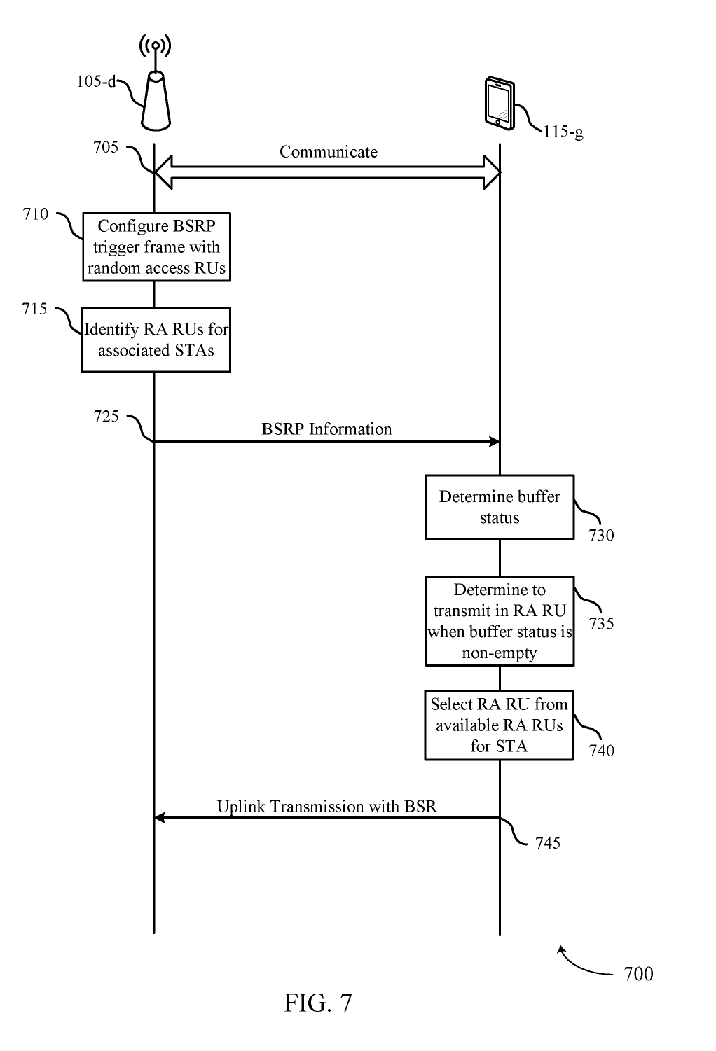

FIG. 7 illustrates another example of a process flow 700 for a system that supports random access regulation techniques for wireless stations in accordance with aspects of the present disclosure. The system and process flow 700 may include AP 105-d and STA 115-g, which may be examples of the corresponding devices as described with reference to FIGS. 1 through 5.

AP 105-d may communicate with STA 115-g through communication link 705, such as through uplink and downlink communications or through a probe request and probe response, for example.

At block 710, the AP 105-d may configure a BSRP trigger frame with random access RUs. The AP 105-d may configure the BSRP trigger frame based at least in part on, for example, timing parameters for obtaining buffer status reports from STAs 115 that may transmit to the AP 105-d. At least some of the STAs 115 may be assigned resource units by the BSRP trigger frame by assigning RUs an AID that is associated with each STA 115, and a BSR may be transmitted using the assigned RUs. Each STA 115 with an assigned RU may use the assigned RUs to transmit a triggered PPDU to the AP 105-d.

At block 715, the AP 105-d may identify random access RUs for associated STAs 115. Such random access RUs may be identified, for example, based on a number of associated STAs 115 that are not assigned specific RUs. For example, the STA 115-g may have been idle for a duration of time, and the AP 105-d may not have assigned a specific RU to the STA 115-g, and thus the STA 115-g may use a random access RU to transmit its BSR. The AP 105-d may transmit the BSRP information 725 in a BSRP trigger frame to the STAs 115, including to STA 115-g.

The STA 115-g, at block 730, may receive the BSRP trigger frame, identify that a BSR is triggered, and determine its buffer status. The STA 115-g may, for example, identify an amount of buffer data present that is to be transmitted.

At block 735, the STA 115-g may determine to transmit its BSR in a random access RU when the buffer status is non-empty. In this example, if the buffer at the STA 115-g is zero, the STA 115-g will not transmit its BSR using a random access RU. In such cases, the STA 115-g may simply transmit its BSR in another uplink transmission, such as where the AP 105-d assigns the STA 115-g an RU or in a subsequent random access RU when the STA 115-g buffer is non-empty.

At block 740, the STA 115-g may select a random access RU from the available random access RUs for the STA 115-g that are in the BSRP trigger frame. In some cases, the STA 115-g may randomly select one of a number of random access RUs that are in the trigger frame. In some cases, when STA 115-g makes a determination to attempt to transmit an uplink transmission using a random access RU, the STA 115-g may attempt to determine that the random access RU is idle (such as by physical and virtual carrier sensing), and if the RU is idle the STA 115-g may transmit uplink transmission with BSR 745.

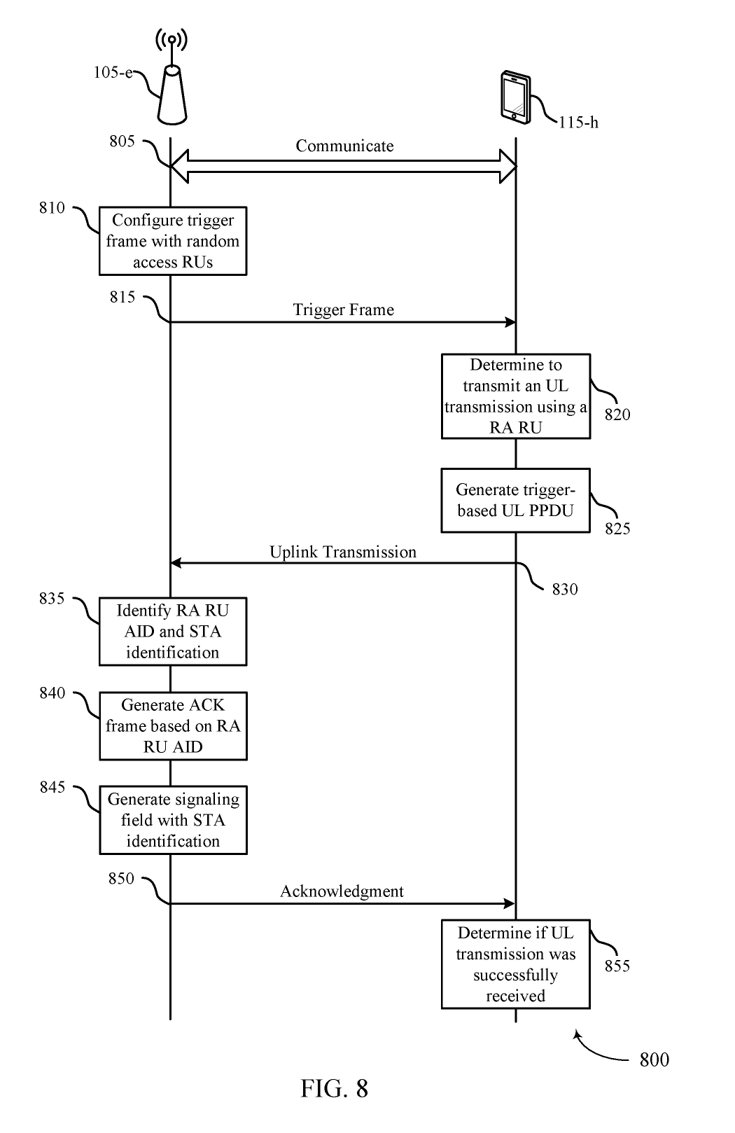

FIG. 8 illustrates another example of a process flow 800 for a system that supports random access regulation techniques for wireless stations in accordance with aspects of the present disclosure. The system and process flow 800 may include AP 105-e and STA 115-h, which may be examples of the corresponding devices as described with reference to FIGS. 1 through 5.

AP 105-e may communicate with STA 115-h through communication link 805, such as through uplink and downlink communications or through a probe request and probe response, for example.

At block 810, the AP 105-e may configure a trigger frame with random access RUs. The trigger frame may be configured in a manner similar to that described above, and may include one or more random access RUs that may be used by STA 115-h. The one or more RUs may be identified by one or more AIDS, for example, in a manner as described above. The AP 105-e may transmit trigger frame 815 to the STA 115-h, and other STAs 115.

At block 820, the STA 115-h may determine to transmit an uplink transmission using a random access RU. The STA 115-h may make such a determination, in some implementations, using regulation techniques as described above.

At block 825, the STA 115-h may generate a trigger-based uplink PPDU. The trigger-based uplink PPDU may, in some cases, contain MAC protocol data units (MPDUs) that solicit an acknowledgment of receipt from the receiver. The STA 115-h may transmit the uplink transmission 830 to the AP 105-e. Such a transmission may be made in a similar manner as described above, such as by the STA 115-h randomly selecting a random access RU, performing carrier sensing to detect whether the selected RU is idle, and transmitting the uplink transmission when the carrier sensing indicates the RU is idle, for example.

At block 835, the AP 105-e may receive the uplink transmission and identify the random access RU AID of the random access RU used for the transmission, and also determine a STA identification. In some cases, the RU AID may be a first AID for an associated STA 115 or second AID for an unassociated STA 115.

At block 840, the AP 105-e may generate an acknowledgment frame based on the random access RU AID. In some cases, an AID for the acknowledgment frame may be the same AID as the AID of the random access RU used to send the uplink transmission.

At block 845, the AP 105-e may generate a signaling field with the STA 115-h identification. In some cases, the signaling field may be a SIG-B field that may include the STA identification, such as a STA-ID or a MAC address for the STA 115-h. In some cases, multiple STAs 115 may transmit using a random access RU, and the AP 105-e may be able to successfully decode one of the transmissions, which may be from a different STA 115 than STA 115-h, in which case the STA identification in the signaling field may for the different STA 115. The AP 105-e may transmit the acknowledgment 850 to the STA 115-h, as well as to one or more other STAs 115.

At block 855, the STA 115-h may determine if the uplink transmission was successfully received at the AP 105-e. In some cases, the STA 115-h may make such a determination based on the AID of the resource unit used for the acknowledgment frame, and based on the STA identification that is included in the signaling field. For example, if the uplink transmission was transmitted using a random access RU with the first AID, the acknowledgement may be transmitted in a downlink RU having the first AID. If the acknowledgment in the downlink RU with the first AID has a same STA identification (such as STA-ID or MAC address), the STA 115-h may determine that the uplink transmission was successfully received, otherwise the STA 115-h may determine that the uplink transmission was not successfully received, and may attempt to retransmit the transmission in a subsequent uplink transmission.

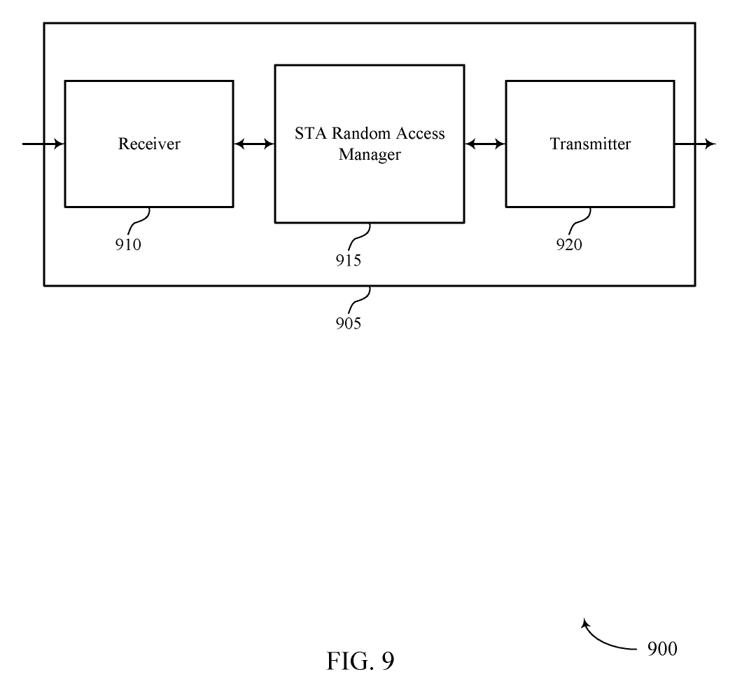

FIG. 9 shows a block diagram 900 of a wireless device 905 that supports random access regulation techniques for wireless stations in accordance with aspects of the present disclosure. Wireless device 905 may be an example of aspects of a STA 115 as described with reference to FIGS. 1 through 5. Wireless device 905 may include receiver 910, STA random access manager 915, and transmitter 920. Wireless device 905 may also include a processor. Each of these components may be in communication with one another (such as via one or more buses).

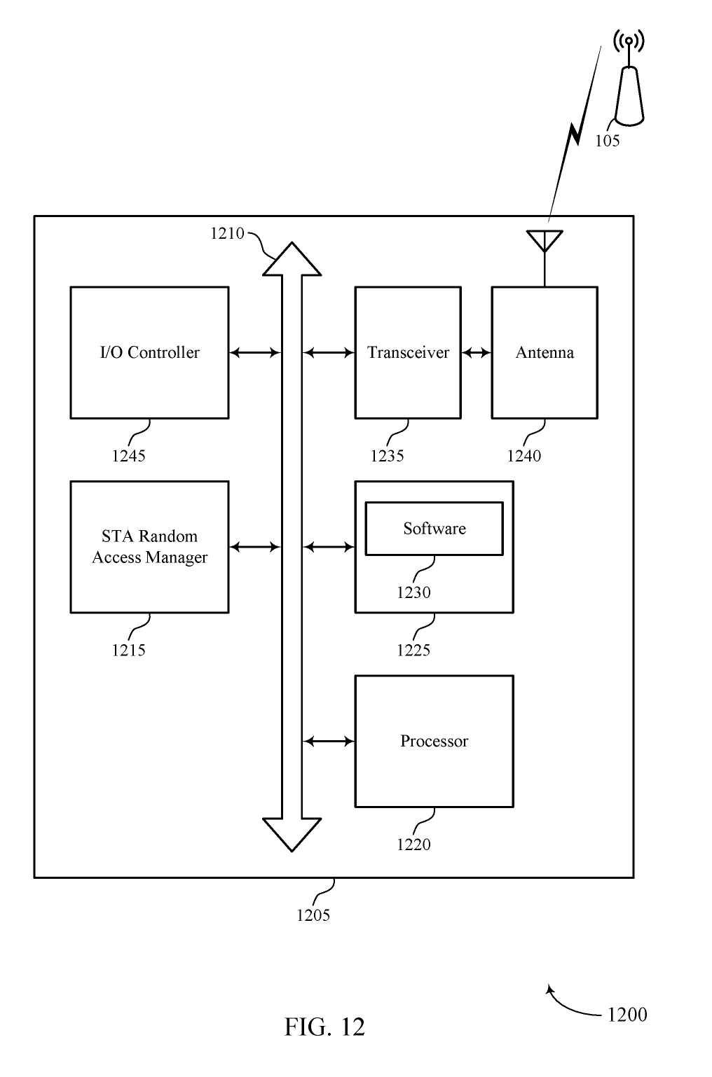

Receiver 910 may receive information such as packets, user data, or control information associated with various information channels (such as control channels, data channels, and information related to random access regulation techniques for wireless stations, etc.). Information may be passed on to other components of the device. The receiver 910 may be an example of aspects of the transceiver 1235 as described with reference to FIG. 12. The receiver 910 may utilize a single antenna or a set of antennas.

STA random access manager 915 may be an example of aspects of the STA random access manager 1215 as described with reference to FIG. 12.

STA random access manager 915 or at least some of its various sub-components may be implemented in hardware, software executed by a processor, firmware, or any combination thereof. If implemented in software executed by a processor, the functions of the STA random access manager 915 or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA random access manager 915 or at least some of its various sub-components may be physically located at different locations, including being distributed such that portions of functions are implemented at different physical locations by one or more physical devices. In some implementations, STA random access manager 915 or at least some of its various sub-components may be a separate and distinct component in accordance with aspects of the present disclosure. In other implementations, STA random access manager 915 or at least some of its various sub-components may be combined with one or more other hardware components, including but not limited to an I/O component, a transceiver, a network server, another computing device, one or more other components described in the present disclosure, or a combination thereof in accordance with aspects of the present disclosure.

STA random access manager 915 may receive a trigger frame from an AP 105 that indicates one or more random access RUs are available for an uplink transmission from the STA 115, determine a connectivity parameter associated with the STA 115 and the AP 105, the connectivity parameter associated with an eligibility of the one or more random access RUs. In some cases, the connectivity parameter may be associated with determining an eligibility of the one or more random access RUs. The STA random access manager 915 may modify a value of a random access counter responsive to the determining, and transmit the uplink transmission using one or more of the random access RUs based on the modified value of the random access counter.

In some implementations, the AP 105 (and/or the STAs 115) may possess information based on the conditions or the connectivity associated with one or more communications links related to the different STAs 115, including the location of each STA 115 in the BSS. In this case, it may be beneficial for the AP 105 to determine and configure one or more connectivity parameters for farther away STAs 115 in its BSS, or uplink-limited STAs 115, such that the farther or uplink-limited STAs 115 are able to access the resources when conflicts with closer STAs 115 occur. Connectivity parameters may be associated with connections, abilities, or aspects related to the AP 105 connecting with one or more STAs 115. The connectivity parameter may, for example, relate to a constraint on a STA' s ability to or configuration for connecting with or communication with an AP 105, such as whether the STA 115 is limited to certain capabilities or limits on connection with the AP 105. As another example, the connectivity parameter may include a rule (such as a prioritization rule), in which case the AP 105 may signal metrics indicating that one or more RUs may be prioritized for particular sets of STAs 115 thus constraining the operation of the STAs 115 in certain conditions. In this case, the STA random access manager 915 (among other components) may determine the connectivity parameter associated with the STA 115 and/or the AP 105, based on which the STA 115 may be able to determine whether, for example, one or more random access RUs may be eligible and then take appropriate action. As an example, the connectivity parameter may include an RA Prioritization field with an associated UORA Power Headroom Limit as described herein and the STA 115 may operate based on the RA Prioritization field with an associated UORA Power Headroom Limit. Based on this, a STA 115 may determine whether or not the STA 115 is eligible to use one or more corresponding random access RAs, for example, as described herein.

In some cases, the STA random access manager 915 may receive a trigger frame from an AP 105 that indicates one or more random access RUs are available for a transmission of an uplink transmission from the STA 115 to the AP 105, determine that the STA 115 has a non-empty buffer, and transmit the uplink transmission using one or more of the random access RUs based on the determining. In some cases, the STA random access manager 915 may receive a buffer status request from an AP 105 that indicates one or more random access RUs are available for a transmission of a buffer status report from the STA 115 to the AP 105, determine that the STA 115 has a non-empty buffer, and transmit the buffer status report using one or more of the random access RUs based on the determining.

In some cases, the STA random access manager 915 may receive a trigger frame from an AP 105 that indicates that one or more random access RUs are available for an uplink transmission from the STA 115, the random access RUs being identified using a first AID. The STA random access manager 915 may also be configured to transmit the uplink transmission to the AP 105 using a first RU of the one or more of the random access RUs, and to receive an acknowledgment in a downlink transmission from the AP 105 that indicates whether the uplink transmission in the first RU was successfully received at the AP 105. In some cases, the acknowledgment may include the first AID, a MAC address, or a combination thereof, among other possibilities. The STA random access manager 915 may, in some implementations, be further configured to receive a signaling field in the downlink transmission that includes a STA identification associated with the acknowledgment, and to determine that the uplink transmission to the AP 105 was successfully received based on the acknowledgment and the STA identification.

In some cases, the STA random access manager 915 may receive, at the STA 115, a trigger frame from an AP 105 that indicates one or more random access RUs are available for an uplink transmission from the STA. The STA random access manager 915 may determine a connectivity parameter of the STA 115 with the AP 105. The connectivity parameter may be associated with an eligibility of the one or more random access RUs. The STA random access manager 915 may transmit the uplink transmission using one or more of the random access RUs based on the determined connectivity parameter.

Transmitter 920 may transmit signals generated by other components of the device (such as from the STA random access manager 915). In some implementations, the transmitter 920 may be collocated with a receiver 910 in a transceiver module. For example, the transmitter 920 may be an example of aspects of the transceiver 1235 as described with reference to FIG. 12. The transmitter 920 may utilize a single antenna or a set of antennas.

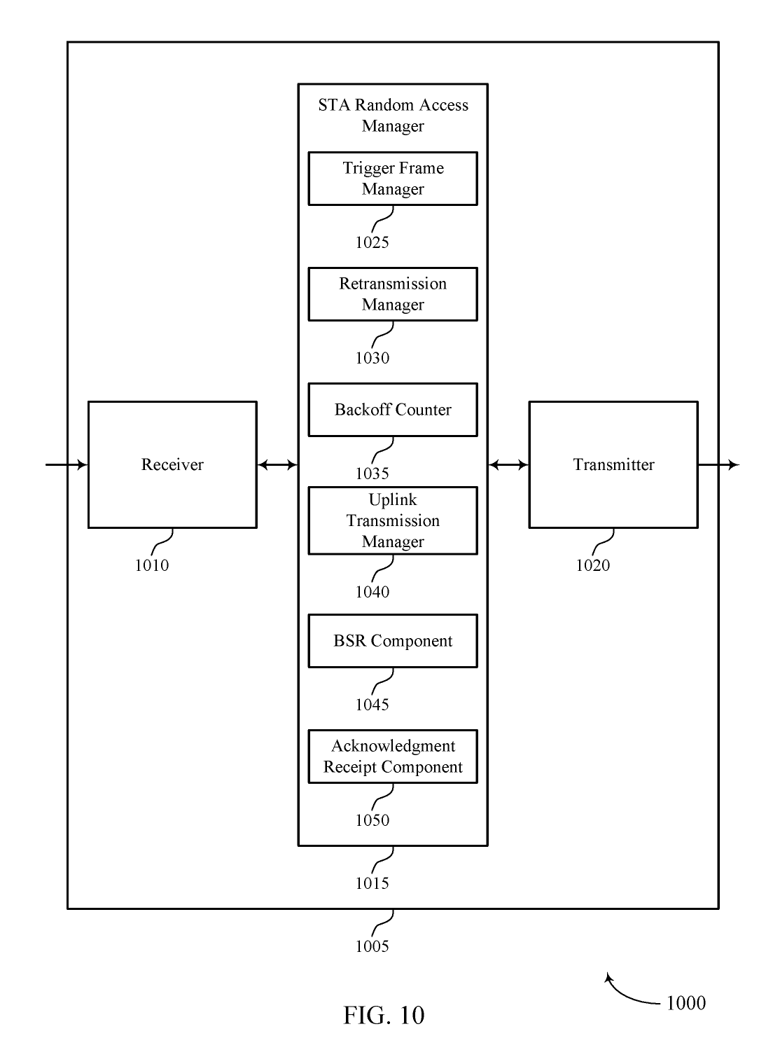

FIG. 10 shows a block diagram 1000 of a wireless device 1005 that supports random access regulation techniques for wireless stations in accordance with aspects of the present disclosure. Wireless device 1005 may be an example of aspects of a wireless device 1005 or a STA 115 as described with reference to FIGS. 1 through 5, 9, 11, and 12. Wireless device 1005 may include receiver 1010, STA random access manager 1015, and transmitter 1020. Wireless device 1005 may also include a processor. Each of these components may be in communication with one another (such as via one or more buses).

Receiver 1010 may receive information such as packets, user data, or control information associated with various information channels (such as control channels, data channels, and information related to random access regulation techniques for wireless stations, etc.). Information may be passed on to other components of the device. The receiver 1010 may be an example of aspects of the transceiver 1235 as described with reference to FIG. 12. The receiver 1010 may utilize a single antenna or a set of antennas.

STA random access manager 1015 may be an example of aspects of the STA random access manager 1215 as described below with reference to FIG. 12. STA random access manager 1015 may also include trigger frame manager 1025, retransmission manager 1030, backoff counter 1035, uplink transmission manager 1040, BSR component 1045, and acknowledgment receipt component 1050.

Trigger frame manager 1025 may receive a trigger frame from an AP 105 that indicates one or more random access RUs are available for an uplink transmission from the STA 115. In some cases, the trigger frame may be a BSRP trigger frame, and the uplink transmission may be a buffer status report. Trigger frame manager 1025 may receive a buffer status request from an AP 105 that indicates one or more random access RUs are available for a transmission of an uplink transmission from the STA 115 to the AP 105. In some cases, trigger frame manager 1025 may determine that the STA 115 is associated with the AP 105, and the trigger frame may further indicate that the one or more random access RUs are available for uplink transmissions of associated STAs 115. In some cases, the trigger frame may further indicate that at least a first RU different from the one or more random access RUs is available for uplink transmissions of unassociated STAs 115. In some cases, a first number of random access RUs for associated STAs 115 may be greater than a second number of random access RUs for unassociated STAs 115. In some cases, a first number of random access RUs for associated STAs 115 may be less than a second number of random access RUs for unassociated STAs 115. In some cases, the one or more random access RUs may be available for uplink transmissions from STAs 115 that are unassociated with the AP 105 (for example, only from STAs 115 that are unassociated with the AP 105).

In some cases, the trigger frame may be received in a BSRP trigger frame, and the uplink transmission may be a buffer status report. In some cases, the one or more random access RUs may be available for uplink transmissions from STAs 115 that are associated with the AP 105 (for example, only from STAs 115 that are associated with the AP 105). In some cases, the trigger frame may include a buffer status request, a buffer quality request, or a combination thereof. In some cases, trigger frame manager 1025 may receive, at a STA 115, a trigger frame from an AP 105 that indicates one or more random access RUs are available for an uplink transmission from the STA 115. In some cases, trigger frame manager 1025 may determine a connectivity parameter of the STA 115 with the AP 105, the connectivity parameter being associated with an eligibility of the one or more random access RUs. In some cases, trigger frame manager 1025 may determine a presence of an indication of a power headroom limit for the connectivity parameter. In some cases, trigger frame manager 1025 may identify a prioritization rule for one or more of the random access RUs based on the determined presence of the indication of the power headroom limit. In such cases, transmitting the uplink transmission using one or more of the random access RUs is based on the identified prioritization rule. In some cases, trigger frame manager 1025 may determine an absence of an indication of a power headroom limit. In such cases, transmitting the uplink transmission using one or more of the random access RUs is based on the absence of the indication of the power headroom limit. In some cases, trigger frame manager 1025 may further determine a default power headroom limit based on determining the absence of the indication of the power headroom limit.

Retransmission manager 1030 may determine a connectivity parameter of the STA 115 with the AP 105, the connectivity parameter associated with an eligibility of the one or more random access RUs. In some cases, retransmission manager 1030 may determine that the STA 115 is uplink-limited. In some cases, retransmission manager 1030 may allocate a greater number of RUs for the STA based on determining that the STA is uplink-limited, where determining that the STA is uplink-limited is based on the connectivity parameter. In some cases, the determining that the STA 115 is uplink-limited includes determining that one or more uplink transmissions have failed prior to receiving the trigger frame. In some cases, the determination that the STA 115 is uplink-limited may be made based on a SLRC value being non-zero.

Backoff counter 1035 may modify a value of a random access counter responsive to the determining. In some cases, the modifying the random access counter includes decrementing a backoff counter (such as an OBO counter) based on a number of random access RUs indicated in the trigger frame when the STA 115 is uplink-limited. In some cases, the modifying is based on the associated eligibility of the one or more random access RUs, the one or more random access RUs including one or more restricted RUs. In some cases, the transmitting the uplink transmission includes transmitting the uplink transmission when the backoff counter reaches zero. In some cases, the modifying the random access counter further includes maintaining a same value of the backoff counter when the STA 115 is not uplink-limited.

Uplink transmission manager 1040 may transmit the uplink transmission using one or more of the random access RUs based on the modified value of the random access counter. In some cases, uplink transmission manager 1040 may transmit the buffer status report using one or more of the random access RUs based on determining that a STA 115 has a non-empty buffer. In some cases, uplink transmission manager 1040 may transmit the uplink transmission to the AP 105 using a first RU of the one or more of the random access RUs. BSR component 1045 may determine that the STA 115 has a non-empty buffer. In some cases, uplink transmission manager 1040 may determine whether to transmit at a first transmit power (e.g., a maximum transmit power) for the assigned MCS based on one or more restricted RUs, where the connectivity parameter, as may have been determined by the retransmission manager 1030, is based on the associated eligibility of the one or more random access RUs, the one or more random access RUs including the one or more restricted RUs. In some cases, uplink transmission manager 1040 may transmit the uplink transmission using one or more of the random access RUs based on the determined connectivity parameter. In some cases, uplink transmission manager 1040 may determine that the STA 115 is able to meet a target RSSI threshold without exceeding a power headroom limit, where transmitting the uplink transmission is based on determining that the STA 115 is able to meet the target RSSI threshold without exceeding the power headroom limit. In some cases, the target RSSI threshold may be based on an assigned MCS. Uplink transmission manager 1040 may determine a feedback indication based on a connectivity of a second STA 115 with the AP 105, and transmit the feedback indication to the AP 105. In some implementations, the feedback indication may include NDP feedback.

Acknowledgment receipt component 1050 may receive an acknowledgment in a downlink transmission from the AP 105 that indicates whether the uplink transmission in the first RU was successfully received at the AP 105. In some cases, acknowledgment receipt component 1050 may receive a signaling field in the downlink transmission that includes a STA 115 identification associated with the acknowledgment, and determine that the uplink transmission to the AP 105 was successfully received based on and AID of the acknowledgment being the same as an AID of the uplink transmission and the received STA 115 identification being the same as the STAs identification.

Transmitter 1020 may transmit signals generated by other components of the device. In some implementations, the transmitter 1020 may be collocated with a receiver 1010 in a transceiver module. For example, the transmitter 1020 may be an example of aspects of the transceiver 1235 as described with reference to FIG. 12. The transmitter 1020 may utilize a single antenna or a set of antennas.

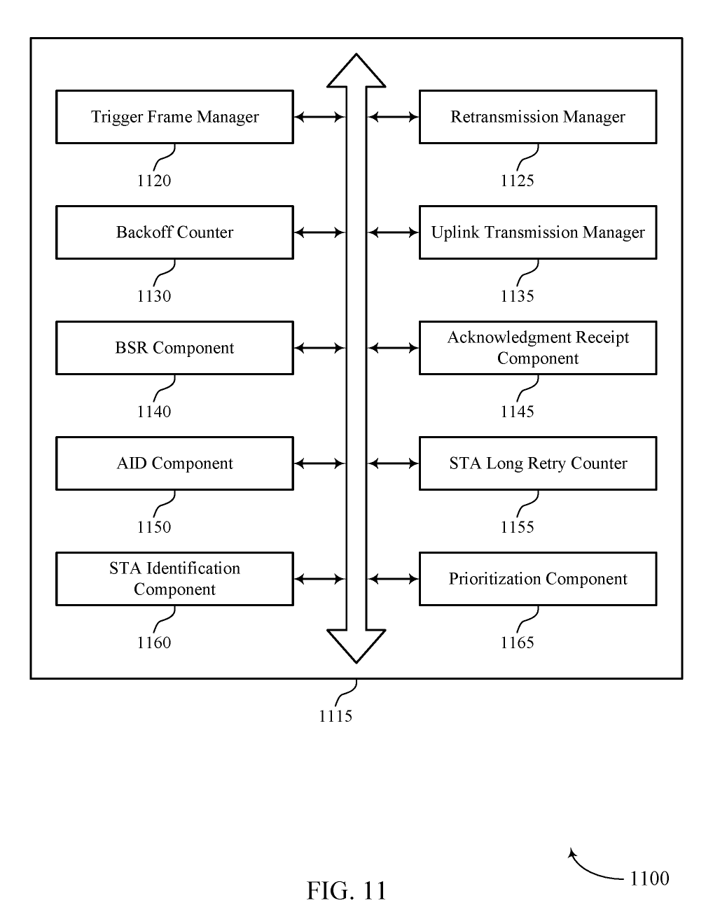

FIG. 11 shows a block diagram 1100 of a STA random access manager 1015 that supports random access regulation techniques for wireless stations in accordance with aspects of the present disclosure. The STA random access manager 1015 may be an example of aspects of a STA random access manager 815, a STA random access manager 915, or a STA random access manager 1115 as described with reference to FIGS. 9 through 12 and 12, respectively. The STA random access manager 1015 may include trigger frame manager 1120, retransmission manager 1125, backoff counter 1130, uplink transmission manager 1135, BSR component 1140, acknowledgment receipt component 1145, AID component 1150, STA long retry counter 1155, STA identification component 1160 and prioritization component 1165. Each of these modules may communicate, directly or indirectly, with one another (such as via one or more buses).

Trigger frame manager 1120 may receive a trigger frame from an AP 105 that indicates one or more random access RUs are available for an uplink transmission from the STA 115. In some cases, the trigger frame may be a BSRP trigger frame, and trigger frame manager 1120 may receive a trigger frame from an AP 105 that indicates one or more random access RUs are available for an uplink transmission of an uplink transmission (for example, a buffer status report) from the STA 115 to the AP 105. In some cases, trigger frame manager 1120 may determine that the STA 115 is associated with the AP 105, and the trigger frame further indicates that the one or more random access RUs are available for uplink transmissions of associated STAs 115. In some cases, the trigger frame further indicates that at least a first RU different from the one or more random access RUs is available for uplink transmissions of unassociated STAs 115. In some cases, a first number of random access RUs for associated STAs 115 is greater than a second number of random access RUs for unassociated STAs 115. In some cases, a first number of random access RUs for associated STAs 115 is less than a second number of random access RUs for unassociated STAs 115. In some cases, the one or more random access RUs are available for uplink transmissions only from STAs 115 that are unassociated with the AP 105. In some cases, the trigger frame may be received in a BSRP trigger frame, and the uplink transmission may be a buffer status report. In some cases, the one or more random access RUs are available for uplink transmissions only from STAs 115 that are associated with the AP 105. In some cases, the trigger frame may include a buffer status request, a buffer quality request, a basic trigger frame, or a combination thereof.

In some cases, trigger frame manager 1120 may receive, at a STA 115, a trigger frame from an AP 105 that indicates one or more random access RUs are available for an uplink transmission from the STA 115. In some cases, trigger frame manager 1120 may determine a connectivity parameter of the STA with the AP, the connectivity parameter associated with an eligibility of the one or more random access RUs. In some cases, trigger frame manager 1120 may determine a presence of an indication of a power headroom limit for the connectivity parameter. In some cases, trigger frame manager 1120 may identify a prioritization rule for one or more of the random access RUs based on the determined presence of the indication of the power headroom limit, where transmitting the uplink transmission using one or more of the random access RUs is based on the identified prioritization rule. In some cases, trigger frame manager 1120 may determine an absence of an indication of a power headroom limit, where transmitting the uplink transmission using one or more of the random access RUs is based on the absence of the indication of the power headroom limit. In some cases, trigger frame manager 1120 may further determine a default power headroom limit based on determining the absence of the indication of the power headroom limit.

Retransmission manager 1125 may determine a connectivity parameter of the STA 115 with the AP 105, the connectivity parameter associated with an eligibility of the one or more random access RUs. In some cases, retransmission manager 1125 may determine that the STA 115 is uplink-limited. In some cases, retransmission manager 1125 may allocate a greater number of RUs for the STA based on determining that the STA is uplink-limited, where determining that the STA is uplink-limited is based on the connectivity parameter. In some cases, the determining that the STA 115 is uplink-limited includes determining that one or more uplink transmissions have failed prior to receiving the trigger frame.

Backoff counter 1130 may modify a value of a random access counter responsive to the determining. In some cases, the modifying the random access counter includes decrementing a backoff counter based on a number of random access RUs indicated in the trigger frame when the STA 115 is uplink-limited. In some cases, the modifying is based on the associated eligibility of the one or more random access RUs, the one or more random access RUs including one or more restricted RUs. In some cases, the transmitting the uplink transmission includes transmitting the uplink transmission when the backoff counter reaches zero. In some cases, the modifying the random access counter further includes maintaining a same value of the backoff counter when the STA 115 is not uplink-limited. In some cases, the backoff counter is an OBO counter.

Uplink transmission manager 1135 may transmit the uplink transmission using one or more of the random access RUs based on the modified value of the random access counter. In some cases, uplink transmission manager 1135 may transmit the uplink transmission (for example, the buffer status report) using one or more of the random access RUs based on the determining. The uplink transmission manager 1135 also may transmit the uplink transmission to the AP 105 using a first RU of the one or more of the random access RUs. BSR component 1140 may determine that the STA 115 has a non-empty buffer. In some cases, uplink transmission manager 1135 may determine whether to transmit the uplink transmission at a first transmit power for the assigned MCS based on one or more restricted RUs, where the connectivity parameter is based on the associated eligibility of the one or more random access RUs, the one or more random access RUs including the one or more restricted RUs. In some cases, the first transmit power for the assigned MCS is a maximum transmit power for the assigned MCS. In some cases, uplink transmission manager 1135 may transmit the uplink transmission using one or more of the random access RUs based on the determined connectivity parameter. In some cases, uplink transmission manager 1135 may determine that the STA 115 is able to meet a target RSSI threshold without exceeding a power headroom limit, where transmitting the uplink transmission is based on determining that the STA 115 is able to meet the target RSSI threshold without exceeding the power headroom limit. Uplink transmission manager 1135 may determine a feedback indication based on a connectivity of a second STA 115 with the AP 105, and transmit the feedback indication to the AP 105. In some implementations, the feedback indication may include NDP feedback.

Acknowledgment receipt component 1145 may receive an acknowledgment in a downlink transmission from the AP 105 that indicates whether the uplink transmission in the first RU was successfully received at the AP. In some cases, acknowledgment receipt component 1145 may receive a signaling field in the downlink transmission that includes a STA identification associated with the acknowledgment, and determine that the uplink transmission to the AP 105 was successfully received based on and AID of the acknowledgment being the same as an AID of the uplink transmission and the received STA identification being the same as the identification of the STA 115.

AID component 1150 may identify a first AID that indicates one or more random access RUs available for uplink transmissions of associated STAs 115 and a second AID that indicates at least one RU is available for uplink transmissions of unassociated STAs 115. In some cases, the trigger frame includes a first AID that indicates the one or more random access RUs available for transmission of the uplink transmission (for example, the buffer status report). In some cases, the STA 115 is associated with the AP 105 and the random access RUs are identified by a first AID for associated STAs 115. In some cases, the receiving of the acknowledgment includes receiving an acknowledgment frame in a downlink RU identified by the first AID. In some cases, the STA 115 is unassociated with the AP 105 and the random access RUs are identified by a second AID for unassociated STAs 115, and the receiving of the acknowledgment includes receiving an acknowledgment frame in a downlink RU identified by the second AID.

STA long retry counter 1155 may maintain the SLRC for use in determining that the STA 115 is uplink-limited when the SLRC is non-zero. STA identification component 1160 may identify that the STA 115 has a first STA identification, and the determination that an uplink transmission was successfully received may be based at least in part on the STA identification in the signaling field matching the first STA identification, and determining that the uplink transmission was unsuccessfully received when the STA identification in the signaling field is different than the first STA identification. In some cases, the STA identification includes one or more of a STA-ID or a MAC address. In some cases, the STA-ID may include a value representing all unassociated STAs.

Prioritization component 1165 may identify a prioritization rule for one or more of the random access RUs, where transmitting the uplink transmission using one or more of the random access RUs includes transmitting the uplink transmission based on the identified prioritization rule. In some cases, the prioritization rule may be applied to each of the one or more random access RUs. In some cases, the prioritization rule may be applied to the one or more random access RUs on a per random access RU-basis. In some cases, prioritization component 1165 may receive the prioritization rule via signaling in a User Info field. In some cases, prioritization component 1165 may receiving the prioritization rule via signaling in an overloaded bit. In some cases, the prioritization rule is applied to each of the one or more random access RUs of the trigger frame. In some cases, the prioritization rule is applied based on a new entry to a RU allocation subfield of the trigger frame. In some cases, the prioritization rule is applied based on a combination of entries to two or more RU allocation subfields of the trigger frame.

FIG. 12 illustrates a block diagram of a system 1200 including a device that supports random access regulation techniques for wireless stations in accordance with aspects of the present disclosure. Device 1205 may be an example of or include the components of wireless device 905, wireless device 1005, or a STA 115 as described above, such as with reference to FIGS. 1 through 5 and 9 through 11. Device 1205 may include components for bi-directional voice and data communications including components for transmitting and receiving communications, including STA random access manager 1215, processor 1220, memory 1225, software 1230, transceiver 1235, antenna 1240, and I/O controller 1245. These components may be in electronic communication via one or more busses (such as bus 1210).

Processor 1220 may include an intelligent hardware device, (such as a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (such as functions or tasks supporting random access regulation techniques for wireless stations).

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a basic input/output system (BIOS) which may control basic hardware and software operation such as the interaction with peripheral components or devices.

Software 1230 may include code to implement aspects of the present disclosure, including code to support random access regulation techniques for wireless stations. Software 1230 may be stored in a non-transitory computer-readable medium such as system memory or other memory. In some cases, the software 1230 may not be directly executable by the processor but may cause a computer (such as when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

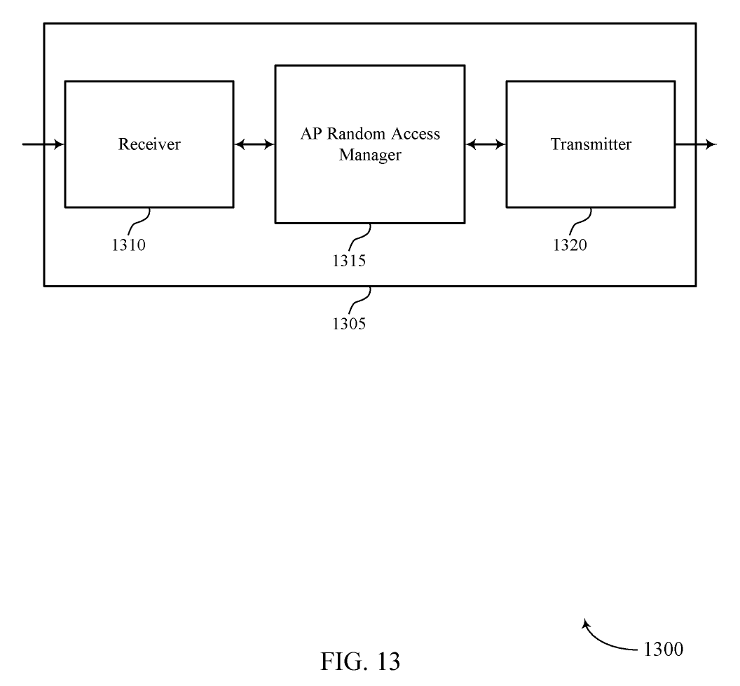

FIG. 13 shows a block diagram 1300 of a device 1305 that supports random access regulation techniques for wireless stations in accordance with aspects of the present disclosure. Device 1305 may be an example of aspects of an AP 105 as described with reference to FIGS. 1 through 5. Device 1305 may include receiver 1310, AP random access manager 1315, and transmitter 1320. Device 1305 may also include a processor. Each of these components may be in communication with one another (such as via one or more buses).

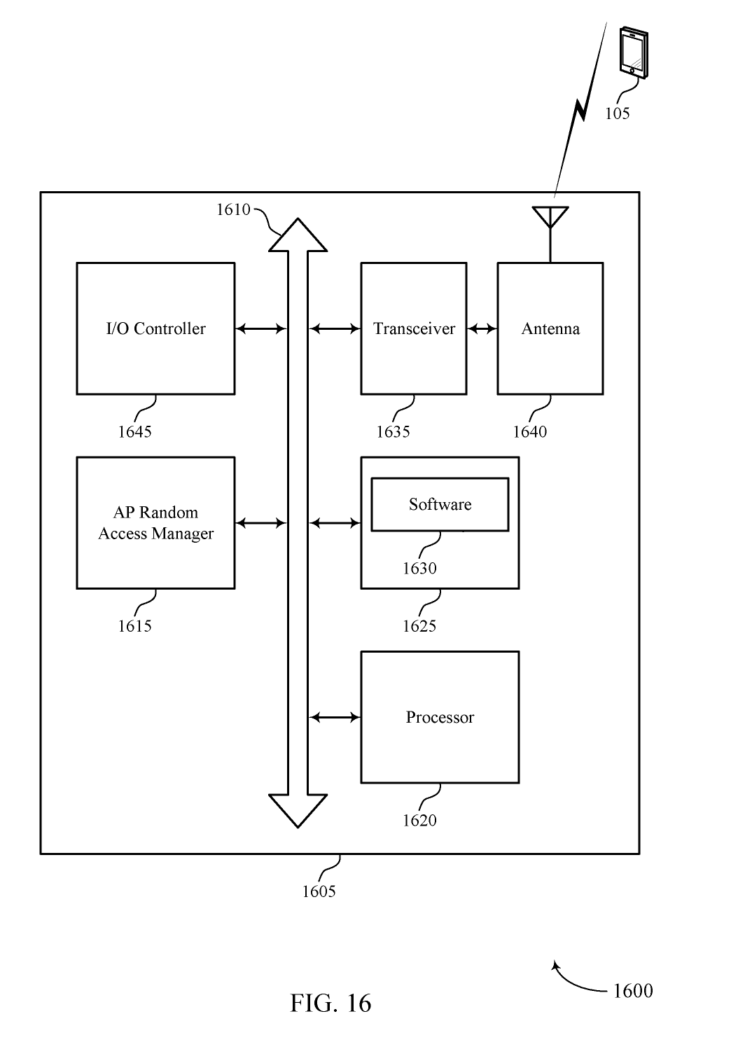

Receiver 1310 may receive information such as packets, user data, or control information associated with various information channels (such as control channels, data channels, and information related to random access regulation techniques for wireless stations, etc.). Information may be passed on to other components of the device. The receiver 1310 may be an example of aspects of the transceiver 1635 as described with reference to FIG. 16. The receiver 1310 may utilize a single antenna or a set of antennas.

AP random access manager 1315 may be an example of aspects of the AP random access manager 1615 as described with reference to FIG. 16.

AP random access manager 1315 or at least some of its various sub-components may be implemented in hardware, software executed by a processor, firmware, or any combination thereof. If implemented in software executed by a processor, the functions of the AP random access manager 1315 or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. In some implementations, AP random access manager 1315 or at least some of its various sub-components may be a separate and distinct component in accordance with aspects of the present disclosure. In other implementations, AP random access manager 1315 or at least some of its various sub-components may be combined with one or more other hardware components, including but not limited to an I/O component, a transceiver, a network server, another computing device, one or more other components described in the present disclosure, or a combination thereof in accordance with aspects of the present disclosure.

AP random access manager 1315 may transmit a trigger frame to two or more STAs 115 that indicates one or more random access RUs are available for uplink transmissions from the STAs 115, receive a first uplink transmission from a first STA 115 over a first RU of the one or more of the random access RUs, identify a STA identification of the first STA 115, transmit an acknowledgment that indicates that the first uplink transmission in the first RU was successfully received at the AP 105, and transmit a signaling field that includes the STA identification of the first STA 115.

In some implementations, AP primary component 1415 may transmit a trigger frame to a first STA 115 of a first set of STAs 115 that indicates one or more random access RUs are available for uplink transmissions from the STA 115, determine a prioritization rule for one or more of the random access RUs, transmit to the first STA 115 an indication of the prioritization rule for one or more of the random access RUs, and receive a first uplink transmission from the first STA 115 over a first RU of the one or more of the random access RUs based on the prioritization rule.

The AP random access manager 1315 may also configure a trigger frame with a set of random access RUs available for random access uplink transmissions from one or more STAs 115, identify a first subset of the random access RUs for use by associated STAs 115, identify a second subset of the random access RUs for use by unassociated STAs 115, and transmit an indicator to start the trigger frame to the one or more STAs 115. The AP random access manager 1315 may also configure one or more random access RUs for a transmission of a BSR from a STA 115 to an AP 105 and transmit a BSRP trigger frame indicating the one or more random access RUs to the STA 115 to trigger the transmission of the BSR from the STA 115 to the AP 105, where the BSR is transmitted using one or more of the random access RUs only if the AP 105 has a non-empty buffer.

Transmitter 1320 may transmit signals generated by other components of the device (such as by AP random access manager 1315). In some implementations, the transmitter 1320 may be collocated with a receiver 1310 in a transceiver module. For example, the transmitter 1320 may be an example of aspects of the transceiver 1535 as described with reference to FIG. 16. The transmitter 1320 may utilize a single antenna or a set of antennas.

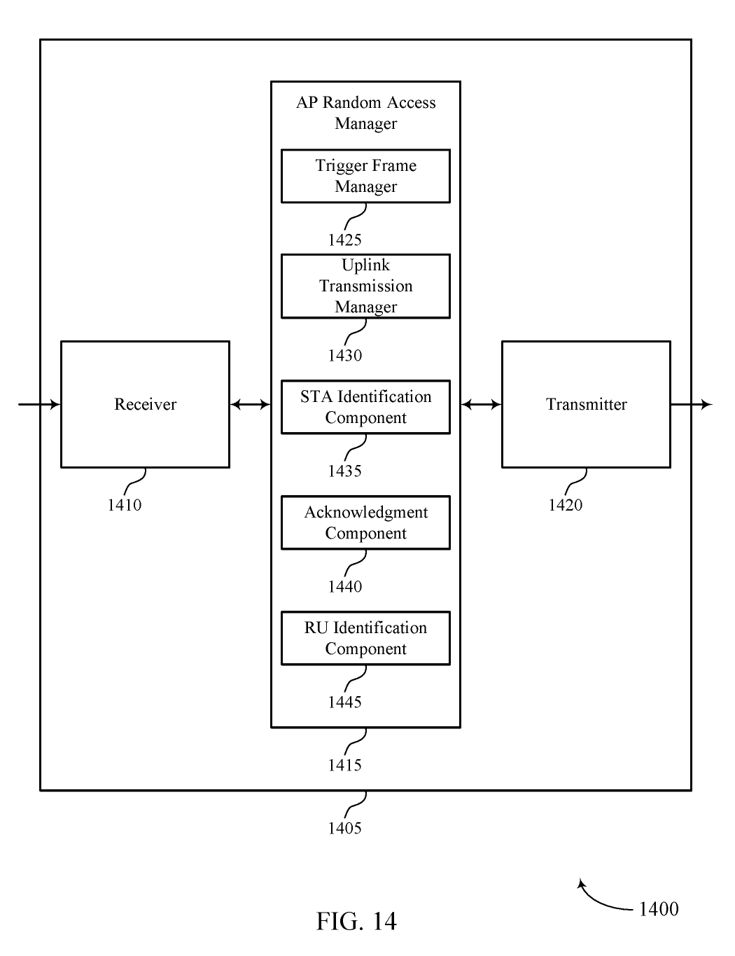

FIG. 14 shows a block diagram 1400 of a device 1405 that supports random access regulation techniques for wireless stations in accordance with aspects of the present disclosure. Device 1405 may be an example of aspects of a device 1205 or an AP 105 as described with reference to FIGS. 1 through 5, 13, 15, and 16. Device 1405 may include receiver 1410, AP random access manager 1415, and transmitter 1420. Device 1405 may also include a processor. Each of these components may be in communication with one another (such as via one or more buses).

Receiver 1410 may receive information such as packets, user data, or control information associated with various information channels (such as control channels, data channels, and information related to random access regulation techniques for wireless stations, etc.). Information may be passed on to other components of the device. The receiver 1410 may be an example of aspects of the transceiver 1635 as described with reference to FIG. 16. The receiver 1410 may utilize a single antenna or a set of antennas.

AP random access manager 1415 may be an example of aspects of the AP random access manager 1615 as described with reference to FIG. 16. AP random access manager 1415 may also include trigger frame manager 1425, uplink transmission manager 1430, STA identification component 1435, acknowledgment component 1440, and RU identification component 1445.

Trigger frame manager 1425 may configure a trigger frame with a set of random access RUs available for random access uplink transmissions from one or more STAs 115, and transmit an indicator to start the trigger frame to the one or more STAs 115. In some cases, trigger frame manager 1425 may transmit a trigger frame to two or more STAs 115 that indicates one or more random access RUs are available for uplink transmissions from the STAs 115. In some cases, trigger frame manager 1425 may transmit a BSRP trigger frame indicating the one or more random access RUs to the STA 115 to trigger the transmission of the BSR from the STA 115 to the AP 105, where the BSR is transmitted using one or more of the random access RUs only if the AP 105 has a non-empty buffer.

In some implementations, trigger frame manager 1425 may transmit a trigger frame to a first STA 115 of a first set of STAs 115 that indicates one or more random access RUs are available for uplink transmissions from the STA 115 and transmit the trigger frame to a second STA 115 of the two or more STAs 115 that indicates one or more random access RUs are available for uplink transmissions from the STAs. Trigger frame manager 1425 may determine a prioritization rule for one or more of the random access RUs, transmit to the first STA 115 an indication of the prioritization rule for one or more of the random access RUs, and transmit to the second STA 115 the indication of the prioritization rule for one or more of the random access RUs. Trigger frame manager 1425 may determine that a second uplink transmission was not received from the second STA 115 over a second RU of the one or more of the random access RUs based on the prioritization rule. In some cases, the trigger frame may include the indication of the prioritization rule. In some cases, the prioritization rule may be based on an elapsed time since a previous received uplink transmission from the first STA. In some cases, the prioritization rule may be based on a total number of STAs 115 in the first set of STAs 115. In some cases, the feedback indication may include null data packet feedback. In some cases, the prioritization rule may be based on a location of the first STA 115. In some cases, the first STA 115 may include a cell-edge STA 115. In some cases, the prioritization rule may be based on a ratio of cell-edge STAs 115 of the first set of STAs 115 to a total number of STAs 115 of the first set of STAs 115. In some cases, trigger frame manager 1425 may determine to transmit the trigger frame to the first STA 115 of the first set of STAs 115 based on a feedback indication received from a second STA 115 of the first set of STAs 115, an elapsed time since a previous received uplink transmission from a cell-edge STA 115, or a combination thereof.

Uplink transmission manager 1430 may receive a first uplink transmission from a first STA 115 over a first RU of the one or more of the random access RUs. STA identification component 1435 may identify a STA identification of the first STA 115. In some cases, the STA identification includes one or more of a STA-ID or a MAC address. In some cases, the STA-ID may include a value representing all unassociated STAs. In some implementations, uplink transmission manager 1430 may receive a first uplink transmission from the first STA over a first RU of the one or more of the random access RUs based on the prioritization rule. Uplink transmission manager 1430 may receive a feedback indication from a second STA of the first set of STAs, where the prioritization rule may be determined based on the received feedback. Uplink transmission manager 1430 may receive a second uplink transmission from the second STA over a second RU of the one or more of the random access RUs based on the prioritization rule.

Acknowledgment component 1440 may transmit an acknowledgment that indicates that the first uplink transmission in the first RU was successfully received at the AP 105 and transmit a signaling field that includes the STA identification of the first STA 115.

RU identification component 1445 may identify a first subset of the random access RUs for use by associated STAs 115, identify a second subset of the random access RUs for use by unassociated STAs 115, select a number of random access RUs for each of the first subset of random access RUs and the second subset of random access RUs based on one or more of a number of associated STAs 115 that have retransmitted uplink transmissions or a number of probe requests received from unassociated STAs 115. In some cases, RU identification component 1445 may configure one or more random access RUs for a transmission of a BSR from a STA 115 to an AP 105. In some cases, the first subset of random access RUs includes more RUs than the second subset of random access RUs. In some cases, the first subset of random access RUs includes less RUs than the second subset of random access RUs. In some cases, the one or more random access RUs are available for uplink transmissions only from STAs 115 that are associated with the AP 105. In some cases, the one or more random access RUs are available for uplink transmissions only from STAs 115 that are unassociated with the AP 105.

Transmitter 1420 may transmit signals generated by other components of the device. In some implementations, the transmitter 1420 may be collocated with a receiver 1410 in a transceiver module. For example, the transmitter 1420 may be an example of aspects of the transceiver 1635 as described with reference to FIG. 16. The transmitter 1420 may utilize a single antenna or a set of antennas.

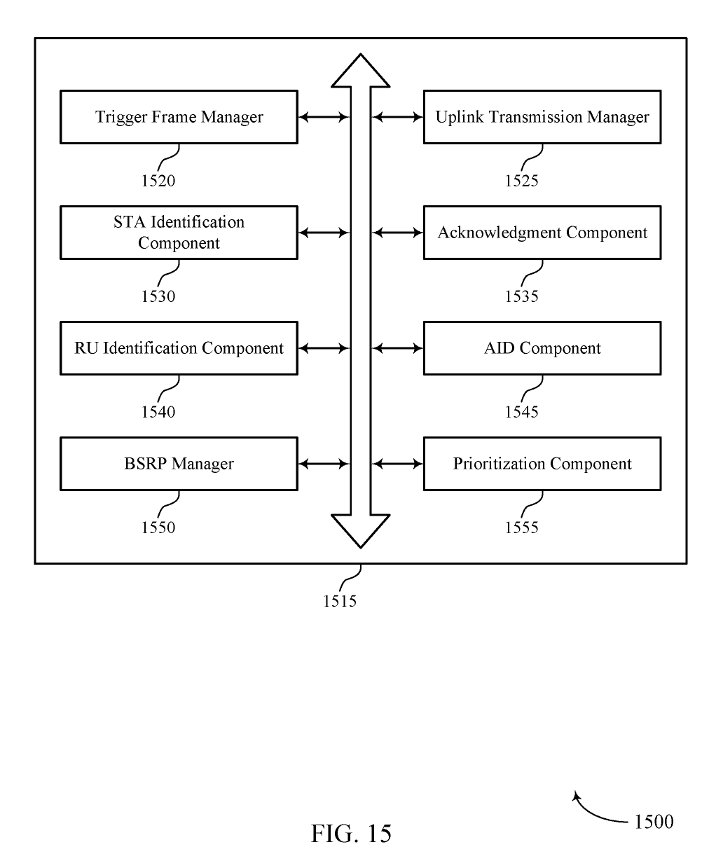

FIG. 15 shows a block diagram 1500 of a device 1515 that supports random access regulation techniques for wireless stations in accordance with aspects of the present disclosure. The device 1515 may be an AP random access manager, and may be an example of aspects of a AP random access manager 1315 as described with reference to FIGS. 13, 13, and 15. The device 1515 may include trigger frame manager 1520, uplink transmission manager 1525, STA identification component 1530, acknowledgment component 1535, RU identification component 1540, AID component 1545, BSRP manager 1550, and prioritization component 1555. Each of these modules may communicate, directly or indirectly, with one another (such as via one or more buses).

Trigger frame manager 1520 may configure a trigger frame with a set of random access RUs available for random access uplink transmissions from one or more STAs 115, and transmit an indicator to start the trigger frame to the one or more STAs 115. In some cases, trigger frame manager 1520 may transmit a trigger frame to two or more STAs 115 that indicates one or more random access RUs are available for uplink transmissions from the STAs 115. In some cases, trigger frame manager 1520 may transmit a BSRP trigger frame indicating the one or more random access RUs to the STA 115 to trigger the transmission of the BSR from the STA 115 to the AP 105, where the BSR is transmitted using one or more of the random access RUs only if the AP 105 has a non-empty buffer.

In some implementations, trigger frame manager 1520 may transmit a trigger frame to a first STA 115 of a first set of STAs 115 that indicates one or more random access RUs are available for uplink transmissions from the STA 115 and transmit the trigger frame to a second STA 115 of the two or more STAs 115 that indicates one or more random access RUs are available for uplink transmissions from the STAs 115. Trigger frame manager 1520 may determine a prioritization rule for one or more of the random access RUs, transmit to the first STA 115 an indication of the prioritization rule for one or more of the random access RUs, and transmit to the second STA 115 the indication of the prioritization rule for one or more of the random access RUs. Trigger frame manager 1520 may determine that a second uplink transmission was not received from the second STA 115 over a second RU of the one or more of the random access RUs based on the prioritization rule. In some cases, the trigger frame may include the indication of the prioritization rule. In some cases, the prioritization rule may be based on an elapsed time since a previous received uplink transmission from the first STA. In some cases, the prioritization rule may be based on a total number of STAs 115 in the first set of STAs 115. In some cases, the feedback indication may include null data packet feedback. In some cases, the prioritization rule may be based on a location of the first STA 115. In some cases, the first STA 115 may be a cell-edge STA 115. In some cases, the prioritization rule may be based on a ratio of cell-edge STAs 115 of the first set of STAs 115 to a total number of STAs 115 of the first set of STAs 115. In some cases, trigger frame manager 1520 may determine to transmit the trigger frame to the first STA 115 of the first set of STAs 115 based on a feedback indication received from a second STA 115 of the first set of STAs 115, an elapsed time since a previous received uplink transmission from a cell-edge STA 115, or a combination thereof.

Uplink transmission manager 1525 may receive a first uplink transmission from a first STA 115 over a first RU of the one or more of the random access RUs. STA identification component 1530 may identify a STA identification of the first STA 115. In some cases, the STA identification includes one or more of a STA-ID or a MAC address. In some cases, the STA-ID may include a value representing all unassociated STAs.

In some implementations, uplink transmission manager 1525 may receive a first uplink transmission from the first STA over a first RU of the one or more of the random access RUs based on the prioritization rule. Uplink transmission manager 1525 may receive a feedback indication from a second STA of the first set of STAs, where the prioritization rule may be determined based on the received feedback. Uplink transmission manager 1525 may receive a second uplink transmission from the second STA over a second RU of the one or more of the random access RUs based on the prioritization rule.

Acknowledgment component 1535 may transmit an acknowledgment that indicates that the first uplink transmission in the first RU was successfully received at the AP 105 and transmit a signaling field that includes the STA identification of the first STA 115f.

RU identification component 1540 may identify a first subset of the random access RUs for use by associated STAs 115, identify a second subset of the random access RUs for use by unassociated STAs 115, and select a number of random access RUs for each of the first subset of random access RUs and the second subset of random access RUs based on one or more of a number of associated STAs 115 that have retransmitted uplink transmissions or a number of probe requests received from unassociated STAs 115. In some cases, RU identification component 1540 may configure one or more random access RUs for a transmission of a BSR from a STA 115 to an AP 105. In some cases, the first subset of random access RUs includes more RUs than the second subset of random access RUs. In some cases, the first subset of random access RUs includes less RUs than the second subset of random access RUs. In some cases, the one or more random access RUs are available for uplink transmissions only from STAs 115 that are associated with the AP 105. In some cases, the one or more random access RUs are available for uplink transmissions only from STAs 115 that are unassociated with the AP 105.

AID component 1545 may assign a first AID value to indicate the first subset of random access RUs and a second AID value to indicate the second subset of random access RUs. In some cases, the one or more random access RUs include a first subset of RUs for STAs 115 that are associated with the AP 105 and a second subset of RUs for STAs 115 that are unassociated with the AP 105, the first subset of RUs are indicated in the trigger frame by a first AID for associated STAs 115, and the second subset of RUs are indicated in the trigger frame by a MAC address for unassociated STAs 115. In some cases, an uplink transmission may be received in a first RU in the first subset of RUs, and the acknowledgment may be transmitted in an acknowledgment frame in a downlink RU identified by the first AID. In some cases, the first RU is in the second subset of RUs, and the acknowledgment may be transmitted in an acknowledgment frame in a downlink RU identified by the second AID. BSRP manager 1550 may determine a number of associated STAs 115, and selecting a number of random access RUs based on the number of associated STAs 115.

Prioritization component 1555 may identify a prioritization rule for one or more of the random access RUs, and transmit an indication of the prioritization rule to the first STA, where receiving the first uplink transmission may be based on the transmitted indication of the prioritization rule. In some cases, the prioritization rule is applied to each of the one or more random access RUs. In some cases, the prioritization rule is applied to the one or more random access RUs on a per random access RU-basis. In some cases, the prioritization component 1555 may transmit the indication of the prioritization rule via signaling in a User Info field. In some cases, the prioritization component 1555 may transmit the indication of the prioritization rule via signaling in an overloaded bit. In some cases, the prioritization rule is applied to each of the one or more random access RUs of the trigger frame. In some cases, the prioritization rule may be applied based on a new entry to a RU allocation subfield of the trigger frame. In some cases, the prioritization rule is applied based on a combination of entries to two or more RU allocation subfields of the trigger frame.

FIG. 16 shows a block diagram of a system 1600 including an AP 1605 that supports random access regulation techniques for wireless stations in accordance with aspects of the present disclosure. AP 1605 may be an example of or include the components of AP 105 as described above, such as with reference to FIGS. 1 through 5. AP 1605 may include components for bi-directional voice and data communications including components for transmitting and receiving communications, including AP random access manager 1615, processor 1620, memory 1625, software 1630, transceiver 1635, antenna 1640, and I/O controller 1645. These components may be in electronic communication via one or more busses (such as bus 1610).

Processor 1620 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, processor 1620 may be configured to operate a memory array using a memory controller. In other cases, a memory controller may be integrated into processor 1620. Processor 1620 may be configured to execute computer-readable instructions stored in a memory to perform various functions (such as functions or tasks supporting random access regulation techniques for wireless stations).

Memory 1625 may include RAM and ROM. The memory 1625 may store computer-readable, computer-executable software 1630 including instructions that, when executed, cause the processor to perform various functions described herein. In some cases, the memory 1625 may contain, among other things, a BIOS which may control basic hardware and software operation such as the interaction with peripheral components or devices.

Software 1630 may include code to implement aspects of the present disclosure, including code to support random access regulation techniques for wireless stations. Software 1630 may be stored in a non-transitory computer-readable medium such as system memory or other memory. In some cases, the software 1630 may not be directly executable by the processor but may cause a computer (such as when compiled and executed) to perform functions described herein.

Transceiver 1635 may communicate bi-directionally, via one or more antennas, wired, or wireless links as described above. For example, the transceiver 1635 may represent a wireless transceiver and may communicate bi-directionally with another wireless transceiver. The transceiver 1635 may also include a modem to modulate the packets and provide the modulated packets to the antennas for transmission, and to demodulate packets received from the antennas.

In some cases, the wireless device may include a single antenna 1640. However, in some cases the device may have more than one antenna 1640, which may be capable of concurrently transmitting or receiving multiple wireless transmissions.

I/O controller 1645 may manage input and output signals for AP 1605. I/O controller 1645 may also manage peripherals not integrated into AP 1605. In some cases, I/O controller 1645 may represent a physical connection or port to an external peripheral. In some cases, I/O controller 1645 may utilize an operating system such as iOS®, ANDROID®, MS-DOS®, MS-WINDOWS®, OS/2®, UNIX®, LINUX®, or another known operating system. In other cases, I/O controller 1645 may represent or interact with a modem, a keyboard, a mouse, a touchscreen, or a similar device. In some cases, I/O controller 1645 may be implemented as part of a processor. In some cases, a user may interact with AP 1605 via I/O controller 1645 or via hardware components controlled by I/O controller 1645.

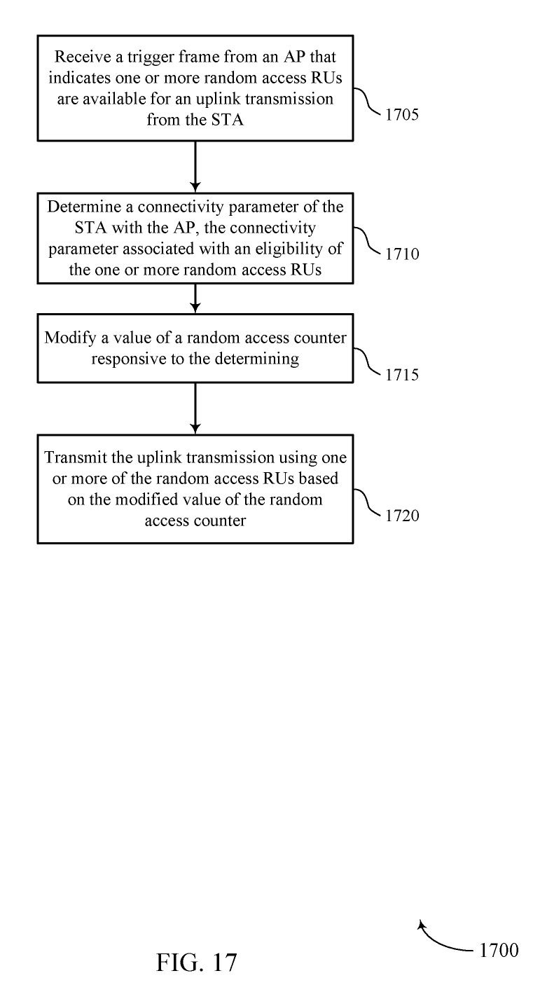

FIG. 17 illustrates a method 1700 for random access regulation techniques for wireless stations in accordance with aspects of the present disclosure. The operations of method 1700 may be implemented by a STA 115 or its components as described herein. For example, the operations of method 1700 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 1705 the STA 115 may receive a trigger frame from an AP 105 that indicates one or more random access RUs are available for an uplink transmission from the STA 115. The operations of block 1705 may be performed according to the methods as described with reference to FIGS. 2 through 8. In certain implementations, aspects of the operations of block 1705 may be performed by a trigger frame manager as described with reference to FIGS. 9 through 12.

At block 1710 the STA 115 may determine a connectivity parameter of the STA 115 with the AP 105, the connectivity parameter associated with an eligibility of the one or more random access RUs. The operations of block 1710 may be performed according to the methods as described with reference to FIGS. 2 through 8. In certain implementations, aspects of the operations of block 1710 may be performed by a retransmission manager as described with reference to FIGS. 9 through 12.

At block 1715 the STA 115 may modify a value of a random access counter responsive to the determining. The operations of block 1715 may be performed according to the methods as described with reference to FIGS. 2 through 8. In certain implementations, aspects of the operations of block 1715 may be performed by a backoff counter as described with reference to FIGS. 9 through 12.

At block 1720 the STA 115 may transmit the uplink transmission using one or more of the random access RUs based at least in part on the modified value of the random access counter. The operations of block 1720 may be performed according to the methods as described with reference to FIGS. 2 through 8. In certain implementations, aspects of the operations of block 1720 may be performed by an uplink transmission manager as described with reference to FIGS. 9 through 12.

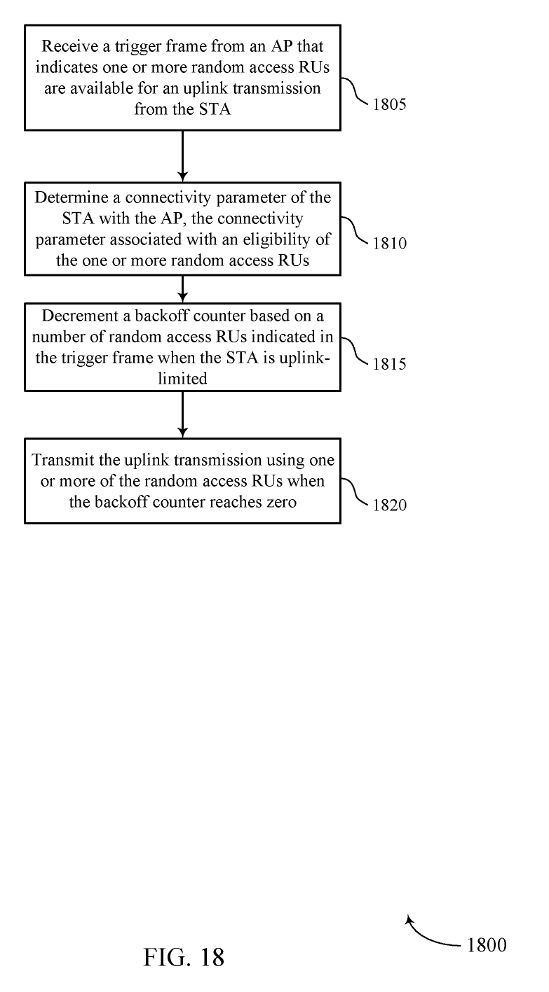

FIG. 18 illustrates a method 1800 for random access regulation techniques for wireless stations in accordance with aspects of the present disclosure. The operations of method 1800 may be implemented by a STA 115 or its components as described herein. For example, the operations of method 1800 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 1805 the STA 115 may receive a trigger frame from an AP 105 that indicates one or more random access RUs are available for an uplink transmission from the STA 115. The operations of block 1805 may be performed according to the methods as described with reference to FIGS. 2 through 8. In certain implementations, aspects of the operations of block 1805 may be performed by a trigger frame manager as described with reference to FIGS. 9 through 12.

At block 1810 the STA 115 may determine a connectivity parameter of the STA 115 with the AP 105, the connectivity parameter associated with an eligibility of the one or more random access RUs. The operations of block 1810 may be performed according to the methods as described with reference to FIGS. 2 through 8. In certain implementations, aspects of the operations of block 1810 may be performed by a retransmission manager as described with reference to FIGS. 9 through 12.

At block 1815 the STA 115 may decrement a backoff counter based at least in part on a number of random access RUs indicated in the trigger frame when the STA 115 is uplink-limited. The operations of block 1815 may be performed according to the methods as described with reference to FIGS. 2 through 8. In certain implementations, aspects of the operations of block 1815 may be performed by a backoff counter as described with reference to FIGS. 9 through 12.

At block 1820 the STA 115 may transmit the uplink transmission using one or more of the random access RUs when the backoff counter reaches zero. The operations of block 1820 may be performed according to the methods as described with reference to FIGS. 2 through 8. In certain implementations, aspects of the operations of block 1820 may be performed by an uplink transmission manager as described with reference to FIGS. 9 through 12.

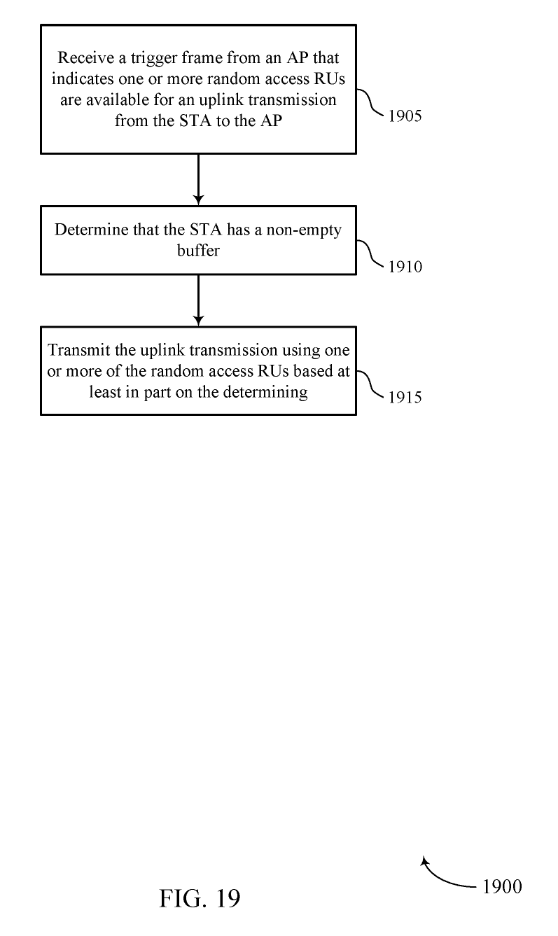

FIG. 19 illustrates a method 1900 for random access regulation techniques for wireless stations in accordance with aspects of the present disclosure. The operations of method 1900 may be implemented by a STA 115 or its components as described herein. For example, the operations of method 1900 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 1905 the STA 115 may receive a trigger frame from an AP 105 that indicates one or more random access RUs are available for a transmission from the STA 115 to the AP 105. The operations of block 1905 may be performed according to the methods as described with reference to FIGS. 2 through 8. In certain implementations, aspects of the operations of block 1905 may be performed by a trigger frame manager as described with reference to FIGS. 8 through 12.

At block 1910 the STA 115 may determine that the STA 115 has a non-empty buffer. The operations of block 1910 may be performed according to the methods as described with reference to FIGS. 2 through 8. In certain implementations, aspects of the operations of block 1910 may be performed by a BSR component as described with reference to FIGS. 9 through 12.

At block 1915 the STA 115 may transmit the trigger frame using one or more of the random access RUs based at least in part on the determining. The operations of block 1915 may be performed according to the methods as described with reference to FIGS. 2 through 8. In certain implementations, aspects of the operations of block 1915 may be performed by an uplink transmission manager as described with reference to FIGS. 8 through 12.

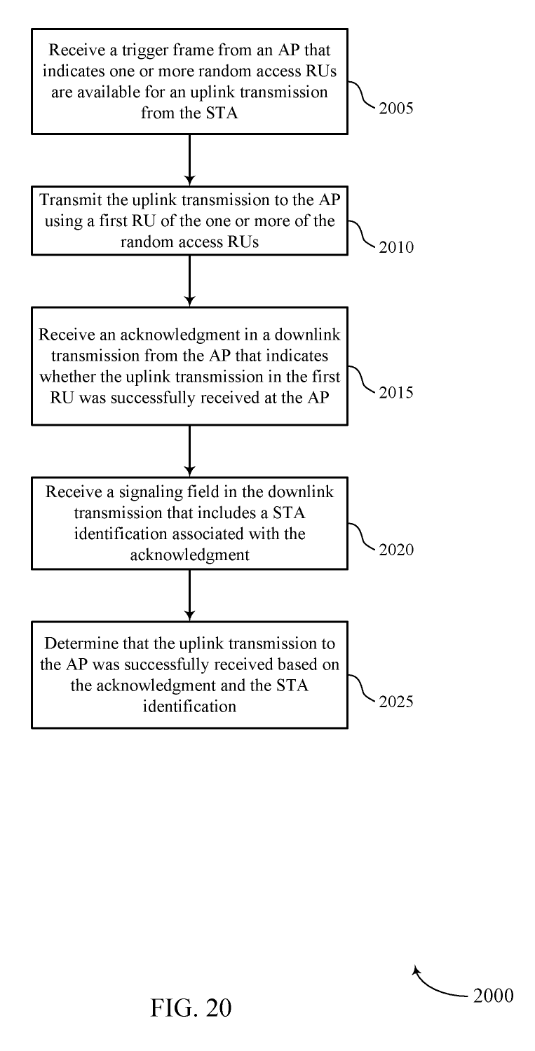

FIG. 20 illustrates a method 2000 for random access regulation techniques for wireless stations in accordance with aspects of the present disclosure. The operations of method 2000 may be implemented by a STA 115 or its components as described herein. For example, the operations of method 2000 may be performed by a STA random access manager as described with reference to FIGS. 8 through 12. In some implementations, a STA 115 may execute a set of codes to control the functional elements of the device to perform the functions described below. Additionally or alternatively, the STA 115 may perform aspects of the functions described below using special-purpose hardware.

At block 2005 the STA 115 may receive a trigger frame from an AP 105 that indicates one or more random access RUs are available for an uplink transmission from the STA 115. The operations of block 2005 may be performed according to the methods as described with reference to FIGS. 2 through 8. In certain implementations, aspects of the operations of block 2005 may be performed by a trigger frame manager as described with reference to FIGS. 9 through 12. The random access RUs may be identified using a first AID.

At block 2010 the STA 115 may transmit the uplink transmission to the AP 105 using a first RU of the one or more of the random access RUs. The operations of block 2010 may be performed according to the methods as described with reference to FIGS. 2 through 8. In certain implementations, aspects of the operations of block 2010 may be performed by an uplink transmission manager as described with reference to FIGS. 9 through 12.

At block 2015 the STA 115 may receive an acknowledgment in a downlink transmission from the AP 105 that indicates whether the uplink transmission in the first RU was successfully received at the AP 105. The operations of block 2015 may be performed according to the methods as described with reference to FIGS. 2 through 8. In certain implementations, aspects of the operations of block 2015 may be performed by an acknowledgment receipt component as described with reference to FIGS. 9 through 12. In some cases, the acknowledgment may be transmitted in a RU including the first AID, a MAC address, or a combination thereof.

At block 2020 the STA 115 may receive a signaling field in the downlink transmission that includes a STA identification associated with the acknowledgment. The operations of block 2020 may be performed according to the methods as described with reference to FIGS. 2 through 8. In certain implementations, aspects of the operations of block 2020 may be performed by an acknowledgment receipt component as described with reference to FIGS. 9 through 12.

At block 2025 the STA 115 may determine that the uplink transmission to the AP 105 was successfully received based at least in part on the acknowledgment and the STA identification. The operations of block 2025 may be performed according to the methods as described with reference to FIGS. 2 through 8. In certain implementations, aspects of the operations of block 2025 may be performed by an acknowledgment receipt component as described with reference to FIGS. 9 through 12.

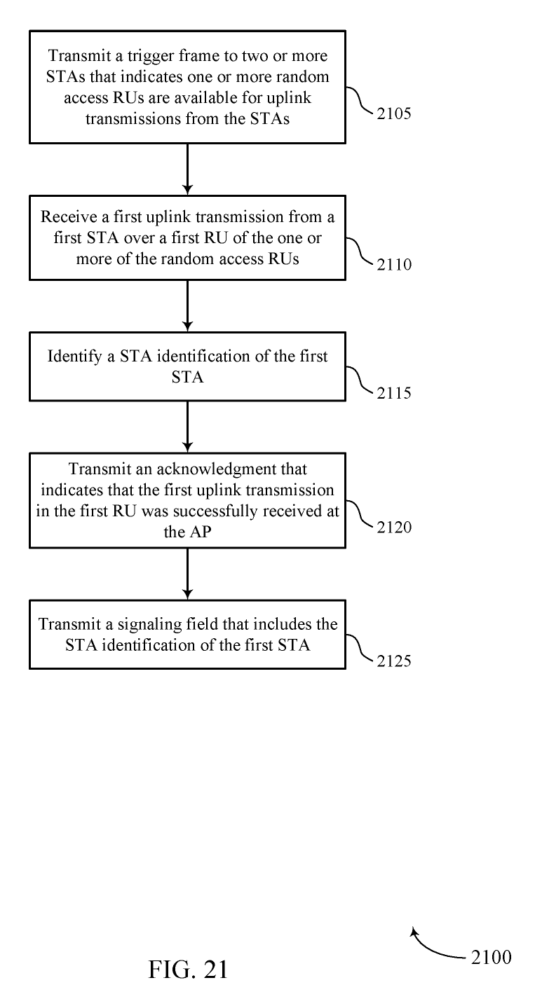

FIG. 21 illustrates a method 2100 for random access regulation techniques for wireless stations in accordance with aspects of the present disclosure. The operations of method 2100 may be implemented by a AP 105 or its components as described herein. For example, the operations of method 2100 may be performed by a AP random access manager as described with reference to FIGS. 13 through 16. In some implementations, a AP 105 may execute a set of codes to control the functional elements of the device to perform the functions described below. Additionally or alternatively, the AP 105 may perform aspects of the functions described below using special-purpose hardware.

At block 2105 the AP 105 may transmit a trigger frame to two or more STAs 115 that indicates one or more random access RUs are available for uplink transmissions from the STAs 115. The operations of block 2105 may be performed according to the methods as described with reference to FIGS. 2 through 8. In certain implementations, aspects of the operations of block 2105 may be performed by a trigger frame manager as described with reference to FIGS. 13 through 16. The one or more random access RUs may be identified with a first AID.

At block 2110 the AP 105 may receive a first uplink transmission from a first STA 115 over a first RU of the one or more of the random access RUs. The operations of block 2110 may be performed according to the methods as described with reference to FIGS. 2 through 8. In certain implementations, aspects of the operations of block 2110 may be performed by an uplink transmission manager as described with reference to FIGS. 13 through 16.

At block 2115 the AP 105 may identify a STA identification of the first STA 115. The operations of block 2115 may be performed according to the methods as described with reference to FIGS. 2 through 8. In certain implementations, aspects of the operations of block 2115 may be performed by a STA identification component as described with reference to FIGS. 13 through 16.

At block 2120 the AP 105 may transmit an acknowledgment that indicates that the first uplink transmission in the first RU was successfully received at the AP 105. The operations of block 2120 may be performed according to the methods as described with reference to FIGS. 2 through 8. In certain implementations, aspects of the operations of block 2120 may be performed by an acknowledgment component as described with reference to FIGS. 13 through 16. The acknowledgment may be transmitted using an RU having the first AID.

At block 2125 the AP 105 may transmit a signaling field that includes the STA identification of the first STA 115. The operations of block 2125 may be performed according to the methods as described with reference to FIGS. 2 through 8. In certain implementations, aspects of the operations of block 2125 may be performed by an acknowledgment component as described with reference to FIGS. 13 through 16.

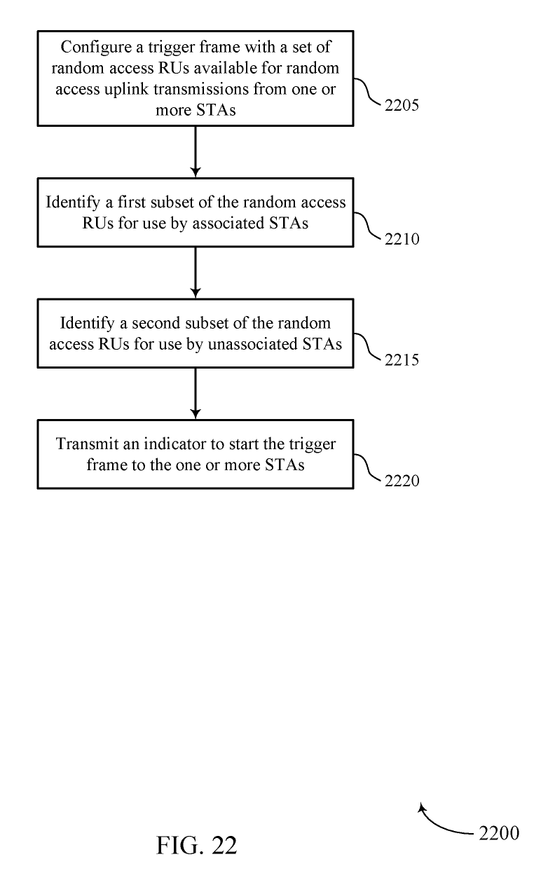

FIG. 22 illustrates a method 2200 for random access regulation techniques for wireless stations in accordance with aspects of the present disclosure. The operations of method 2200 may be implemented by a AP 105 or its components as described herein. For example, the operations of method 2200 may be performed by a AP random access manager as described with reference to FIGS. 13 through 16. In some implementations, a AP 105 may execute a set of codes to control the functional elements of the device to perform the functions described below. Additionally or alternatively, the AP 105 may perform aspects of the functions described below using special-purpose hardware.

At block 2205 the AP 105 may configure a trigger frame with a set of random access RUs available for random access uplink transmissions from one or more STAs 115. The operations of block 2205 may be performed according to the methods as described with reference to FIGS. 2 through 8. In certain implementations, aspects of the operations of block 2205 may be performed by a trigger frame manager as described with reference to FIGS. 13 through 16.

At block 2210 the AP 105 may identify a first subset of the random access RUs for use by associated STAs 115. The operations of block 2210 may be performed according to the methods as described with reference to FIGS. 2 through 8. In certain implementations, aspects of the operations of block 2210 may be performed by a RU identification component as described with reference to FIGS. 13 through 16.

At block 2215 the AP 105 may identify a second subset of the random access RUs for use by unassociated STAs 115. The operations of block 2215 may be performed according to the methods as described with reference to FIGS. 2 through 8. In certain implementations, aspects of the operations of block 2215 may be performed by a RU identification component as described with reference to FIGS. 13 through 16.

At block 2220 the AP 105 may transmit an indicator to start the trigger frame to the one or more STAs 115. The operations of block 2220 may be performed according to the methods as described with reference to FIGS. 2 through 8. In certain implementations, aspects of the operations of block 2220 may be performed by a trigger frame manager as described with reference to FIGS. 13 through 16.

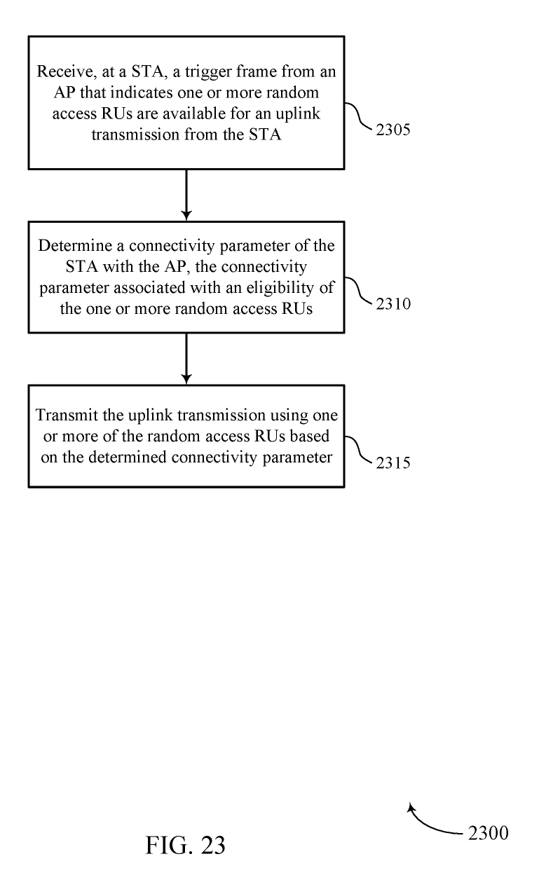

FIG. 23 illustrates a method 2300 for random access regulation techniques for wireless stations in accordance with aspects of the present disclosure. The operations of method 2300 may be implemented by a STA 115 or its components as described herein. For example, the operations of method 2300 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 2305 the STA 115 may receive, at a STA 115, a trigger frame from an AP 105 that indicates one or more random access RUs are available for an uplink transmission from the STA 115. The operations of block 2305 may be performed according to the methods described herein. In certain implementations, aspects of the operations of block 2305 may be performed by a trigger frame manager as described with reference to FIGS. 9 through 12.

At block 2310 the STA 115 may determine a connectivity parameter of the STA 115 with the AP 105, the connectivity parameter associated with an eligibility of the one or more random access RUs. The operations of block 2310 may be performed according to the methods described herein. In certain implementations, aspects of the operations of block 2310 may be performed by a trigger frame manager as described with reference to FIGS. 9 through 12.

At block 2315 the STA 115 may transmit the uplink transmission using one or more of the random access RUs based at least in part on the determined connectivity parameter. The operations of block 2315 may be performed according to the methods described herein. In certain implementations, aspects of the operations of block 2315 may be performed by an uplink transmission manager as described with reference to FIGS. 9 through 12.

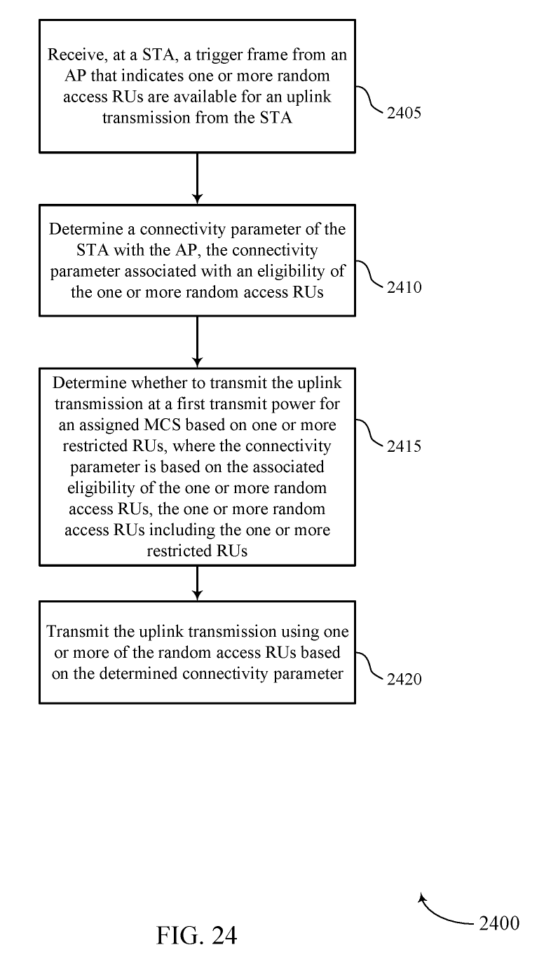

FIG. 24 illustrates a method 2400 for random access regulation techniques for wireless stations in accordance with aspects of the present disclosure. The operations of method 2400 may be implemented by a STA 115 or its components as described herein. For example, the operations of method 2400 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 2405 the STA 115 may receive, at a STA 115, a trigger frame from an AP 105 that indicates one or more random access RUs are available for an uplink transmission from the STA 115. The operations of block 2405 may be performed according to the methods described herein. In certain implementations, aspects of the operations of block 2405 may be performed by a trigger frame manager as described with reference to FIGS. 9 through 12.

At block 2410 the STA 115 may determine a connectivity parameter of the STA 115 with the AP 105, the connectivity parameter associated with an eligibility of the one or more random access RUs. The operations of block 2410 may be performed according to the methods described herein. In certain implementations, aspects of the operations of block 2410 may be performed by a trigger frame manager as described with reference to FIGS. 9 through 12.

At block 2415 the STA 115 may determine whether to transmit the uplink transmission at a first transmit power for an assigned MCS based on one or more restricted RUs, where the connectivity parameter may be based on the associated eligibility of the one or more random access RUs, and the one or more random access RUs may include the one or more restricted RUs. The operations of block 2415 may be performed according to the methods described herein. In certain implementations, aspects of the operations of block 2415 may be performed by an uplink transmission manager as described with reference to FIGS. 9 through 12.

At block 2420 the STA 115 may transmit the uplink transmission using one or more of the random access RUs based at least in part on the determined connectivity parameter. The operations of block 2415 may be performed according to the methods described herein. In certain implementations, aspects of the operations of block 2420 may be performed by an uplink transmission manager as described with reference to FIGS. 9 through 12.

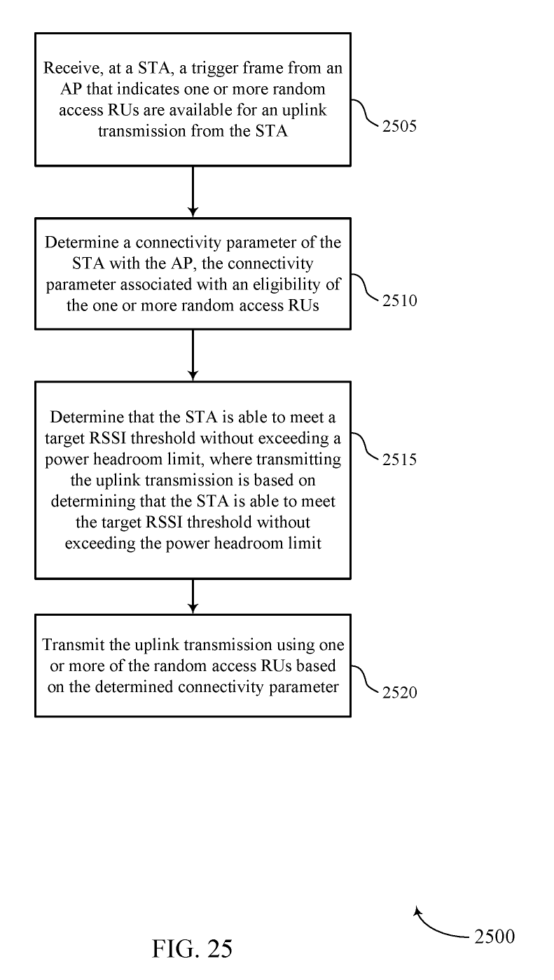

FIG. 25 illustrates a method 2500 for random access regulation techniques for wireless stations in accordance with aspects of the present disclosure. The operations of method 2500 may be implemented by a STA 115 or its components as described herein. For example, the operations of method 2500 may be performed by a STA random access manager as described with reference to FIGS. 9 through 12. In some implementations, a STA 115 may execute a set of codes to control the functional elements of the device to perform the functions described below. Additionally or alternatively, the STA 115 may perform aspects of the functions described below using special-purpose hardware.

At block 2505 the STA 115 may receive, at a STA 115, a trigger frame from an AP 105 that indicates one or more random access RUs are available for an uplink transmission from the STA 115. The operations of block 2505 may be performed according to the methods described herein. In certain implementations, aspects of the operations of block 2505 may be performed by a trigger frame manager as described with reference to FIGS. 9 through 12.

At block 2510 the STA 115 may determine a connectivity parameter of the STA 115 with the AP 105, the connectivity parameter associated with an eligibility of the one or more random access RUs. The operations of block 2510 may be performed according to the methods described herein. In certain implementations, aspects of the operations of block 2510 may be performed by a trigger frame manager as described with reference to FIGS. 9 through 12.

At block 2515 the STA 115 may determine that the STA is able to meet a target RSSI threshold without exceeding a power headroom limit, where transmitting the uplink transmission may be based on determining that the STA is able to meet the target RSSI threshold without exceeding the power headroom limit. The operations of block 2515 may be performed according to the methods described herein. In certain implementations, aspects of the operations of block 2515 may be performed by an uplink transmission manager as described with reference to FIGS. 9 through 12.

At block 2520 the STA 115 may transmit the uplink transmission using one or more of the random access RUs based at least in part on the determined connectivity parameter. The operations of block 2515 may be performed according to the methods described herein. In certain implementations, aspects of the operations of block 2520 may be performed by an uplink transmission manager as described with reference to FIGS. 9 through 12.

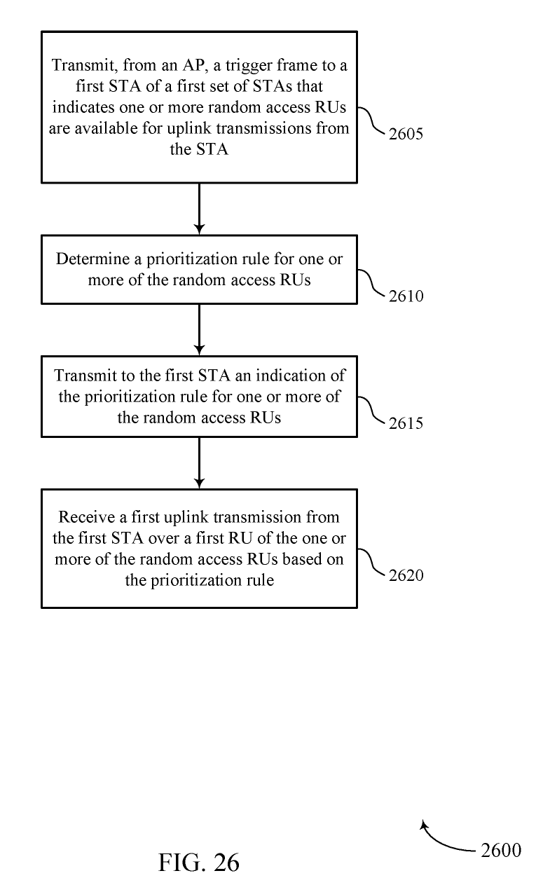

FIG. 26 shows a flowchart illustrating a method 2600 for undefined in accordance with aspects of the present disclosure. The operations of method 2600 may be implemented by a AP 105 or its components as described herein. For example, the operations of method 2600 may be performed by a AP primary component as described with reference to FIGS. 13 through 16. In some examples, a AP 105 may execute a set of codes to control the functional elements of the device to perform the functions described below. Additionally or alternatively, the AP 105 may perform aspects of the functions described below using special-purpose hardware.

At 2605 the AP 105 may transmit, from an access point (AP), a trigger frame to a first station (STA) of a first set of STAs that indicates one or more random access resource units (RUs) are available for uplink transmissions from the STA. The operations of 2605 may be performed according to the methods described herein. In certain examples, aspects of the operations of 2605 may be performed by a trigger frame manager as described with reference to FIGS. 13 through 16.

At 2610 the AP 105 may determine a prioritization rule for one or more of the random access RUs. The operations of 2610 may be performed according to the methods described herein. In certain examples, aspects of the operations of 2610 may be performed by a trigger frame manager as described with reference to FIGS. 13 through 16.

At 2615 the AP 105 may transmit to the first STA an indication of the prioritization rule for one or more of the random access RUs. The operations of 2615 may be performed according to the methods described herein. In certain examples, aspects of the operations of 2615 may be performed by a trigger frame manager as described with reference to FIGS. 13 through 16.

At 2620 the AP 105 may receive a first uplink transmission from the first STA over a first RU of the one or more of the random access RUs based at least in part on the prioritization rule. The operations of 2620 may be performed according to the methods described herein. In certain examples, aspects of the operations of 2620 may be performed by a uplink transmission manager as described with reference to FIGS. 13 through 16.

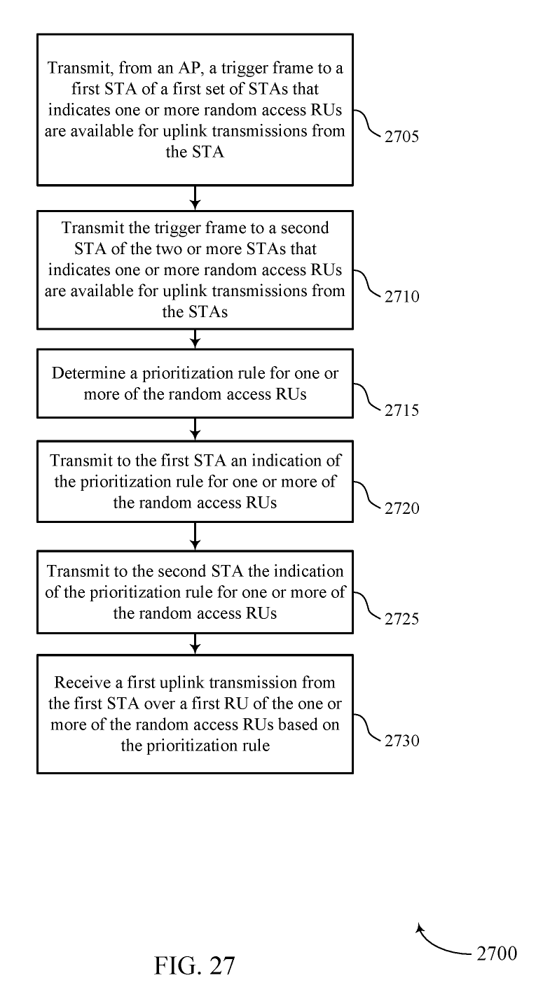

FIG. 27 shows a flowchart illustrating a method 2700 for undefined in accordance with aspects of the present disclosure. The operations of method 2700 may be implemented by a AP 105 or its components as described herein. For example, the operations of method 2700 may be performed by a AP primary component as described with reference to FIGS. 13 through 16. In some examples, a AP 105 may execute a set of codes to control the functional elements of the device to perform the functions described below. Additionally or alternatively, the AP 105 may perform aspects of the functions described below using special-purpose hardware.

At 2705 the AP 105 may transmit, from an access point (AP), a trigger frame to a first station (STA) of a first set of STAs that indicates one or more random access resource units (RUs) are available for uplink transmissions from the STA. The operations of 2705 may be performed according to the methods described herein. In certain examples, aspects of the operations of 2705 may be performed by a trigger frame manager as described with reference to FIGS. 13 through 16.

At 2710 the AP 105 may transmit the trigger frame to a second STA of the two or more STAs that indicates one or more random access RUs are available for uplink transmissions from the STAs. The operations of 2710 may be performed according to the methods described herein. In certain examples, aspects of the operations of 2710 may be performed by a trigger frame manager as described with reference to FIGS. 13 through 16.

At 2715 the AP 105 may determine a prioritization rule for one or more of the random access RUs. The operations of 2715 may be performed according to the methods described herein. In certain examples, aspects of the operations of 2715 may be performed by a trigger frame manager as described with reference to FIGS. 13 through 16.

At 2720 the AP 105 may transmit to the first STA an indication of the prioritization rule for one or more of the random access RUs. The operations of 2720 may be performed according to the methods described herein. In certain examples, aspects of the operations of 2720 may be performed by a trigger frame manager as described with reference to FIGS. 13 through 16.

At 2725 the AP 105 may transmit to the second STA the indication of the prioritization rule for one or more of the random access RUs. The operations of 2725 may be performed according to the methods described herein. In certain examples, aspects of the operations of 2725 may be performed by a trigger frame manager as described with reference to FIGS. 13 through 16.

At 2730 the AP 105 may receive a first uplink transmission from the first STA over a first RU of the one or more of the random access RUs based at least in part on the prioritization rule. The operations of 2730 may be performed according to the methods described herein. In certain examples, aspects of the operations of 2730 may be performed by a uplink transmission manager as described with reference to FIGS. 13 through 16.

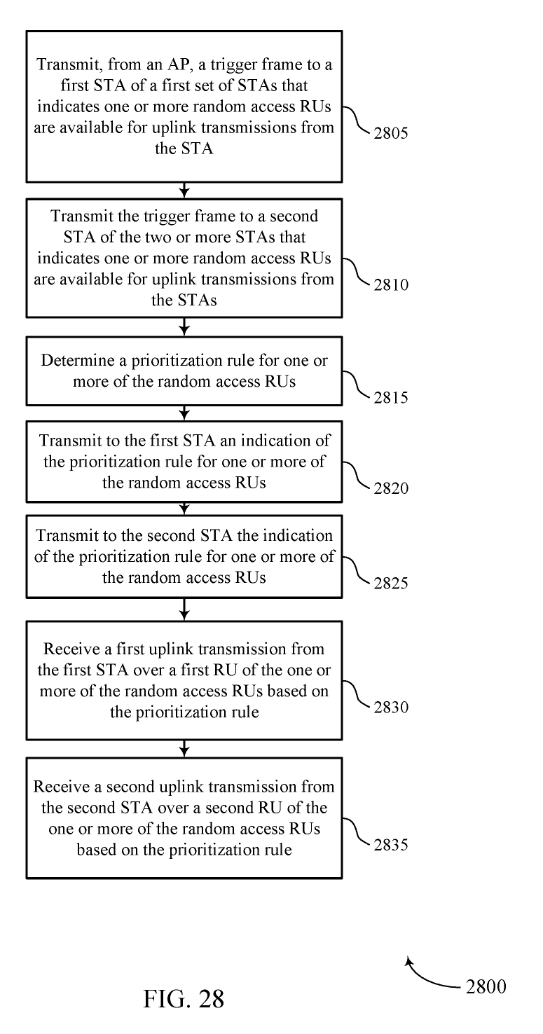

FIG. 28 shows a flowchart illustrating a method 2800 for undefined in accordance with aspects of the present disclosure. The operations of method 2800 may be implemented by a AP 105 or its components as described herein. For example, the operations of method 2800 may be performed by a AP primary component as described with reference to FIGS. 13 through 16. In some examples, a AP 105 may execute a set of codes to control the functional elements of the device to perform the functions described below. Additionally or alternatively, the AP 105 may perform aspects of the functions described below using special-purpose hardware.

At 2805 the AP 105 may transmit, from an access point (AP), a trigger frame to a first station (STA) of a first set of STAs that indicates one or more random access resource units (RUs) are available for uplink transmissions from the STA. The operations of 2805 may be performed according to the methods described herein. In certain examples, aspects of the operations of 2805 may be performed by a trigger frame manager as described with reference to FIGS. 13 through 16.

At 2810 the AP 105 may transmit the trigger frame to a second STA of the two or more STAs that indicates one or more random access RUs are available for uplink transmissions from the STAs. The operations of 2810 may be performed according to the methods described herein. In certain examples, aspects of the operations of 2810 may be performed by a trigger frame manager as described with reference to FIGS. 13 through 16.

At 2815 the AP 105 may determine a prioritization rule for one or more of the random access RUs. The operations of 2815 may be performed according to the methods described herein. In certain examples, aspects of the operations of 2815 may be performed by a trigger frame manager as described with reference to FIGS. 13 through 16.

At 2820 the AP 105 may transmit to the first STA an indication of the prioritization rule for one or more of the random access RUs. The operations of 2820 may be performed according to the methods described herein. In certain examples, aspects of the operations of 2820 may be performed by a trigger frame manager as described with reference to FIGS. 13 through 16.

At 2825 the AP 105 may transmit to the second STA the indication of the prioritization rule for one or more of the random access RUs. The operations of 2825 may be performed according to the methods described herein. In certain examples, aspects of the operations of 2825 may be performed by a trigger frame manager as described with reference to FIGS. 13 through 16.

At 2830 the AP 105 may receive a first uplink transmission from the first STA over a first RU of the one or more of the random access RUs based at least in part on the prioritization rule. The operations of 2830 may be performed according to the methods described herein. In certain examples, aspects of the operations of 2830 may be performed by a uplink transmission manager as described with reference to FIGS. 13 through 16.

At 2835 the AP 105 may receive a second uplink transmission from the second STA over a second RU of the one or more of the random access RUs based at least in part on the prioritization rule. The operations of 2835 may be performed according to the methods described herein. In certain examples, aspects of the operations of 2835 may be performed by a uplink transmission manager as described with reference to FIGS. 13 through 16.

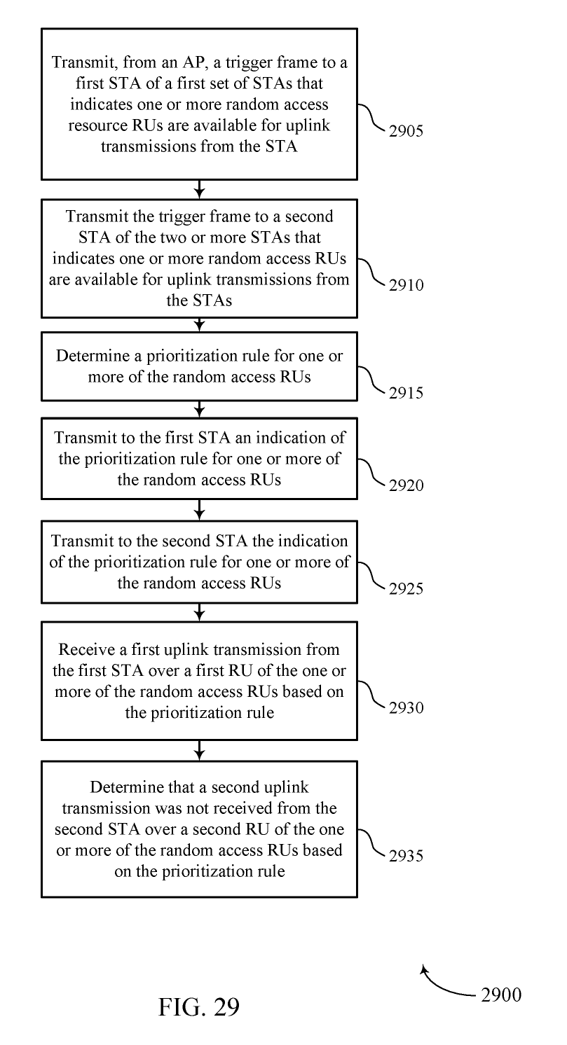

FIG. 29 shows a flowchart illustrating a method 2900 for undefined in accordance with aspects of the present disclosure. The operations of method 2900 may be implemented by a AP 105 or its components as described herein. For example, the operations of method 2900 may be performed by a AP primary component as described with reference to FIGS. 13 through 16. In some examples, a AP 105 may execute a set of codes to control the functional elements of the device to perform the functions described below. Additionally or alternatively, the AP 105 may perform aspects of the functions described below using special-purpose hardware.

At 2905 the AP 105 may transmit, from an access point (AP), a trigger frame to a first station (STA) of a first set of STAs that indicates one or more random access resource units (RUs) are available for uplink transmissions from the STA. The operations of 2905 may be performed according to the methods described herein. In certain examples, aspects of the operations of 2905 may be performed by a trigger frame manager as described with reference to FIGS. 13 through 16.

At 2910 the AP 105 may transmit the trigger frame to a second STA of the two or more STAs that indicates one or more random access RUs are available for uplink transmissions from the STAs. The operations of 2910 may be performed according to the methods described herein. In certain examples, aspects of the operations of 2910 may be performed by a trigger frame manager as described with reference to FIGS. 13 through 16.

At 2915 the AP 105 may determine a prioritization rule for one or more of the random access RUs. The operations of 2915 may be performed according to the methods described herein. In certain examples, aspects of the operations of 2915 may be performed by a trigger frame manager as described with reference to FIGS. 13 through 16.

At 2920 the AP 105 may transmit to the first STA an indication of the prioritization rule for one or more of the random access RUs. The operations of 2920 may be performed according to the methods described herein. In certain examples, aspects of the operations of 2920 may be performed by a trigger frame manager as described with reference to FIGS. 13 through 16.

At 2925 the AP 105 may transmit to the second STA the indication of the prioritization rule for one or more of the random access RUs. The operations of 2925 may be performed according to the methods described herein. In certain examples, aspects of the operations of 2925 may be performed by a trigger frame manager as described with reference to FIGS. 13 through 16.

At 2930 the AP 105 may receive a first uplink transmission from the first STA over a first RU of the one or more of the random access RUs based at least in part on the prioritization rule. The operations of 2930 may be performed according to the methods described herein. In certain examples, aspects of the operations of 2930 may be performed by a uplink transmission manager as described with reference to FIGS. 13 through 16.

At 2935 the AP 105 may determine that a second uplink transmission was not received from the second STA over a second RU of the one or more of the random access RUs based at least in part on the prioritization rule. The operations of 2935 may be performed according to the methods described herein. In certain examples, aspects of the operations of 2935 may be performed by a trigger frame manager as described with reference to FIGS. 13 through 16.

In some examples, aspects from two or more of the methods may be combined. It should be noted that the methods are just example implementations, and that the operations of the methods may be rearranged or otherwise modified such that other implementations are possible.

Techniques described herein may be used for various wireless communications systems such as code division multiple access (CDMA), time division multiple access (TDMA), frequency division multiple access (FDMA), OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 as described with reference to FIGS. 1 and 2—may include one or more carriers, where each carrier may be a signal made up of multiple sub-carriers (such as waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C, as well as any combination with multiples of the same element (for example, A-A A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary feature that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving, at a station (STA), a trigger frame from an access point (AP) that indicates one or more random access resource units (RUs) are available for an uplink transmission from the STA;
determining a connectivity parameter of the STA with the AP, the connectivity parameter associated with an eligibility of the one or more random access RUs; and
transmitting the uplink transmission using one or more of the random access RUs based at least in part on the determined connectivity parameter.

2. The method of claim 1, further comprising determining whether to transmit the uplink transmission at a first transmit power for an assigned modulation and coding scheme (MCS) based at least in part on one or more restricted RUs, wherein the connectivity parameter is based at least in part on the associated eligibility of the one or more random access RUs, the one or more random access RUs including the one or more restricted RUs.

3. The method of claim 2, wherein the first transmit power for the assigned MCS is a maximum transmit power for the assigned MCS.

4. The method of claim 1, further comprising determining that the first STA is able to meet a target received signal strength index (RSSI) threshold without exceeding a power headroom limit, wherein transmitting the uplink transmission is based at least in part on determining that the first STA is able to meet the target RSSI threshold without exceeding the power headroom limit.

5. The method of claim 4, wherein the target RSSI threshold is based at least in part on an assigned modulation and coding scheme (MCS).

6. The method of claim 1, further comprising:
determining a presence of an indication of a power headroom limit for the connectivity parameter; and
identifying a prioritization rule for one or more of the random access RUs based at least in part on the determined presence of the indication of the power headroom limit, wherein transmitting the uplink transmission using one or more of the random access RUs is based at least in part on the identified prioritization rule.

7. The method of claim 1, further comprising determining an absence of an indication of a power headroom limit, wherein transmitting the uplink transmission using one or more of the random access RUs is based at least in part on the absence of the indication of the power headroom limit.

8. The method of claim 7, further comprising determining a default power headroom limit based at least in part on determining the absence of the indication of the power headroom limit.

9. The method of claim 1, further comprising:
determining a feedback indication based at least in part on a connectivity of a second STA with the AP; and
transmitting the feedback indication to the AP.

10. The method of claim 9, wherein the feedback indication comprises NDP feedback.

11. A method for wireless communication, comprising:
transmitting, from an access point (AP), a trigger frame to a first station (STA) of a first set of STAs that indicates one or more random access resource units (RUs) are available for uplink transmissions from the STA;
determining a prioritization rule for one or more of the random access RUs;
transmitting to the first STA an indication of the prioritization rule for one or more of the random access RUs; and
receiving a first uplink transmission from the first STA over a first RU of the one or more of the random access RUs based at least in part on the prioritization rule.

12. The method of claim 11, wherein the trigger frame comprises the indication of the prioritization rule.

13. The method of claim 11, wherein the prioritization rule is based at least in part on a location of the first STA.

14. The method of claim 13, wherein the first STA comprises a cell-edge STA.

15. The method of claim 11, wherein the prioritization rule is based at least in part on a ratio of cell-edge STAs of the first set of STAs to a total number of STAs of the first set of STAs.

16. The method of claim 11, wherein the prioritization rule is based at least in part on an elapsed time since a previous received uplink transmission from the first STA.

17. The method of claim 11, wherein the prioritization rule is based at least in part on a total number of STAs in the first set of STAs.

18. The method of claim 11, further comprising receiving a feedback indication from a second STA of the first set of STAs, wherein the prioritization rule is determined based at least in part on the received feedback.

19. The method of claim 18, wherein the feedback indication comprises null data packet feedback.

20. The method of claim 11, further comprising determining to transmit the trigger frame to the first STA of the first set of STAs based at least in part on a feedback indication received from a second STA of the first set of STAs, an elapsed time since a previous received uplink transmission from a cell-edge STA, or a combination thereof.

21. The method of claim 11, further comprising:
transmitting the trigger frame to a second STA of the two or more STAs that indicates one or more random access RUs are available for uplink transmissions from the STAs; and
transmitting to the second STA the indication of the prioritization rule for one or more of the random access RUs.

22. The method of claim 21, further comprising receiving a second uplink transmission from the second STA over a second RU of the one or more of the random access RUs based at least in part on the prioritization rule.

23. The method of claim 21, further comprising determining that a second uplink transmission was not received from the second STA over a second RU of the one or more of the random access RUs based at least in part on the prioritization rule.

24. An apparatus for wireless communication, comprising:
a processor;
memory in electronic communication with the processor; and
instructions stored in the memory and executable by the processor to cause the apparatus to:
receive, at a station (STA), a trigger frame from an access point (AP) that indicates one or more random access resource units (RUs) are available for an uplink transmission from the STA;
determine a connectivity parameter of the STA with the AP, the connectivity parameter associated with an eligibility of the one or more random access RUs; and
transmit the uplink transmission using one or more of the random access RUs based at least in part on the determined connectivity parameter.

25. The apparatus of claim 24, wherein the instructions are further executable by the processor to cause the apparatus to determine whether to transmit the uplink transmission at a first transmit power for an assigned modulation and coding scheme (MCS) based at least in part on one or more restricted RUs, wherein the connectivity parameter is based at least in part on the associated eligibility of the one or more random access RUs, the one or more random access RUs including the one or more restricted RUs.

26. The apparatus of claim 24, wherein the instructions are further executable by the processor to cause the apparatus to determine that the first STA is able to meet a target received signal strength index (RSSI) threshold without exceeding a power headroom limit, wherein transmitting the uplink transmission is based at least in part on determining that the first STA is able to meet the target RSSI threshold without exceeding the power headroom limit.

27. The apparatus of claim 24, wherein the instructions are further executable by the processor to cause the apparatus to:
determine a presence of an indication of a power headroom limit for the connectivity parameter; and
identify a prioritization rule for one or more of the random access RUs based at least in part on the determined presence of the indication of the power headroom limit, wherein transmitting the uplink transmission using one or more of the random access RUs is based at least in part on the identified prioritization rule.

28. An apparatus for wireless communication, comprising:
a processor;
memory in electronic communication with the processor; and
instructions stored in the memory and executable by the processor to cause the apparatus to:
transmit, from an access point (AP), a trigger frame to a first station (STA) of a first set of STAs that indicates one or more random access resource units (RUs) are available for uplink transmissions from the STA;
determine a prioritization rule for one or more of the random access RUs;
transmit to the first STA an indication of the prioritization rule for one or more of the random access RUs; and
receive a first uplink transmission from the first STA over a first RU of the one or more of the random access RUs based at least in part on the prioritization rule.

29. The apparatus of claim 28, wherein the prioritization rule is based at least in part on a ratio of cell-edge STAs of the first set of STAs to a total number of STAs of the first set of STAs.

30. The apparatus of claim 28, wherein the instructions are further executable by the processor to cause the apparatus to:
transmit the trigger frame to a second STA of the two or more STAs that indicates one or more random access RUs are available for uplink transmissions from the STAs; and
transmit to the second STA the indication of the prioritization rule for one or more of the random access RUs.
